(19) United States
(12) Patent Application Publication
(10) Pub. No.: US 2017/0262540 A1
(43) Pub. Date: Sep. 14, 2017

(54) Method And System For Providing Reference Checks

(71) Applicant: aRefChex Inc., Chicago, IL (US)

(72) Inventors: Kevin Anhalt, Scottsdale, AZ (US); Shawn Matthews, Collingwood (CA); Karen Matthews, Collingwood (CA); Travis Brown, Knoxville, TN (US)

(21) Appl. No.: 15/529,831

(22) PCT Filed: Nov. 25, 2015
(86) PCT No.: PCT/US15/62678

§ 371 Date: May 25, 2017

Related U.S. Application Data
(60) Provisional application No. 62/084,320, filed on Nov. 25, 2014.

(51) Int. Cl. G06F 17/30; G06Q 10/10

(52) U.S. Cl. CPC G06F 17/30861; G06Q 10/1053; G06F 17/30994; G06F 17/30864; G06Q 10/101; G06Q 50/182

(57) ABSTRACT

A system for checking references is disclosed that can be initiated by an individual for self-verification in anticipation of applying for a position, or a potential employer or user. The system may generate a survey that is distributed to references who can provide feedback based on the survey prompts. The survey may be drafted using parameters input by the individual, or the survey may be drafted using employment related information gathered from another source, for instance third-party website that collects employment data, such as O*NET. Based on received survey responses, a reference report is generated.

The reference checking system also comprises an adverse action process and monitoring system that enables FCRA compliance in the event the reference report results in an adverse action.

Also, the reference checking system provides a structured database for storing and retrieving reference reports designed to help reduce repeal requests for feedback from referee providers.

### CROSS-REFERENCE(S) TO RELATED APPLICATION(S)

This application claims the benefit of priority of U.S. Ser. No. 62/084,320 filed Nov. 25, 2014, now the entire contents of which are hereby expressly incorporated by reference into the present application.

### BACKGROUND OF THE INVENTION

1. Field of the Invention

A system and method for creating and storing surveys; collecting and receiving responses to the surveys from references; and a dispute-investigation method or system to verify the information provided in the surveys.

2. Discussion of the Related Art

Existing reference checking systems are most often not based on structured and researched-job relevant information and they use a system of scoring and assessing survey responses to evaluate and/or judge the candidate. Furthermore, existing reference checking systems do not provide candidates the opportunity to review the reference report and to provide feedback and/or correct inaccurate information gathered from references—a process required under Fair Credit Reporting Act (FCRA) regulations—when a candidate is rejected from the hiring process by a user of a 3^{rd} party service. The end result is that a candidate is often evaluated or assessed on non-job relevant data and the candidate is denied the FCRA legally mandated opportunity to dispute and/or defend him/herself against incomplete and/or inaccurate information provided by a reference or references.

Furthermore, existing reference checking systems only allow the reference checking process to be initialed by an end user/reviewer of the reference report and do not provide individuals that are anticipating taking part in an application process a way of generating a reference report in advance of actually applying for a position.

Additionally, existing reference checking systems are not candidate and reference-provider friendly in that they do not store previously generated reference checking reports into a database for use by individuals in applying for other positions or for perspective employers to search for individuals with previously completed reference checking surveys.

Thus, there is a need for a method and system for reference checking that addresses at least one of the issues identified above. For instance, a reference checking method or system is desired that has a high degree of job-specific relevance and only objectively presents the results of the references' survey responses. Additionally a reference checking method and system and method is desired that allows the candidate to review and provide feedback as well as resolve information obtained from his or her references in the event that the reference responses have negatively affected a user's decision process with regards to an employment opportunity. Also, because the process of reference checking has become a standard step in almost all application processes, there is a need to provide individuals the option to self-initiate a self-verification process meeting all these criteria in advance of the individual applying for a job or other position. Moreover, because the vast majority of candidates apply to more than one job opportunity, there is a need to enable individuals the opportunity to reuse a previously generated reference checking report when apply for multiply positions and with different perspective employers.

### SUMMARY AND OBJECTS OF THE INVENTION

By way of summary, the present invention is directed to a system for checking references of an individual in anticipation of submitting an application. The individual may initiate the reference checking system or a potential employer or other third party may initiate the reference checking system. Where the individual initiates the reference requesting system, it is for self-verification purposes. In accordance with one aspect of the invention, the system includes a plurality of computers in communication with one another, with at least one computer configured to receive a reference request. The individual provides a list of references to be contacted to at least one of the computers.

In another aspect of invention, the system also may include a survey generation device that includes a plurality of device specific generating modules configured to generate a survey based on parameters. The survey may be generated based on parameters provided by the individual or based on information provided by a third party. For instance, the information may be retrieved from a third party website, such as a third-party database containing job-specific information. In one embodiment, the job-specific information may be gathered based on a job title. For example, the job-specific information may be collected from an O*NET database. This could be achieved where at least one of the computers has direct remote access to the O*NET database to retrieve the job-specific information.

In yet another aspect of the invention, the system also may include a survey distribution device including a plurality of device specific processing modules, where each device specific processing module is configured to distribute the survey to each of the list of references.

The system may also include a survey database, which includes a plurality of collection modules that collect responses provided by the list of references based on the survey.

Additionally, the system may include an organization database. The organization database may include a plurality of analysis modules that organize the plurality of responses. Once the organization database organizes the responses, a system database may be used to generate a survey report based on the plurality of response. In one embodiment, the individual is provided with access to the survey report. In another embodiment, only a third parry is provided access to the survey report.

The system may also include a second survey generation device with a plurality of device specific generating modules that generate and update survey feedback over time.

Furthermore, the system may include a survey report distribution device that enables the individual to invite at least one third party to review the survey report.

In accordance with another aspect of the invention, a reference survey database may be provided that is communication with the plurality of computers for storage of responses and survey reports. This would allow the individual third parties to access this information at a later date.

In accordance to yet another aspect of the invention, a searching module may be included with the system, which allows a user to search the survey responses based on parameters provided by the user. This may be provided to the user using the system database.

In another aspect of the invention, the system is configured to flag when an adverse action occurs relating to an applicant's reference report, for example, where a decision to not advance an applicant in an application process based on the applicant's reference report. In such a case, the system database may be configured to receive a notice from the user when this occurs. Pursuant to this aspect, the system may additionally include a message distribution device. The message distribution device may be configured to notify the applicant of an adverse action process by a notice. The message distribution device may then provide the applicant with information regarding the applicant's reference report and information about the applicant's right under the Fair Credit Reporting Act (FCRA). The system could further include a collection database that receives additional information relating to the applicant's reference report in response to the notification of the adverse action process. Further still the system may include a docketing database that automatically periodically sends reminders relating to the adverse action process to the individual.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 illustrates a reference checking system according to one embodiment of the present invention,

FIG. 2 illustrates a reference checking process according to one embodiment of the present invention,

FIGS. 2a and 2b illustrates a reference checking process according to one embodiment of the present invention,

FIG. 3 illustrates a reference checking process according to one embodiment of the present invention,

FIGS. 4a-4o illustrate exemplary steps of the survey generation according to one embodiment of the present invention.

FIGS. 5a-5r illustrate exemplary steps of the candidate invitation step according to one embodiment of the present invention,

FIGS. 6a-6c illustrate exemplary steps of the reference invitation step according to one embodiment of the present invention,

FIGS. 7a-7e illustrates a compiled reference report according to one embodiment of the present invention,

FIGS. 7f-7q illustrates a compiled reference report according to another embodiment of the present invention,

FIG. 8 illustrates an adverse action process according to one embodiment of the present invention,

FIG. 8a illustrates an adverse action process according to another embodiment of the present invention,

FIG. 9 illustrates reference checking and adverse action processes according to various embodiments of the present invention,

FIG. 10 illustrates a pre-adverse action notification sent to a candidate informing the candidate of a potential adverse action according to one embodiment of the present invention,

FIG. 11 illustrates a self-verification process according to one embodiment of the present invention,

FIGS. 12a-12d illustrate internal flow processes for guiding the reference checking process according to one embodiment of the present invention,

FIGS. 13a and 13b illustrate exemplary views of a user interface system according to the embodiment of the present invention,

FIGS. 14a-14c illustrates a Candidate Reference Application process according to one embodiment of the present invention,

FIGS. 15a-15c illustrates Candidate Reference Application—Reference Interface process according to one embodiment of the present invention,

FIGS. 16a-16c illustrates a Candidate Reference Application—View Reference Report process according to one embodiment of the present invention,

FIGS. 17a-17c illustrates a Candidate Reference Application—Add/Update References process according to one embodiment of the present invention,

FIGS. 18a-18b illustrates a Candidate Reference Application—View Employers process according to one embodiment of the present invention,

FIGS. 19a & 19b illustrates a Candidate Reference Application—My Account process according to one embodiment of the present invention, and

FIG. 20 illustrates a Candidate Reference Application Database structure according to one embodiment of the present invention.

In describing the preferred embodiment of the invention that is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose.

### DESCRIPTION OF PREFERRED EMBODIMENTS

### 1. Resume

The present invention relates to a method and system for providing a reference check. In general, the reference checking system of the invention comprises a computer system that is programmed to be capable of being used to conduct the reference checking process of the invention.

The reference checking process of the invention is initiated when a reference request is received from a user. In response to the reference request, the reference checking system generates a survey to be sent to references provided by a candidate.

In generating a survey, the reference checking process receives from the user job descriptions, job titles, job names, job responsibilities, job codes, or other job identifying terms or search parameters relevant to a job or position that the user may want fill or hire for or that a user may wish to apply for. The reference checking system then accesses a third-party occupational information database or library and searches the third-party database or library using the user-provided job identifying terms to identify one or more job profiles relevant to the parameters input by the user. These identified job profiles are presented to the user, who may then select one or more of the job profiles and/or alter the profile content for building a custom library of job profiles

In utilizing a third-party database or library, the reference checking system may provide the user with a list of one or more third-party occupational information databases or libraries that may be utilized to generate the survey, and may present to the user the option of selecting which of the third-party databases or libraries to use in generating the survey. In one embodiment, the third-party database or library that is utilized is O*NET.

When utilizing the third-party database or library to generate a survey, the reference checking system may access and search through the third-party database or library by accessing the third-party database or library directly, utilizing an intermediate party to access the third-party database or library, and/or accessing a copy of the third-party database or library which is stored on the reference checking system.

Based on the user selected job profiles, the reference checking system retrieves from the third-party database any categories and/or category elements associated with the user-selected one or snore job profiles and presents to user these categories and/or category elements. After reviewing the presented categories and/or category elements the user selects and/or alters the desired categories and/or category elements to be included in the survey. The reference checking system then utilizes each of the selected and/or alters categories and/or category elements from the third-party database or library to generate individual survey elements, and provides a scale or free-form text fields for each of the individual survey elements such that a reference can provide an evaluation, feedback, and/or response of a candidate based on each of the survey elements.

Preferably, each of the survey elements mirrors exactly a selected category and/or category element from the third-party database or library, and the categories and/or category elements from the third-party database or library are not in any manner regrouped, renamed, combined, interpreted, expanded on, or altered in any other way in generating survey elements, such that each of the survey elements is dictated entirely by the categories and/or category elements from the third-party database or library. Prior to finalizing the survey, the reference checking system may present to the user the option to customize the survey, by providing the user with the option to, for example add or remove categories and/or category elements, edit, rename, combine, expand and/or otherwise alter the selected job profile or to add in additional survey elements.

After the survey has been generated and references have been invited to and have completed the survey, the reference checking system compiles the reference survey response to generate a reference report that is provided to the user.

In the event that, after reviewing the reference report a user decides to no longer pursue a candidate based in whole or in part based on the candidate's reference report, the reference checking system allows a user to initiate an adverse action process. As part of the adverse action process, the reference checking system notifies the candidate of the adverse action and provides the candidate with a copy of the candidate's reference report and information about the candidate's rights under the Fair Credit Reporting Act (FCRA). Additionally, the reference checking system may receive additional information related to the candidate's reference report in response to the notification of the adverse action. This additional information may be received from the candidate, or alternatively from other individuals involved in the adverse action process. Once the adverse action process has been completed, the candidate's adverse action status is updated in the reference checking system.

So as to help facilitate the adverse action process, the reference checking system may display the status of the adverse action process, allowing the user to monitor the adverse action process to ensure compliance with FCRA requirements. Among other things that may be monitored and tracked by the reference checking system are whether a candidate has been notified of the adverse action, the amount of time that has passed since the candidate was notified; whether reminders have been sent to the candidate, whether the candidate has received and/or viewed the adverse action notification, the final status of the adverse action once the adverse action process has been completed, and/or whether other individuals besides the candidate have been notified of and/or responded to the adverse action.

In another embodiment of the invention, the method and system are used to allow an individual to self-verify information in anticipation of submitting an application. In such an embodiment, in response to a self-verification reference request received from an individual, the reference checking system automatically generates a survey based on parameters provided by or inputted by the individual, sends a copy of the survey and invitation to the references to complete the survey, receives survey responses from the references, and compiles the reference survey responses to generate a reference report.

In such a self-verification embodiment, the application for which the individual anticipates using the results of the self-verification method may include an application for a job or other employment position, a volunteer position, a teaching or coaching position, academic admissions, an athletic team, a recreational team, a child-care position, a government position, a political position or organization, a professional or trade association, a charitable organization, a menial health position, a personal introductory and/or membership organization, and a religious organization.

In the self-verification embodiment, the survey may be generated based in whole or in part on information and materials provided or input by the individual or a third-party such as, but not limited to an employer, a volunteer organization, a teaching or coaching organization, academic institution, an athletic team, a recreational team, a child-care provider, a governmental institution, a political organization or party, a professional or trade association, a charitable organization, a mental health organization, a personal introductory and/or membership organization, and a religious organization. In other embodiments of the self-verification embodiment, the survey may be generated using the above, previously described survey generation process using a third-party database or library.

In addition to receiving survey responses from references, in the self-verification process, the individual may also complete a self-evaluation survey, the responses to which may then be compiled with the reference survey responses to generate the reference report. The self-evaluation survey may mirror and/or be identical to the survey provided to the references.

When compiling the survey responses, the responses may be compiled based on the preferences, inputs and parameters provided by the individual. Alternatively, the survey responses may be compiled based on she preferences, inputs and parameters provided by a third-party such as an employer, a volunteer organization, a teaching or coaching organization, academic institution, an athletic team, a recreational team, a child-care provider, a governmental institution, a political organization or party, a professional or trade association, a charitable organization, a mental health organization, a personal introductory and/or membership organization, and a religious organization.

Once the survey responses have been compiled, the reference report may be provided to the individual for review of the results and/or contents. The reference report may also be supplied to a third-party. In certain embodiments, the reference report may be provided to only third parties, and optionally, among third parties, only to those third parties that have verified that they are obtaining, accessing, or otherwise reviewing the reference report. For example, in one embodiment, the third party may need to pass a verification procedure. Alternately, the third party may be required to be invited by the individual and be given a unique web link which requires a form of verification such as a password.

The decision as to whom access to the reference report should be granted may be determined by the individual. Alternatively, the decision may be determined by the references, wherein in the event that even one of the references provided by the individual denies the individual the opportunity to obtain, access, or otherwise review the results of and contents of the reference report, the individual will not be provided with the opportunity to obtain, access, or otherwise review the results of and contents of the reference report. In different embodiments, the subject of the reference check may or may not be provided with a copy of the reference report.

In another embodiment, the reference checking system may be used by users to screen applicants. According to this embodiment, the user first receives a self-verification reference request from one or more persons, wherein the individual has included a list of references. The computerized system will then generate a survey based on parameters either provided or inputted by the user. Once the survey has been generated, the system sends a copy of the survey to the references with an invitation to complete the survey. Upon completion of the surveys, the system receives responses from the references. The system then searches the responses for information based on parameters provided by the user, ultimately providing the user with the search results. This system may also include a self-evaluation survey to be completed by the individual, wherein the individual's responses and information are also searched by the system.

In embodiments in which the reference checking system is used for self-verification processes, the reference checking system may also allow a user to screen individuals using the results from the self-verification processes of one or more individuals. In such an embodiment, the reference checking system allows a user to search through the anonymized results of the self-evaluation survey responses and reference survey responses based on user-input parameters. Optionally, in such an embodiment an individual may first be required to authorize the reference checking system to search through the results of the individual's self-verification process. The reference checking system may then present to the user the results from this search.

Among parameters provided by the user that may be used when searching the survey responses are minimum or maximum acceptable reference response, desired average reference response, type of reference (e.g. supervisor, co-worker, professional, friend, family. etc.), types of survey elements presented, types of survey categories presented, types of survey questions presented, consistency between reference responses and self-evaluation responses. The reference checking system may use these parameters to search through uncompiled survey responses, survey responses as they have been compiled in a reference report, or a combination of uncompiled and compiled results.

As additional reference responses and/or self-evaluation responses are received from existing or from new individuals, the reference checking system may periodically update the search of the responses and provide the user with the results of the updated search.

To facilitate the candidate's ongoing use of the reference report, whether initiated when applying for employment or initiated as a self-verification, the reference checking system provides the candidate access to the reference report within a secure, personal Candidate Reference Application. The Candidate Reference Application functionality includes tools for the candidate to: invite additional references, update references, provide prospective employers access to the reference report, track viewers of the reference report and provide access to the reference report on social media sites including: LinkedIn, Facebook, Google+, etc.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### 2. Detailed Description of Preferred Embodiment

The present invention and the various features and advantageous details thereof are explained more fully with reference to the non-limiting embodiments described in detail in the following description.

The following terminology will be used in accordance with the definitions set forth below. The singular forms “a,” “an,” and, “the” include plural referents unless the context clearly dictates otherwise. Thus, for example, reference to “a sensor” includes reference to one or more of such sensors. As used herein, the term “about” is used to provide flexibility to a numerical range endpoint by providing that a given value may be “a little above” or “a little below” the endpoint.

As used herein, the term “substantially” refers to the complete or nearly complete extent or degree of an action, characteristic, property, state, structure, item, or result. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

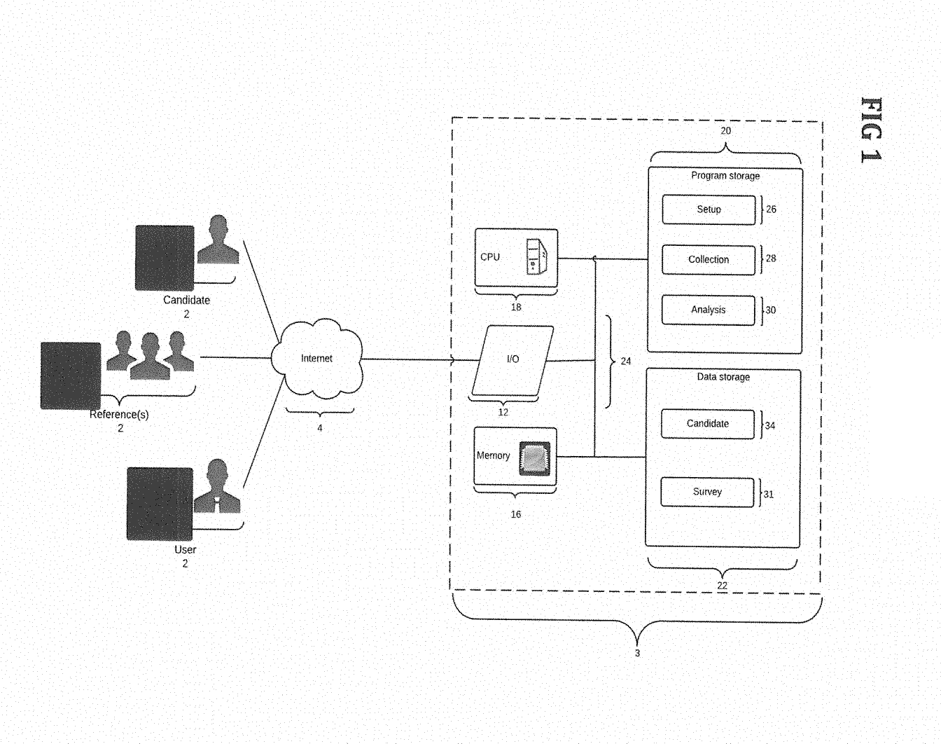

As illustrated in FIG. 1, a reference checking system 1 of the present invention involves a number of computers 3, 2 that are connected to each other through a computer network 4 such as the Internet. The computers 3, 2 of the reference checking system 1 cooperate with each other to provide comprehensive collection and analysts of reference information that are made through the network 4. Computers 2 are similar to the computer 3, with the exception of some of the databases and software modules.

As also illustrated in FIG. 1, the computer 3 is connected to the internet 4 through, for example, an I/O interface 12, such as for a LAN, WAN, or fiber optic, wireless or cable link, which receives information from and sends information to other computers 2.

The computer 3 includes, for example, memory storage 16, processor (CPU.) 18, program storage 20, and data storage 22, all commonly connected to each other through a bus 24. The program storage 20 stores, among others, software programs such as set-up module 26, collection module 28, and analysis module 30. The data storage 22 stores, among others, candidate database 34, and survey database 31, all preferably stored in a relational database that relates all of the databases stored in the data storage. Any of the software program modules in the program storage 20 and data from the data storage 22 are transferred to the memory 16 as needed and is executed by the processor 18.

The computer 3 can be any computer such as a WINDOWS-based or UNIX-based personal computer, server, workstation or a mainframe, or a combination thereof. While the computer 3 is illustrated as a single computer unit for purposes of clarity, persons of ordinary skill in the art will appreciate that the system may comprise a group of computers which can be sealed depending on the processing load and database size and which can be remotely located to provide localized non-stop service.

Although in a preferred embodiment, the reference checking system 1 is fully automated using the computer 3 set-up described shove, and the reference checking process 100 is performed using the above described computer 3 set-up, if is to be understood that in other embodiments, all of or parts of the reference checking system 1 and reference checking process 100 may be used with a non-automated and/or non-computer 3 set-up.

The present invention generally relates to a reference checking system 1 and a reference checking process 100 and 100a that generates and provides users, e.g. employers, applicant tracking systems (ATS), vendor management systems (VMS), human resource information systems (HRIS), job boards, consumer reporting agency (CRA), recruitment process outplacement firms (RPO), temporary staffing firms, permanent placement firms, executive recruitment firms, payroll companies or any other entities or individuals with a fast, accurate, and compliant manner of checking and verifying a candidate's references. The reference checking system 1 and reference checking process 100 of the present invention may function as a stand-along system, or alternatively, the system may be integrated into new or existing host systems.

FIG, 2 illustrates one embodiment of a high level process flow of the reference checking process 100 according to the present invention. The reference checking process 100 begins when a user creates a reference request at step 101. Typically, step 101 is initiated when a user using an Internet enabled computer 2 accesses the computer 3 of the reference checking system 1 through the Internet. The reference request created at step 101 may be a reference request for a single candidate, or a request for multiple candidates. A unique identifier is assigned to each candidate for whom a reference request is created, which is stored in the candidate database 34. In the event that the user has not previously submitted a reference request, or if the user wishes to modify a previously created reference request, the process continues to step 102.

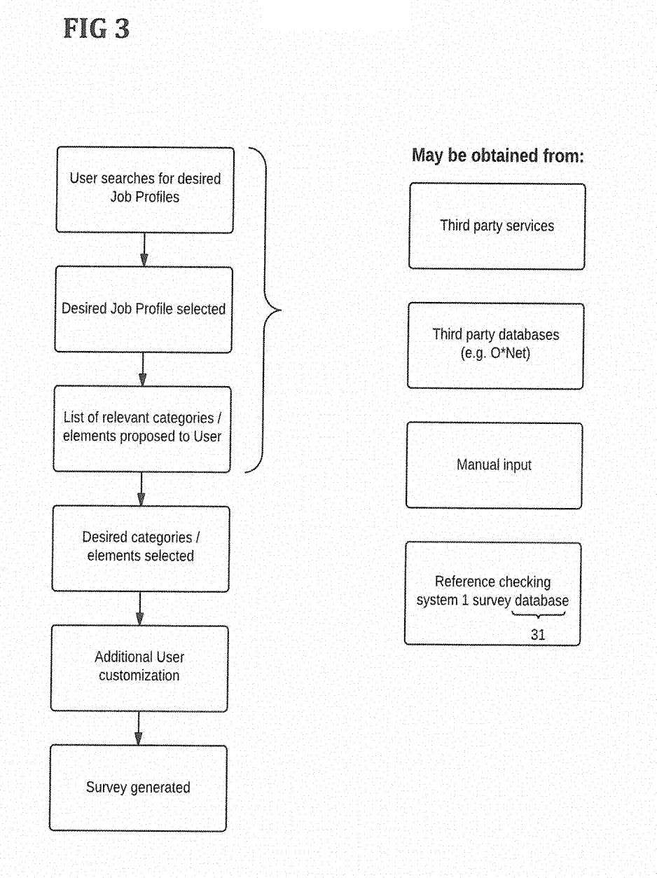

In step 102 the user selects existing or inputs new information that will be used to generate a survey best suited for the reference request. The reference checking system 1 may include a first survey generation device that includes a plurality of device specific generating modules that are configured to generate a survey based on specific parameters. These specific parameters may be provided by the user or by information provided by a third party. Furthermore, the reference checking system 1 may also include a second survey generation device including a plurality of device specific generating modules configured to generate and update survey feedback periodically. The process of generating a survey is described in more detail in the discussion of FIG. 3. In step 102, in addition to specifying the job or position that the reference request is being generated for, the user is able to enter other specifications and/or requests to create a survey best tailored for the user's needs. Examples of customizations that a user can make during step 102 to best tailor the survey to the user's needs are: setting the number of references that a candidate must provide; defining the type of individuals (e.g. managers, co-workers, subordinates, peers, friends, customers, professional references, etc.) that are or are not eligible to serve as references; predefining desired references to a specific profession or industry; predefining desired references from specific companies and/or specific positions; allowing the user to create free-form questions or fields; allowing a user to add or remove survey elements to the survey automatically generated by the process described in FIG. 3; allowing the user to replace the survey automatically generated by the process described in FIG. 3 with a user-provided survey; allowing the user to determine the type of scale (e.g. 1-10, 1-4, poor-average-high, etc.) used to answer survey elements; etc. The information entered by the user in step 102 is stored by the computer 3 in the candidate database 34 of the data storage 22. Once the survey of step 102 has been finalized (or in the event that a user is selecting a previously created reference request the user does not wish to modify), the reference checking process 100 continues to step 103 in which the candidate is invited to participate in the reference checking process 100.

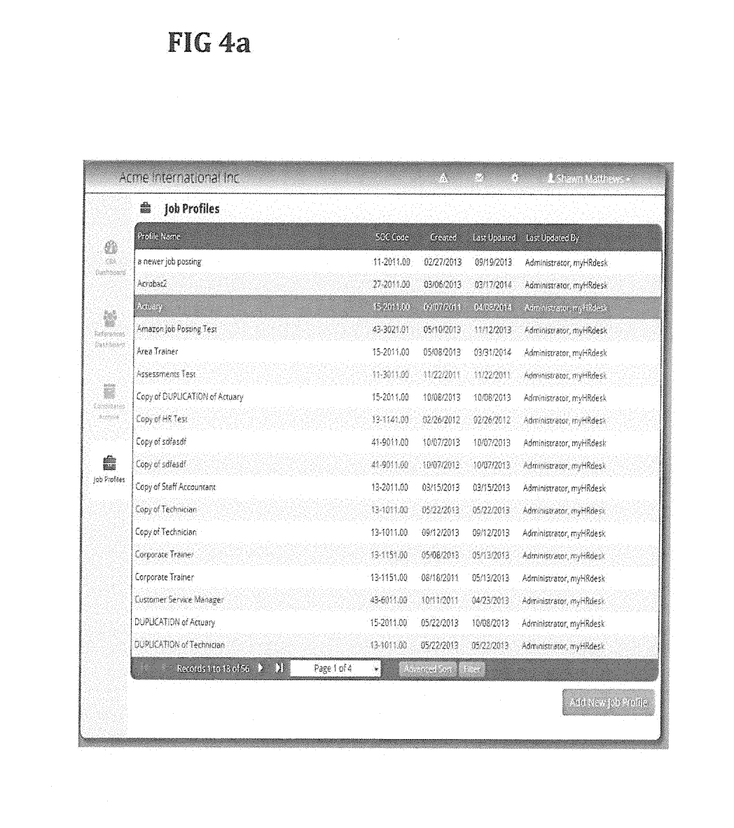

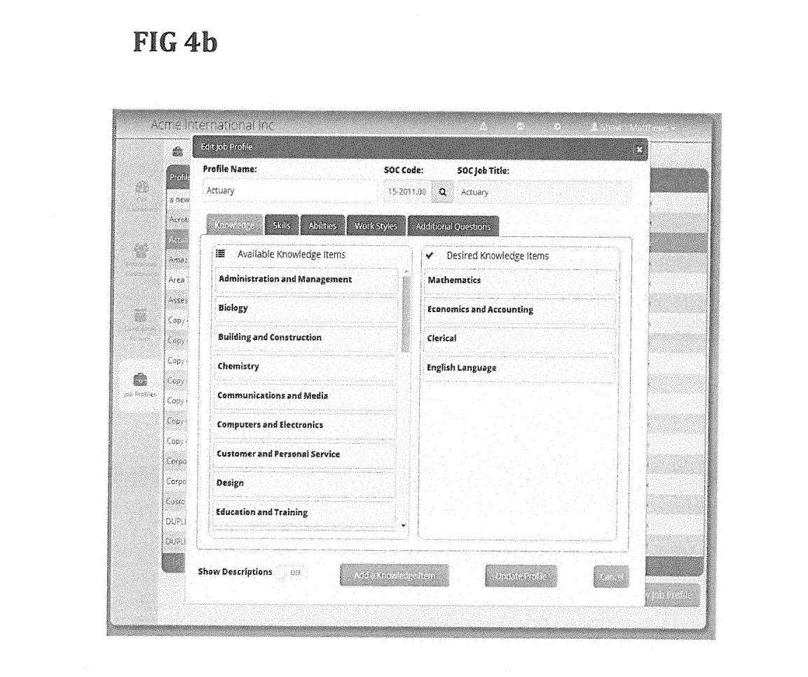

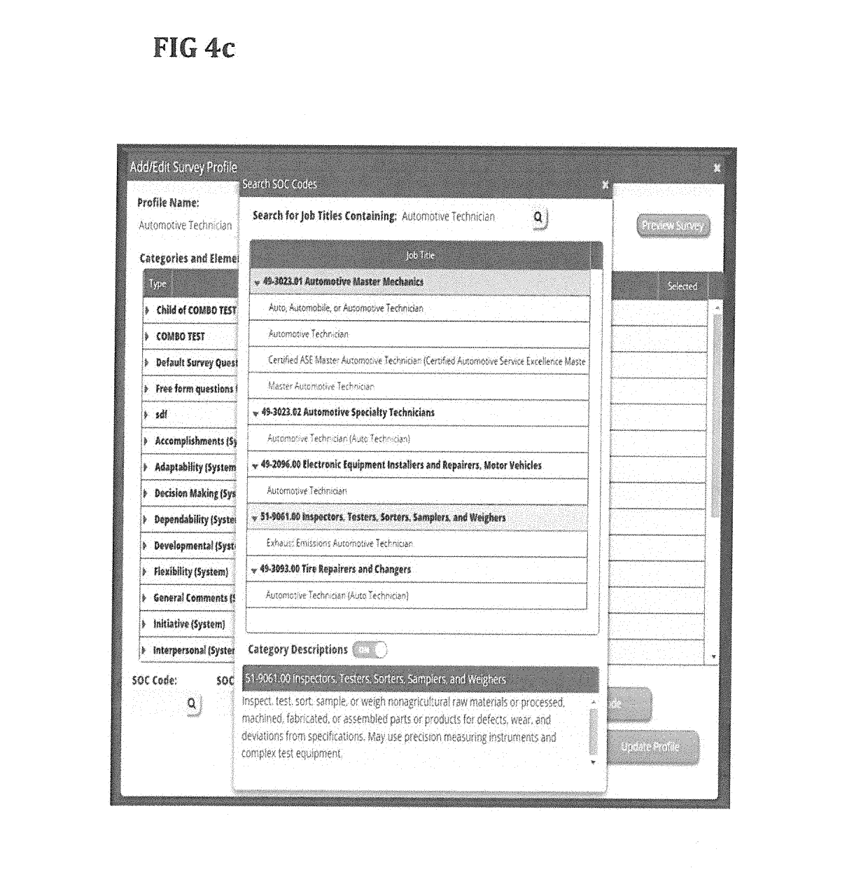

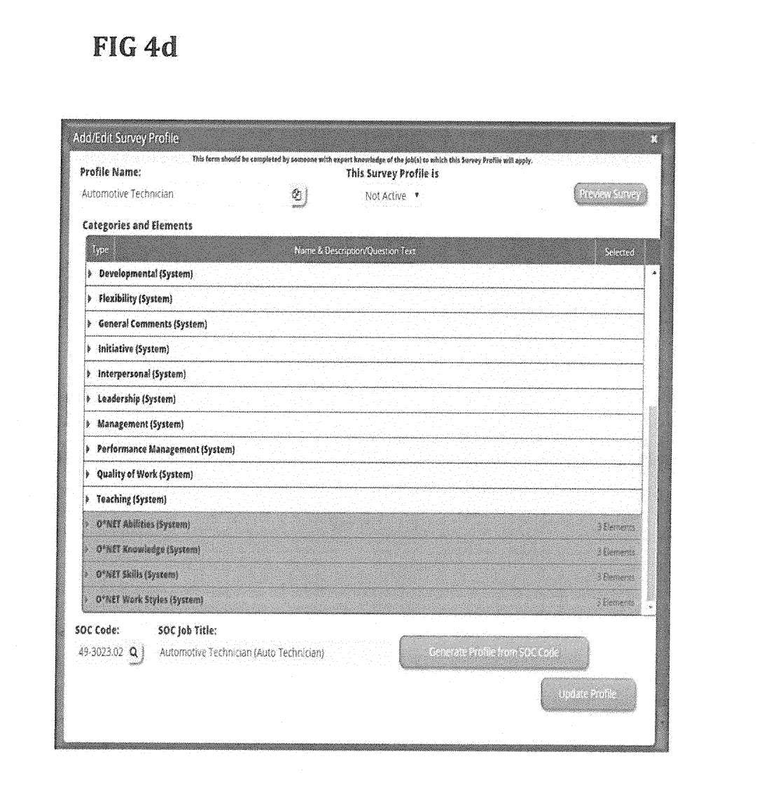

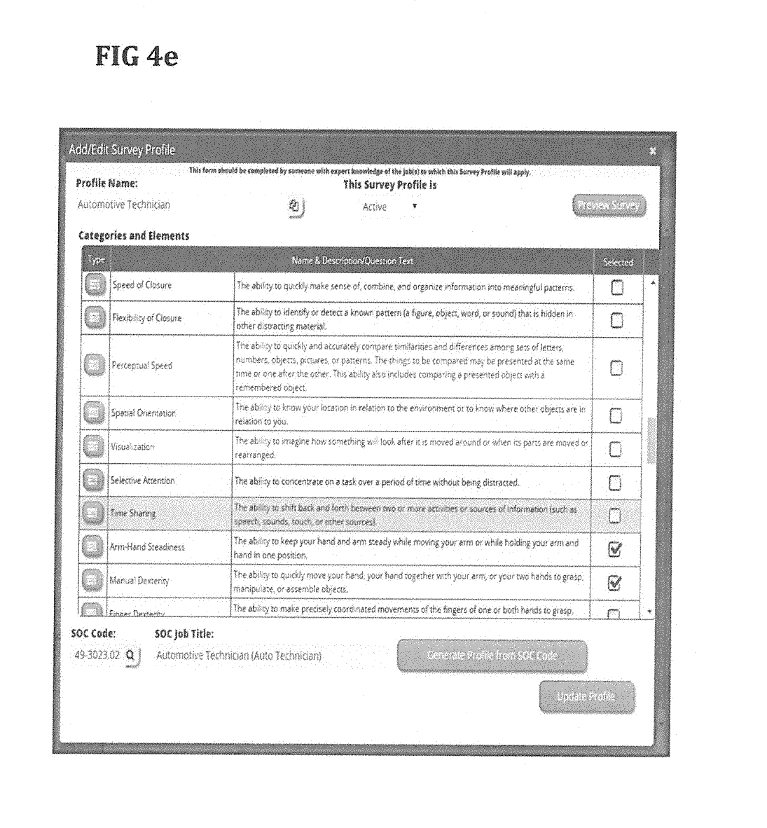

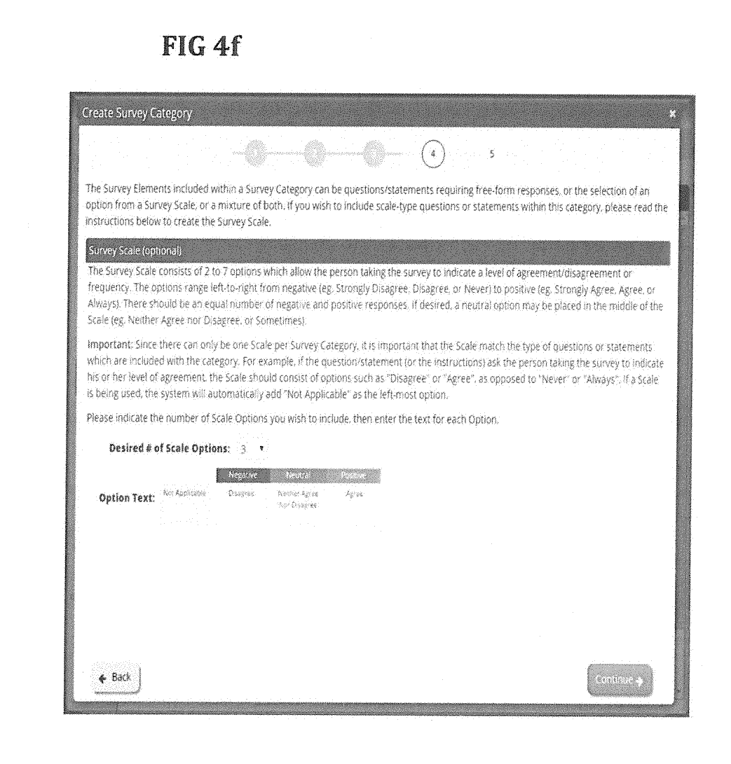

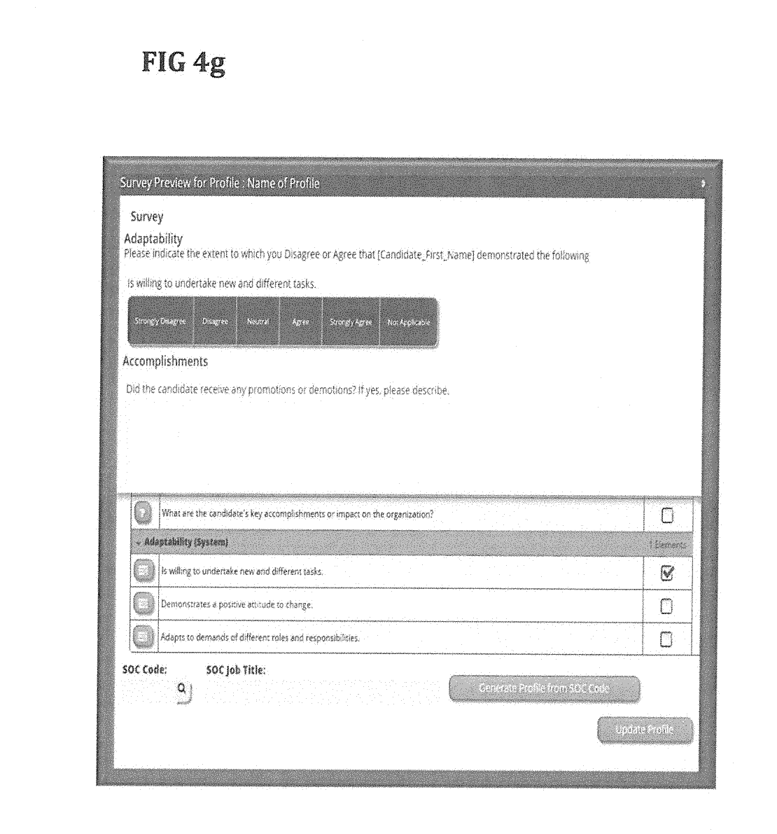

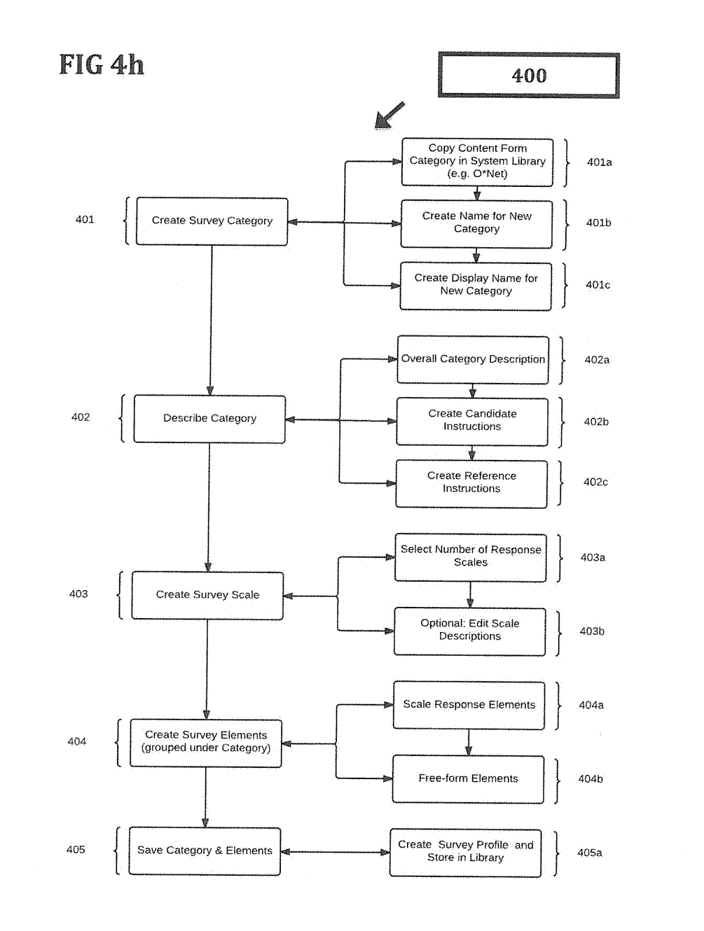

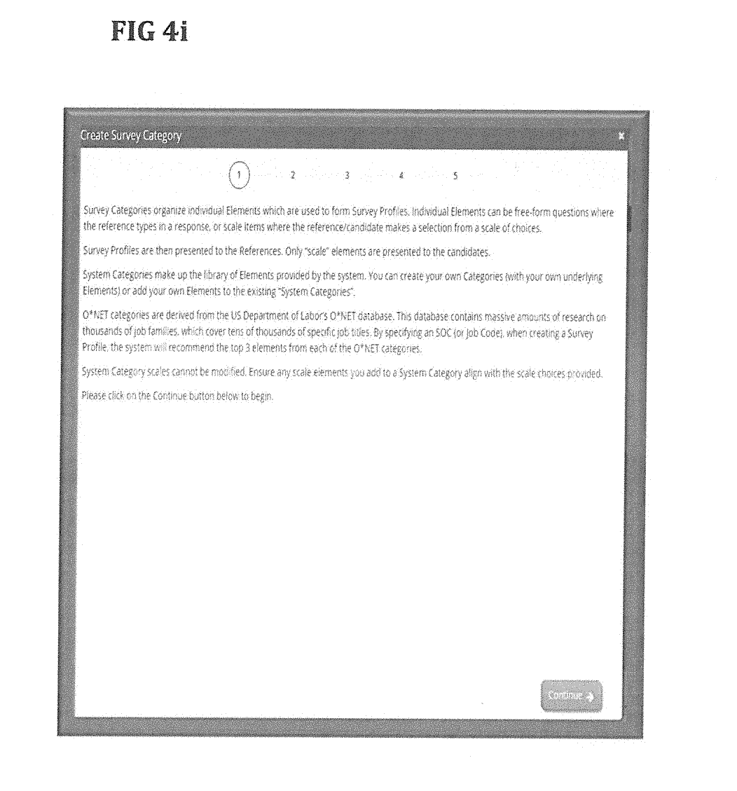

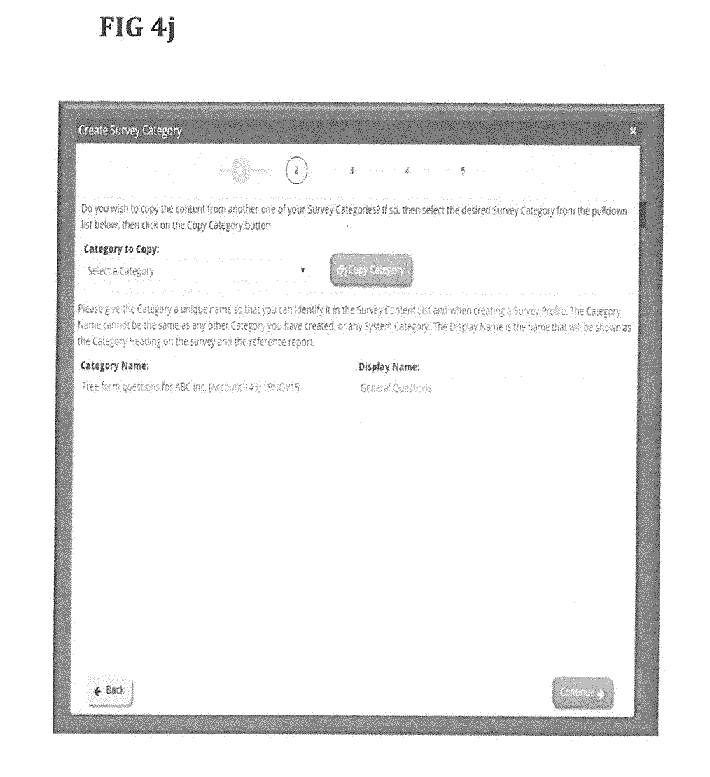

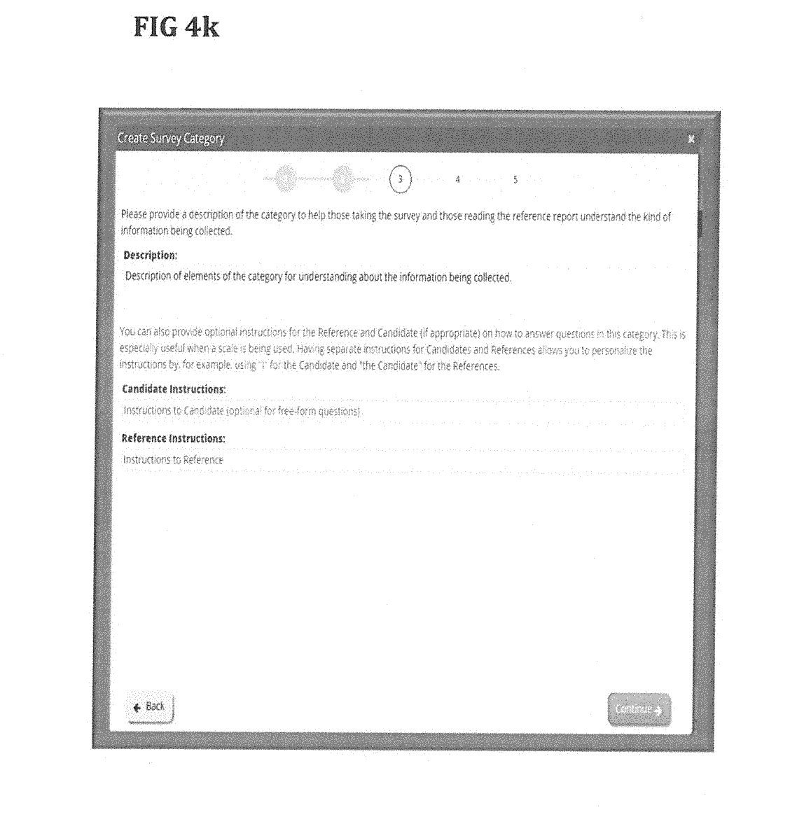

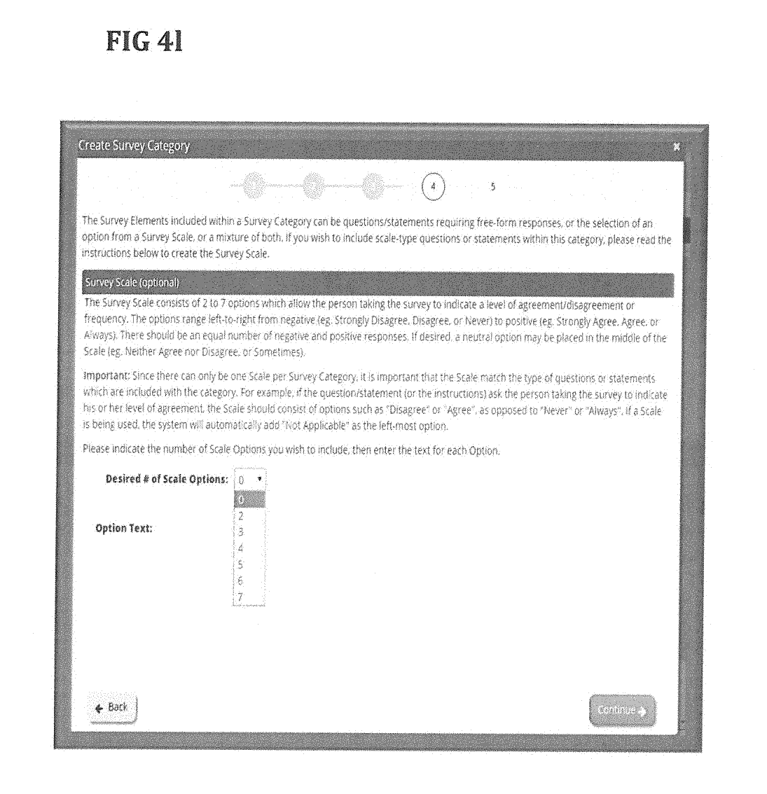

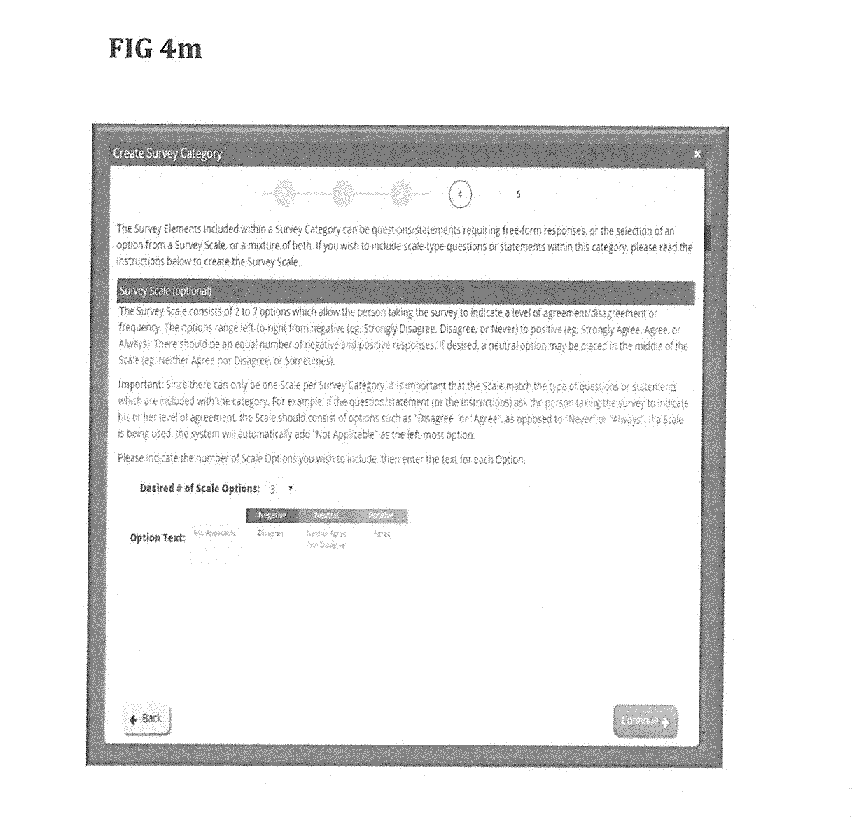

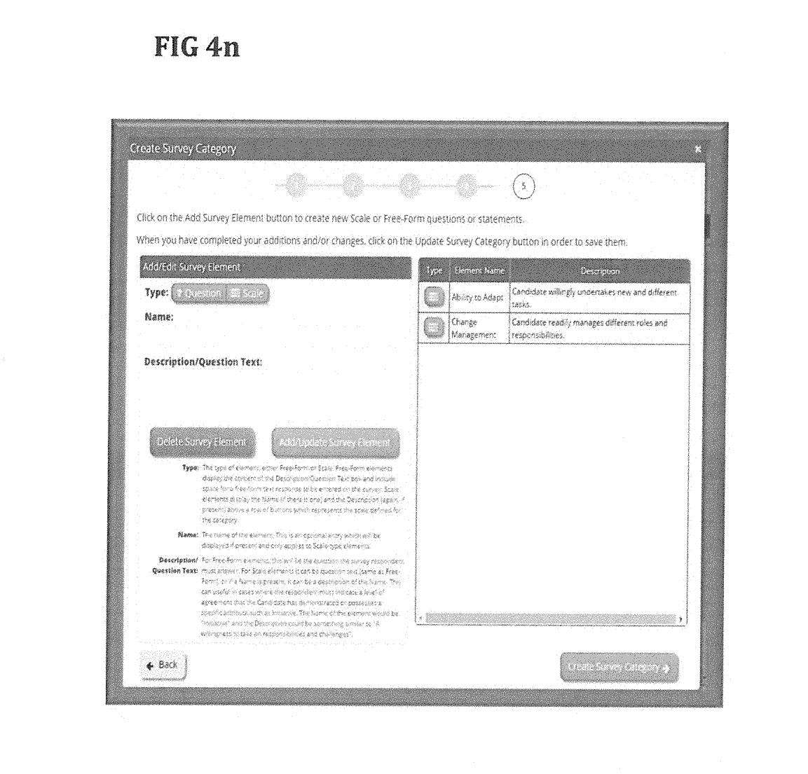

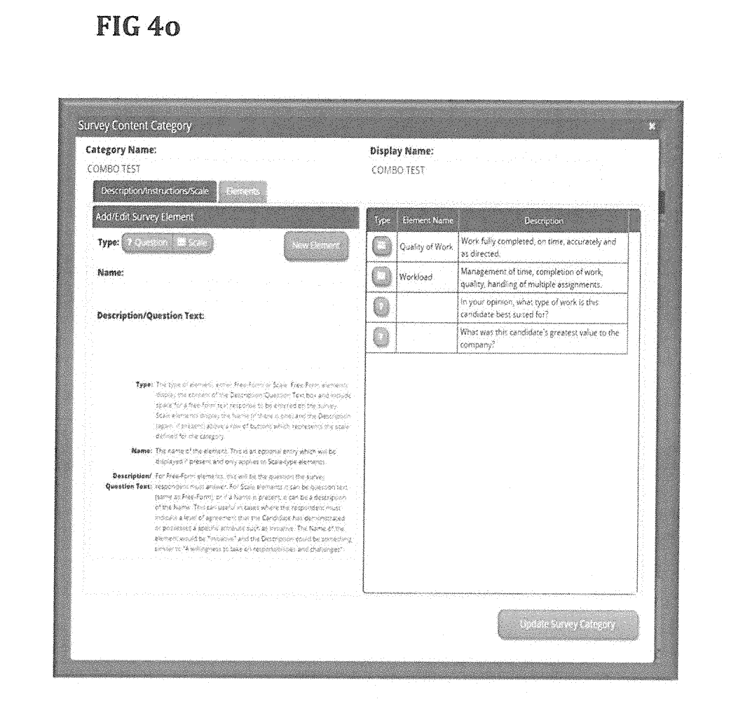

FIG. 3 illustrates the general process on an embodiment of generating a survey. As seen in FIG. 4a, in a first step of generating a survey, the user searches through the reference checking system 1 survey database 31 to find a job profile or job profiles that are most relevant to the position the user is looking to hire for/fill. As illustrated in FIG. 4b, once the user has identified the relevant job profile(s), utilizing the survey database 31 the reference checking system 1 automatically generates a list of categories and category elements relevant to the selected job profile(s) winch is then presented to the user. In general, categories are larger groups into which one or more category elements fall into. Categories may optionally include a brief description of the category to better assist the user in selecting the relevant categories to include in the survey. The user is then able to, among miner things: choose any or all of the categories and category elements to generate the survey; amend and/or delete any categories and category elements from those present by the reference checking system 1; add in other self-generated categories and/or category elements to include with the categories and category elements presented by the reference cheek system 1; etc.

After the individual has finalized the categories and category elements to be included in the survey, the reference checking system 1 may prompt the user to input additional information and/or alter the information to assist in generating the survey. For example, the reference checking system may prompt the user to select how the survey elements will be presented to references for evaluation. Options for how the elements are presented for evaluation include: a yes/no option; a scale option; or a free-form response option. For example, if one of the survey elements was: “attention to detail,” that references could be asked to evaluate the candidate on such an element in a number of ways, for instance by asking the references to answer “yes/no” as to whether the reference believes the candidate possesses the trail of “attention to detail”; asking the references to provide a 1-10 rating for the candidate's “attention to detail”; and/or asking the references to input into a free-form box any comments and/or examples regarding the candidates “attention to detail.”

The reference checking system 1 may be used with surveys generated in any number of ways and originating from any number of sources, including e.g. user provided surveys. However, in a preferred embodiment, the surveys created by the reference checking system 1 are generated by utilizing as much as possible the content of existing, well-established occupational information databases or libraries. Well-established occupational information databases and libraries provide a vast resource of not only a comprehensive listing of job profiles, but also well researched information related to the different traits, skills, knowledge, attributes, work styles, characteristics and other traits that are most desirable, most important, best suited, and/or otherwise most relevant to a particular job profile. Examples of sources of such well-established occupational information databases and libraries include, among others: experts, researched and/or industry standards; regulatory standards; national and/or international databases; government funded databases; etc.

The reference checking system 1 may therefore select parameters based on job-specific information collected from a third party. To the extent that a survey is generated utilizing existing databases and libraries, the survey categories and elements that are included in the survey represent the most on-point and reliable manner of evaluating whether a candidate—based on the evaluation of the references—possesses those traits, skills, knowledge, attributes, tools, work styles, characteristics and/or other traits that are most relevant to and most likely to be indicative of the candidate being an appropriate candidate for the position.

In utilizing the contents of such existing databases and libraries to generate surveys, the reference checking system 1 preferably does not edit, amend, or regroup, recategorize, or otherwise alter the contents of these existing databases and libraries. Rather, the reference checking system 1, as faithfully as possible, mirrors the presentation of the elements and categories as they are presented in the existing databases and libraries when presenting the same elements and categories to the users of the reference checking system 1. To best achieve this mirroring, when generating a survey, the job profiles, categories, and category elements that the reference checking system 1 presents to users are preferable taken directly from the existing databases and libraries. One manner in which this may be achieved is by uploading the contents of such existing databases and libraries directly in the reference checking system 1 survey database 31, and having the user access the existing databases and libraries from the reference checking system 1. Alternatively, the content of these existing databases and libraries may be accessed using: a connection between the reference checking system 1 and the existing databases and libraries; a connection between the reference checking system 1 and a third party service that connects to the existing databases and libraries; manual entry; etc.

One example of an existing database or library that the reference checking system 1 may preferably utilize to generate surveys is O*NET. O*NET is the primary source of occupational information in the United States and a leader in providing occupational information abroad. Of course, the reference checking system 1 could also be configured to be compatible with foreign equivalents to O*NET. The O*NET database contains information on numerous job profiles, and for each job profile O*NET a list of the different mix of knowledge, skills, and abilities, activities, tools and tasks associated with that job profile. These distinguishing characteristics of a job profile define the key features of a job profile as a standardized, measurable set of variables called descriptors.

In the embodiment utilizing O*NET, the reference checking system 1 connects to the O*NET database in any manner described above (e.g. by accessing an uploaded copy of the O*NET database that is stored in the reference checking system 1 survey database 31, accessing directly an online version of the O*NET database, and/or using a third-party to access the O*NET database). For instance, the reference checking system 1 may include a survey generation device that includes a plurality of device specific generating modules to generate a survey based on parameters identified by information found on the third party (in this case the O*NET) website. Once the reference checking system 1 is connected to the O*NET database, the reference checking system 1 allows the user to search for relevant job profiles directly in the O*NET database. Alternatively, if the user already knows the Standard Occupational Classification (SOC) code associated with the position they are looking to hire for/fill, the user may directly input that SOC code. In embodiments using other existing databases or libraries that utilize other non-DOC code systems for organizing job profiles, the user may input other non-SOC job codes to locate the relevant job profile.

Based on the job profiles and/or SOC codes entered or selected by the user, the reference checking system 1—utilizing the O*NET database—will display the categories and category elements associated with that job profile/SOC code in the O*NET database. The user may then select any or all of the categories and elements, and/or the user may add additional categories and elements to finalize and generate a survey.

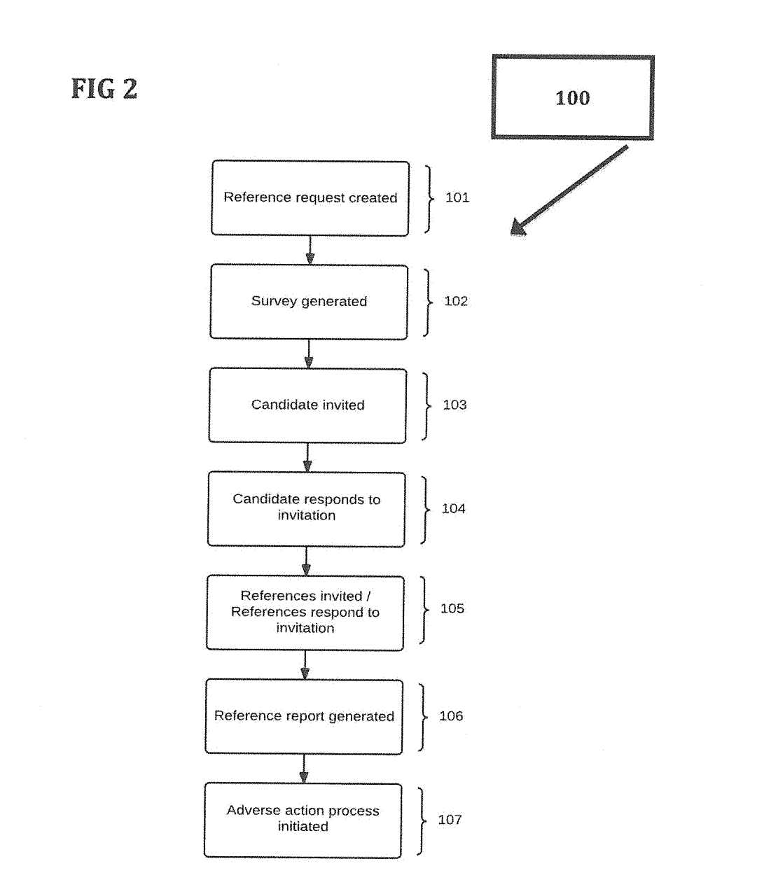

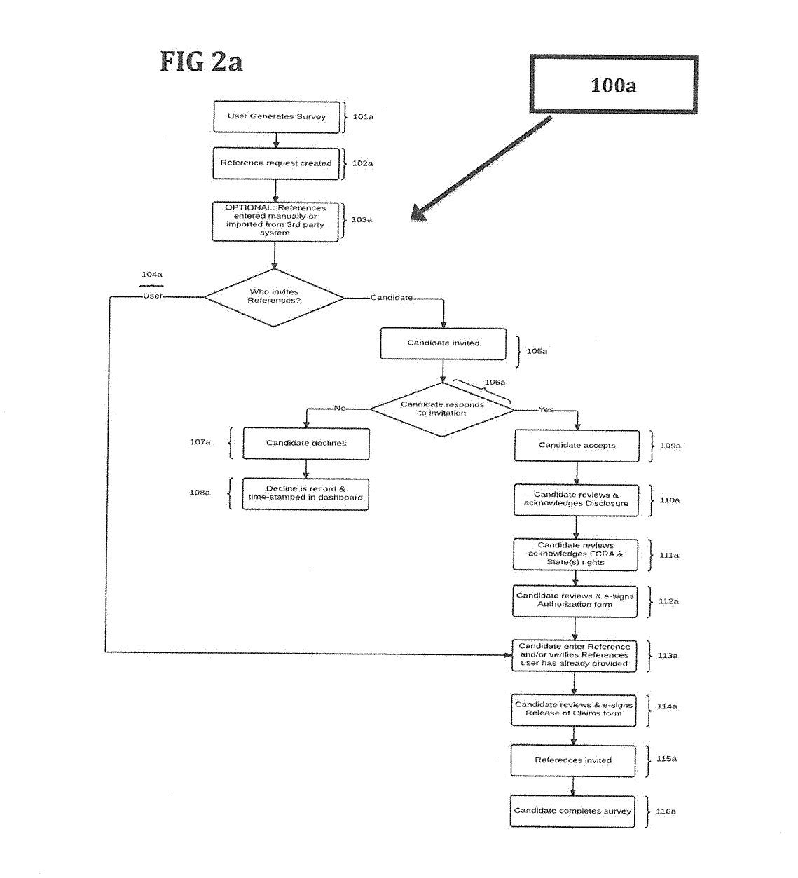

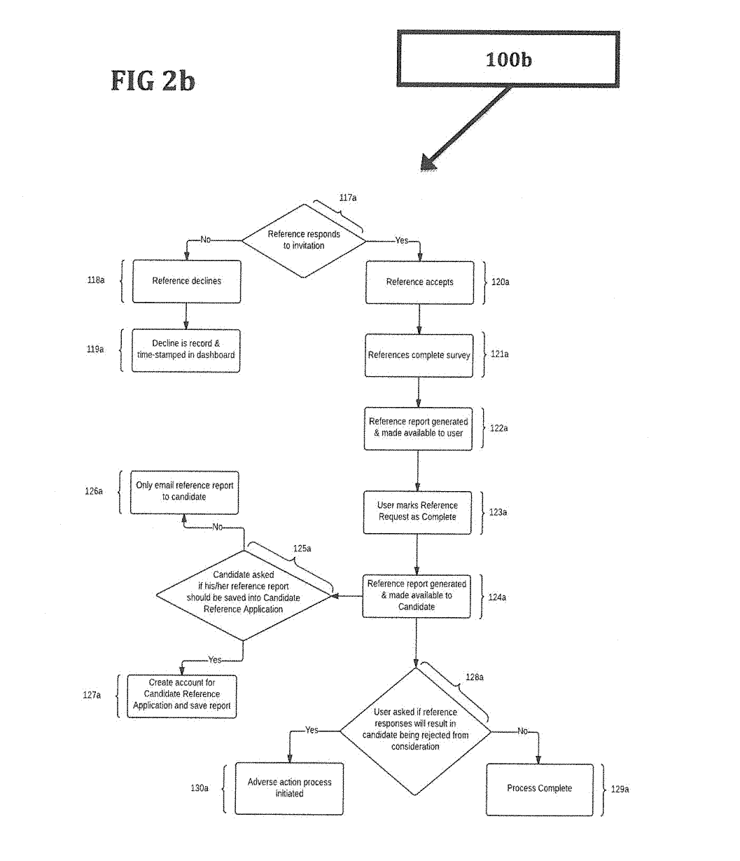

In the embodiment shown in FIG. 2a, a high level process flow of the reference checking process 100a according to the present invention is illustrated. The reference checking process 100a begins when a user creates and/or generates a reference survey at step 101a, Typically, step 101a is initiated when a user using an internet enabled computer 2 accesses the computer 3 of the reference checking system 1 through the Internet. The reference survey created at step 101a may be a reference survey for a single candidate, or a survey for multiple candidates. A unique identifier is assigned to each reference survey created, which is stored in the reference survey database 31.

In step 102a the user selects existing or inputs new information that will be used to generate a reference survey best suited for the job position. The process of generating a survey is described in more detail in the discussion of FIG. 3. In step 101a, in addition to specifying the job or position that the reference request is being generated for, the user is able to enter other specifications and/or requests to create a survey best tailored for the user's needs (e.g. job specific relevant knowledge, skills, abilities, etc) allowing the user to create free-form questions or fields; allowing a user to add or remove survey elements to the survey automatically generated by the process described in FIG. 3; allowing the user to replace the survey automatically generated by the process described in FIG. 3 with a user-provided survey; allowing the user to determine the type of scale (e.g. 1-10, 1-4, poor-average-high, etc.,) used to answer survey elements; etc. The information entered by the user in step 101a is stored by the computer 3 in the reference survey database 31 of the data storage 22. Once the survey of step 101a has been finalized (or in the event that a user is selecting a previously created reference request the user does not wish to modify), the reference checking process 100a continues to step 102a where a reference request is generated.

FIG. 3 illustrates one embodiment of generating a reference survey using a survey generation device, which includes device specific generating modules. As seen in FIG. 4c, the first step in one embodiment of generating a survey, the user searches through the reference checking system 1 survey database 31 to find a job profile or job profiles that are most relevant to the position the user is looking to hire for/fill. As illustrated in FIG. 4c, once the user has identified the relevant job profile(s), utilizing the survey database 31 the reference checking system 1 automatically generates a list of researched-job relevant categories as illustrated in FIG. 4d. After reviewing the categories, the user clicks on the arrow along side the category to display the job elements most closely associated with a high performing individual in the searched for job title in FIG. 4c, and category elements relevant to the selected job profiler(s) which is then presented to the user. In general, categories are larger groups into which one or more category elements fall into. Categories may optionally include a brief description of the category to better assist the user in selecting the relevant categories to include in the survey. The user is then able to, among other things: choose any or all of the categories and category elements to generate the survey, amend and/or delete any categories and category elements from those present by the reference checking system add in other self-generated categories and/or category elements to include with the categories and category elements presented by the reference check system 1; etc.

After the individual has finalized the categories and category elements to be included in the survey, the reference checking system 1 may prompt the user to input additional information and/or alter the information to assist in generating the survey. For example, the reference chocking system may prompt the user to select how the survey elements will be presented to references for evaluation.

Options for how the elements are presented for evaluation include: a yes/no option; a scale option as in FIG. 4f; or a free-form response option. For example, if one of the survey elements was: “adaptability” that references could be asked to evaluate the candidate on such an element in a number of ways, for instance by asking the references to answer “yes/no” as to whether the reference believes the candidate possesses the trait of “adaptability”; asking the references to provide a response to a scale as illustrated in FIG. 4g of Strongly Disagree, Disagree, Neutral, Agree, Strongly Agree or Not Applicable for the candidate's “adaptability”; and/or asking the references to input into a free-form box any comments and/or examples regarding the candidates “adaptability.”

The reference checking system 1 may be used with surveys generated in any number of ways and originating from any number of sources, including e.g. user provided surveys. However, in a preferred embodiment, the surveys created by the reference checking system 1 are generated by utilizing as much as possible the content of existing, well-established occupational information databases or libraries. Well-established occupational information databases and libraries provide a vast resource of not only a comprehensive listing of job profiles, but also well researched information related to the different traits, skills, knowledge, attributes, work styles, characteristics and other traits that are most desirable, most important, best suited, and/or otherwise most relevant to a particular job profile. Examples of sources of such well-established occupational information databases and libraries include, among others: experts, researched and/or industry standards; regulatory standards; national and/or international databases; government funded databases; etc.

One example of an existing database or library that the reference checking system 1 may preferably utilize to generate surveys is O*NET. O*NET is the primary source of occupational information in the United States and a leader in providing occupational information abroad. The O*NET database contains information on numerous job profiles, and for each job profile O*NET a list of the different mix of knowledge, skills, and abilities, activities, tools and tasks associated with that job profile. These distinguishing characteristics of a job profile define the key features of a job profile as a standardized, measurable set of variables called descriptors.

Based on the job profiles and/or SOC codes entered or selected by the user, the reference checking system 1—utilizing the O*NET database—will display the categories and category elements associated with that job profile/SOC code in the O*NET database. The user may then select any or all of the categories and elements, and/or the user may add additional categories and elements and/or alters the categories and elements to finalize and generate a survey.

In step 105a, using a survey distribution device that includes a plurality of device specific processing modules, the reference checking system 1 generates and transmits via email, SMS text message, letter, or other form of communication an invitation for the candidate to participate in the reference checking process as illustrated in FIGS. 2a and 2b.

In another embodiment, FIG. 2 illustrates a high level process flow of the reference checking process 100 according to the present invention. The reference checking process 100 begins when a user creates and/or generates a reference survey at step 101.

FIG. 4h illustrates one embodiment of a high level process flow 400 for generating a highly job relevant reference survey according to the present invention. Before reference survey 400 begins, the user is presented instructions as illustrated in FIG. 4i to facilitate using process 400 for creating custom survey categories and custom survey elements.

Reference survey process 400 begins with step 401 where the user is prompted to create a Survey Category. To efficiently create a Survey Category in step 401a and as illustrated in FIG. 4j, the user is given the option to copy content from another survey category along with the corresponding survey (e.g. O*NET's job specific survey categories and elements) as stored in the reference survey database 31. The category is copied by selecting a category from the drop-down window. Copying a Survey Category and its respective elements often serves as a valuable starting point from which the content can be tailored to the specific job at hand.

The user is now prompted to create a unique, job specific name for the new category in step 401b and as illustrated FIG. 4j. Furthermore, in step 401c, the user is given the instruction to create a display name for the category that will be shown as the category heading on the surveys presented to reference respondents and on the reference report.

The flexibility in step 401 of having two naming opportunities allows the categories to have a very specific label while the display name may be more generic in nature that provides clarity and ease of use to the reference respondents as well as reviewers of the reference report.

After completing step 401c, the user clicks the ‘continue’ button and is taken to the next step in process 400 which is step 402 where the user describes the category created in 401. In step 402a and as illustrated in FIG. 4k, the user is prompted to provide a description of the category to help those taking the survey understand the kind of information being collected when responding to the reference survey.

Next, the user is prompted in step 402b and illustrated in FIG. 4k, to create instructions for the candidate and instructions for the reference respondents in step 402c on how to respond to the category questions. For example, the user could enter instructions for the candidate that read as: “Please indicate the extent to which yon Disagree or Agree that you possess the following attribute.” On the other hand, the user could enter instructions for the reference that read as: “Please indicate the extent which you Disagree or Agree that <<CandidateName>>possess the following attributes.”

Upon completion of step 402 described above, the user clicks the ‘continue’ button and is taken to step 403 of process 400 to create a survey scale. In step 403a and as illustrated in FIG. 4l, the user is prompted to choose the desired number of scale response options that will show on the reference survey. The response options are selected from a pulldown menu as illustrated in FIG. 4l.

The survey scale options consists of 2 to 7 responses which allow the individual taking the survey to indicate a level of agreement/disagreement or frequency. The options are displayed on the survey from as a range from left-to-right, from negative (e.g. Strongly Disagree, Disagree, or Never) to positive (e.g. Strongly Agree, Agree, or Always).

After selecting the survey scale, the user is provide the option in step 403b and illustrated in FIG. 4m, to type in descriptive adjective labels for the numerical response choices for the selected scale.

Upon completion of step 403 of process 400, the user clicks the ‘continue’ button and is taken to step 404 to create survey elements. The user enters one element at a time for each question and scale element, the name of the element (name is optional for questions) and the text of the statement or question for the scale elements and free form questions. In step 404a and as illustrated in FIG. 4n, the user creates the scale response elements. In step 404b, the user is prompted to create the free-form survey elements.

The user selects the ‘Add/Update Survey Element’ button to build the individual elements that will be available in the category. The added elements appear on to the right-hand side window as illustrated in FIG. 4n.

Step 405 of process 400 enables the user to save the category and elements, the question element names and descriptions and the type of scale for each element that are identified individually and as seen on the right hand side of the screen in illustration FIGS. 4o.

When all the elements have been added in step 405a, the user clicks on the ‘Create Survey Category’ button and the data entered in during process 400 is stored into reference survey database 31. Upon saving all the elements, a survey category is created and is made available in the survey library for the user to select when creating a reference survey as in FIG. 2a, step 101a. This completes the reference survey process 400 as illustrated in FIG. 4h.

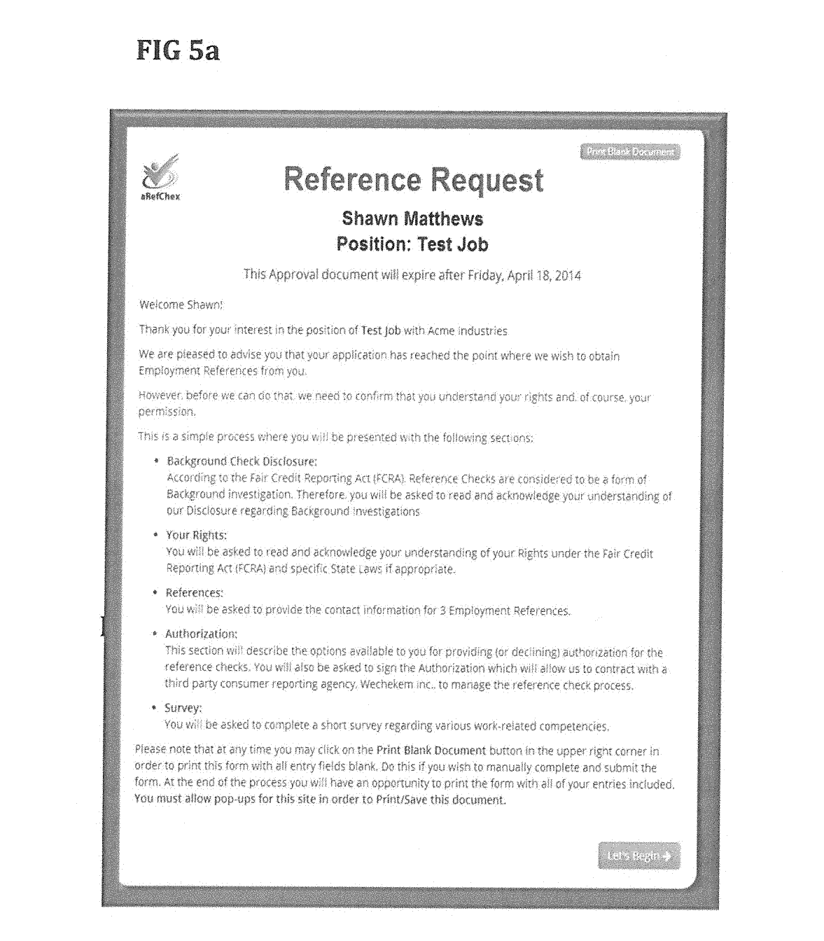

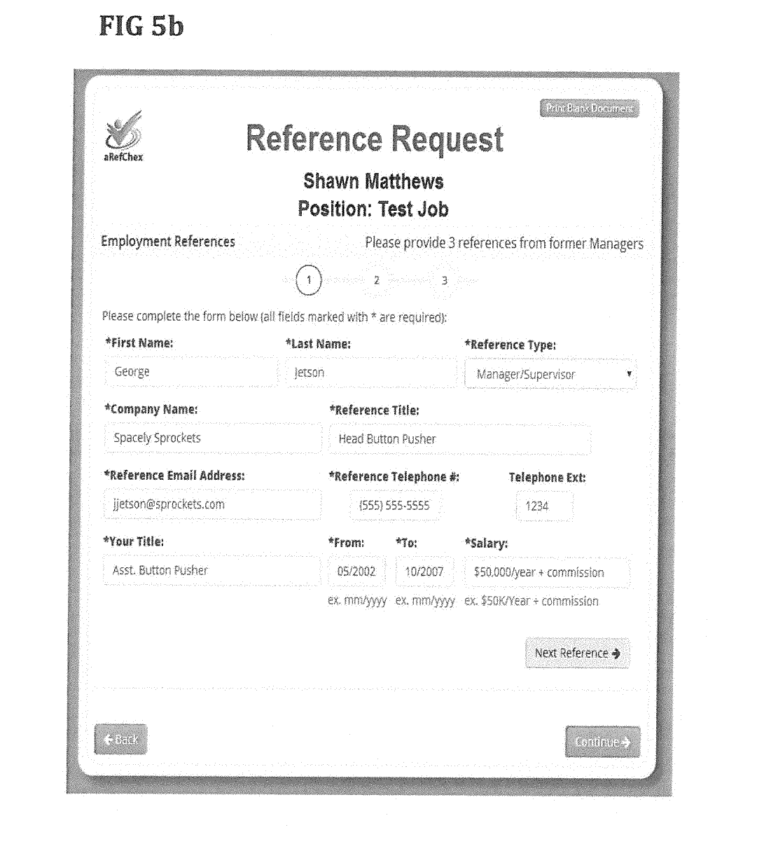

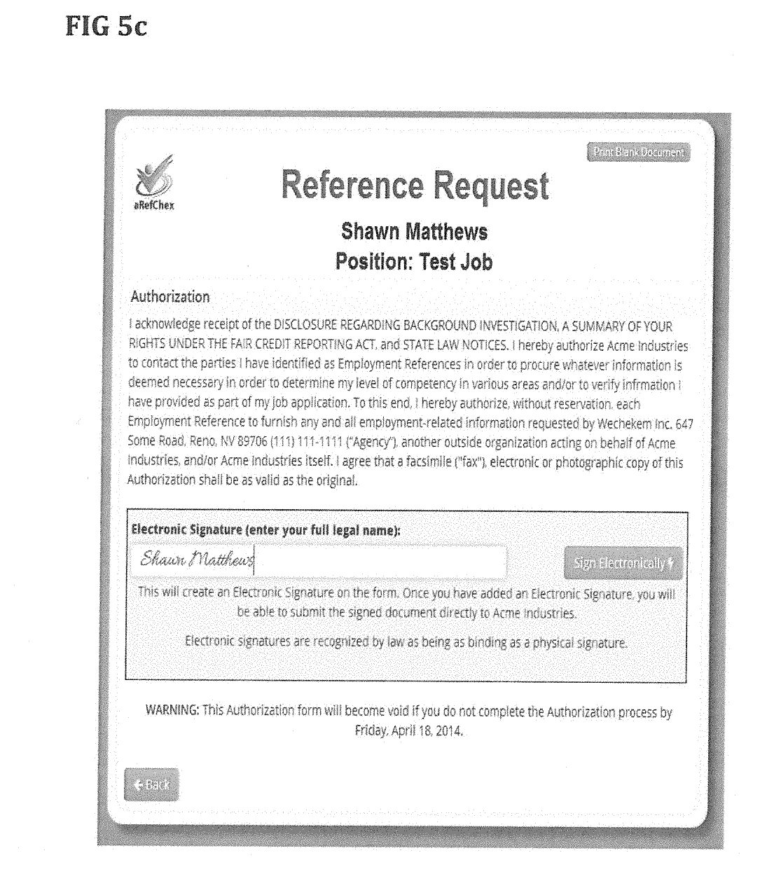

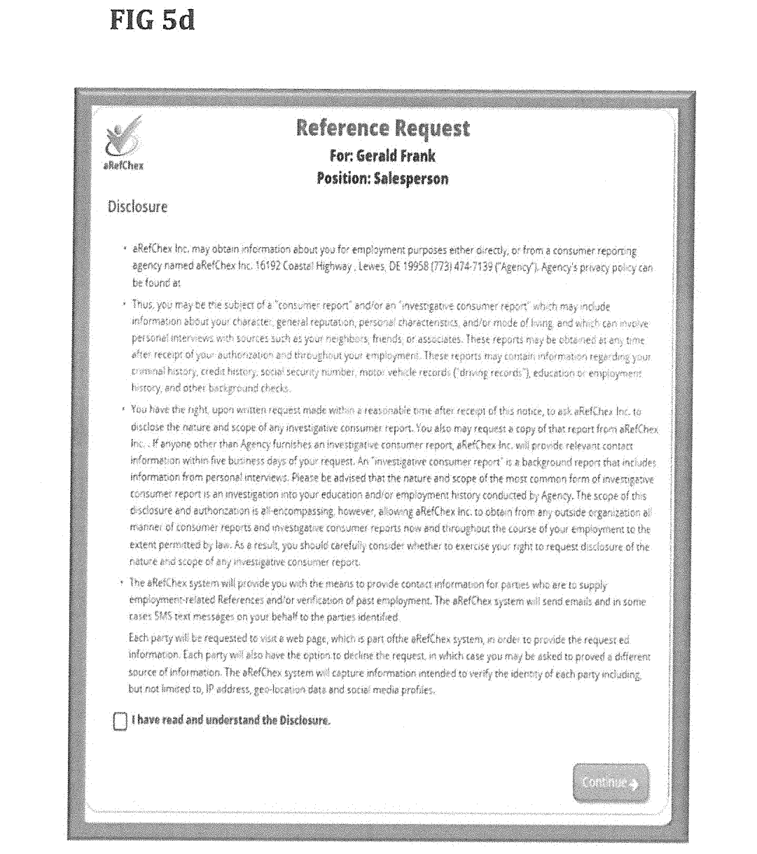

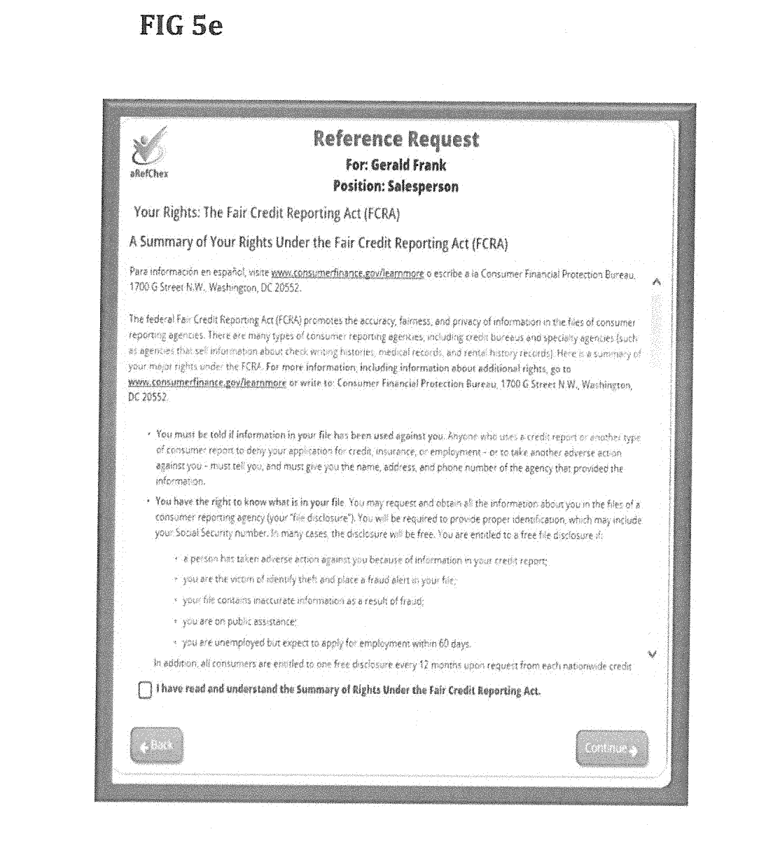

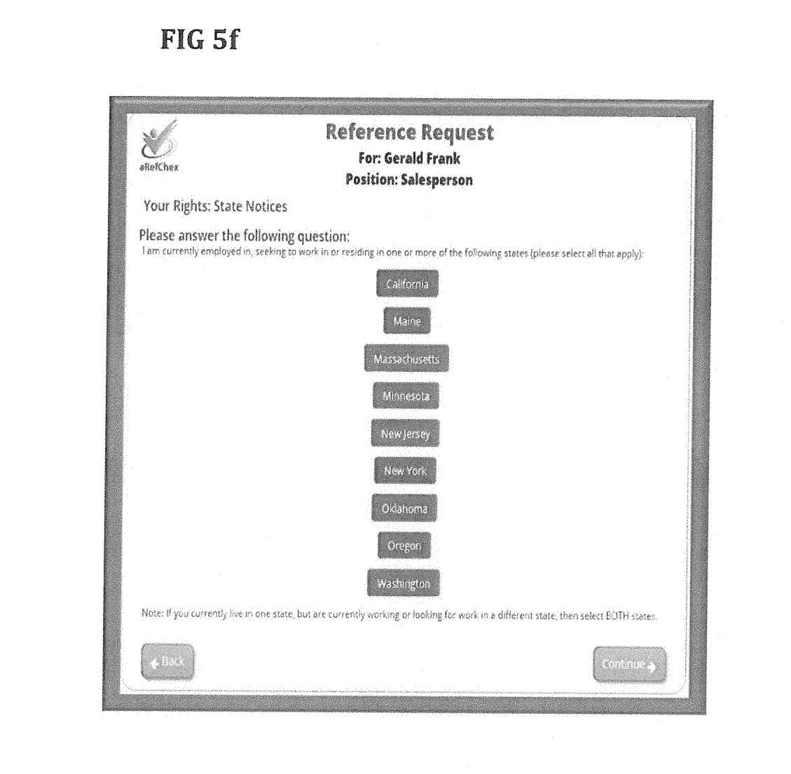

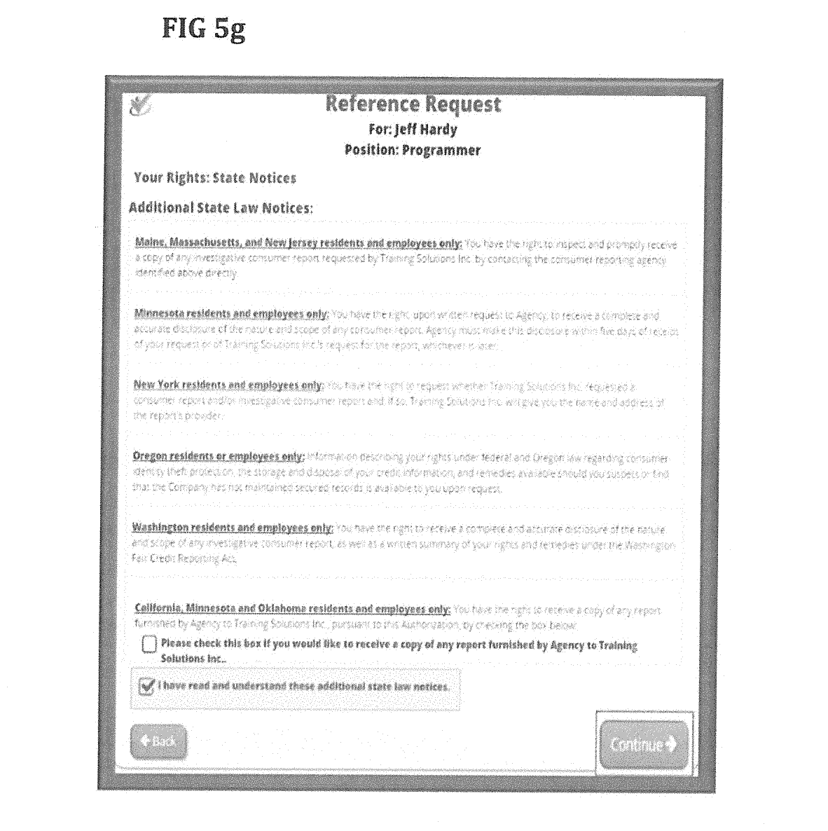

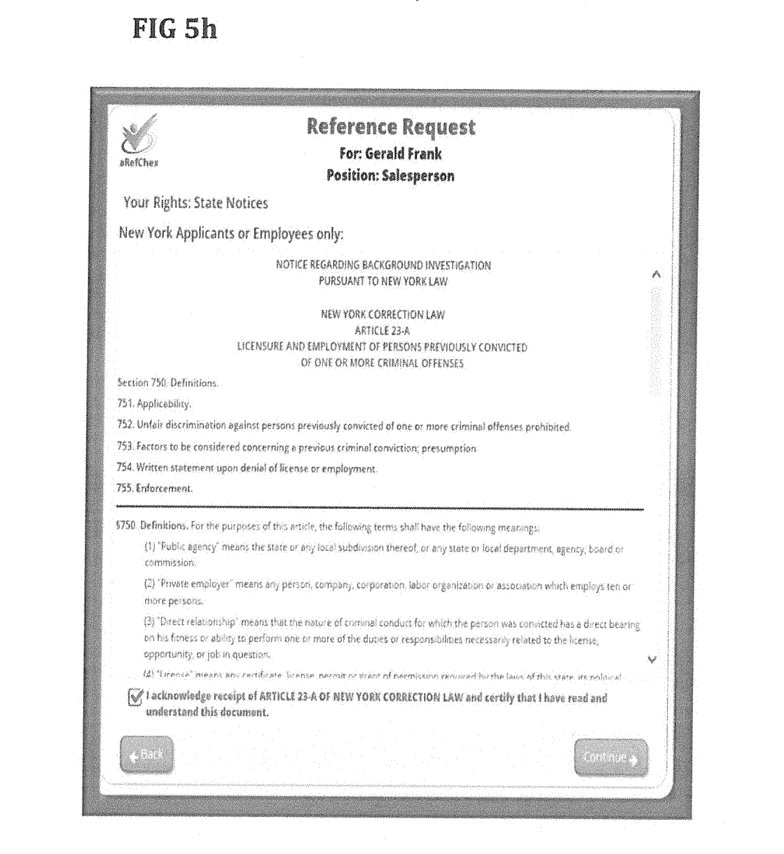

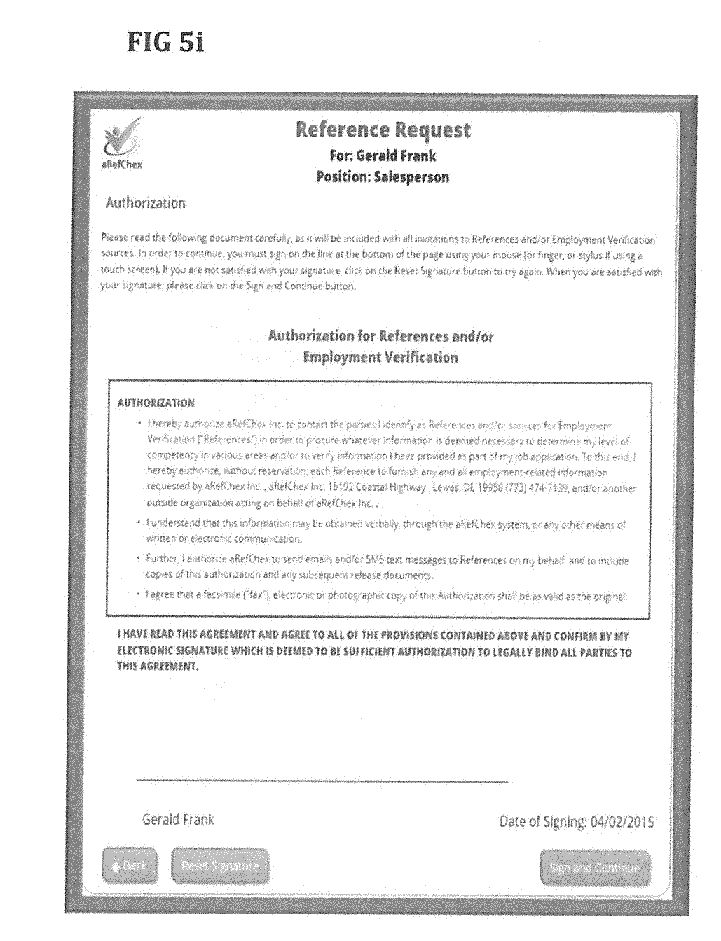

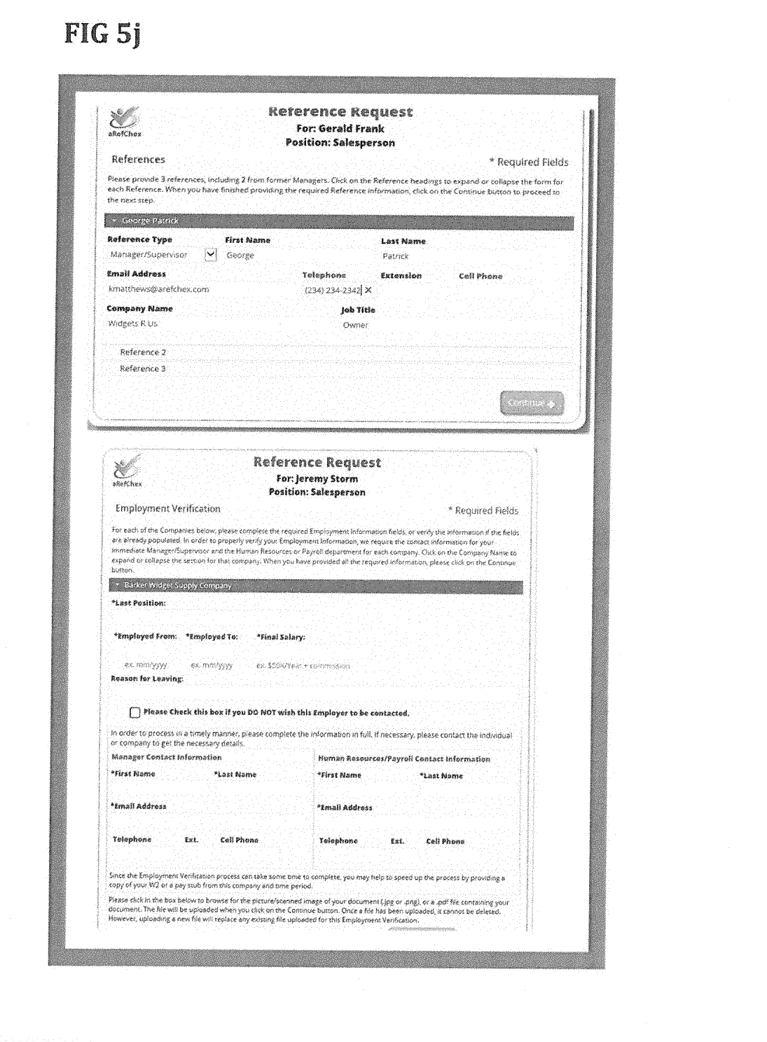

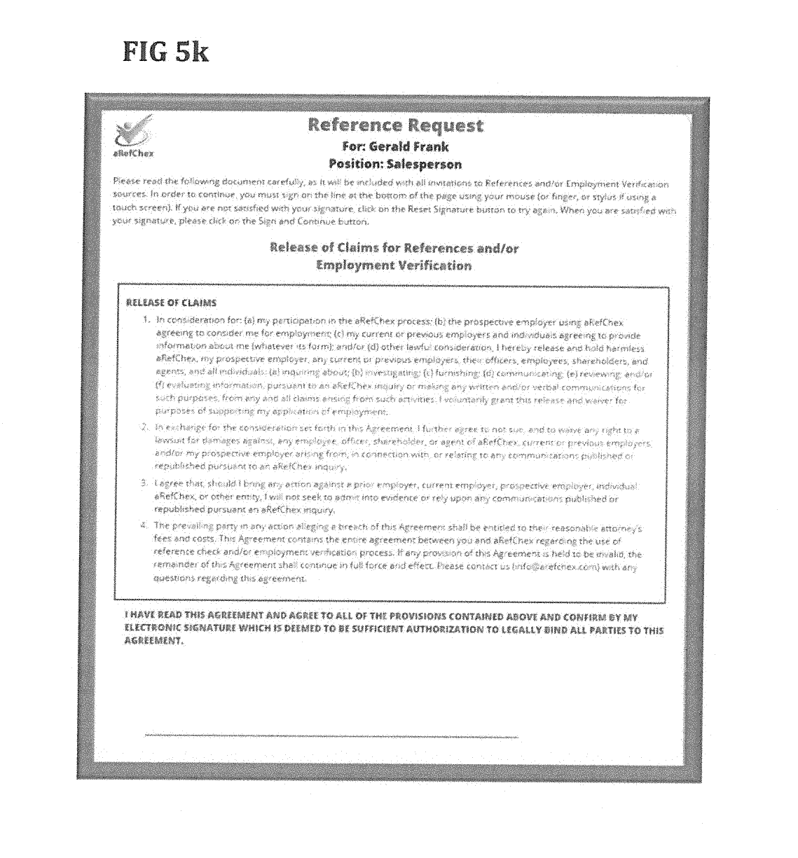

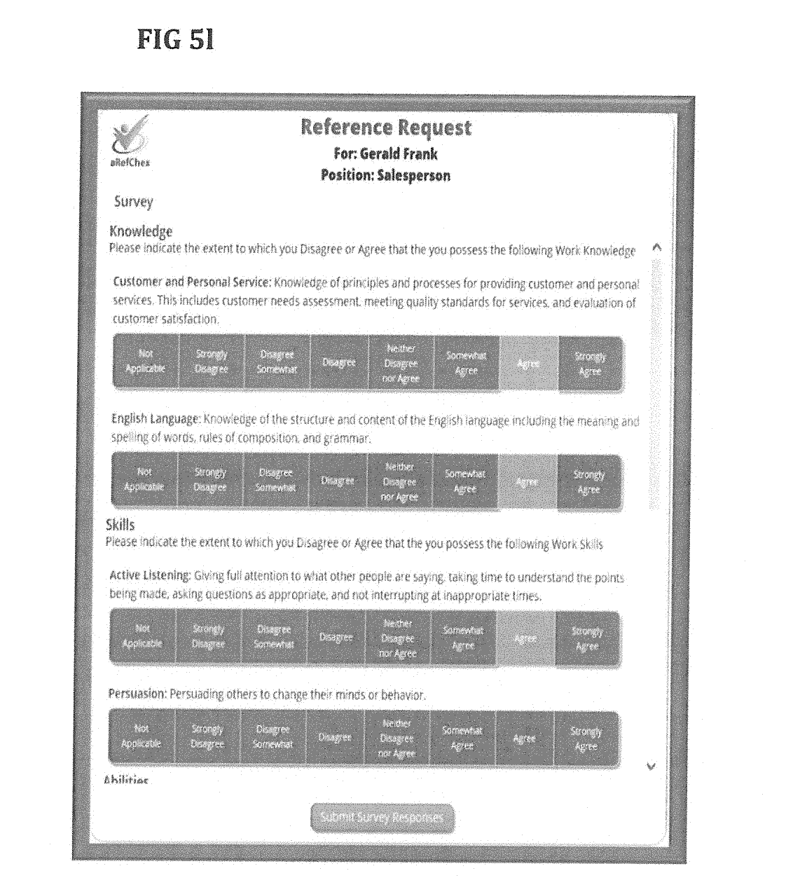

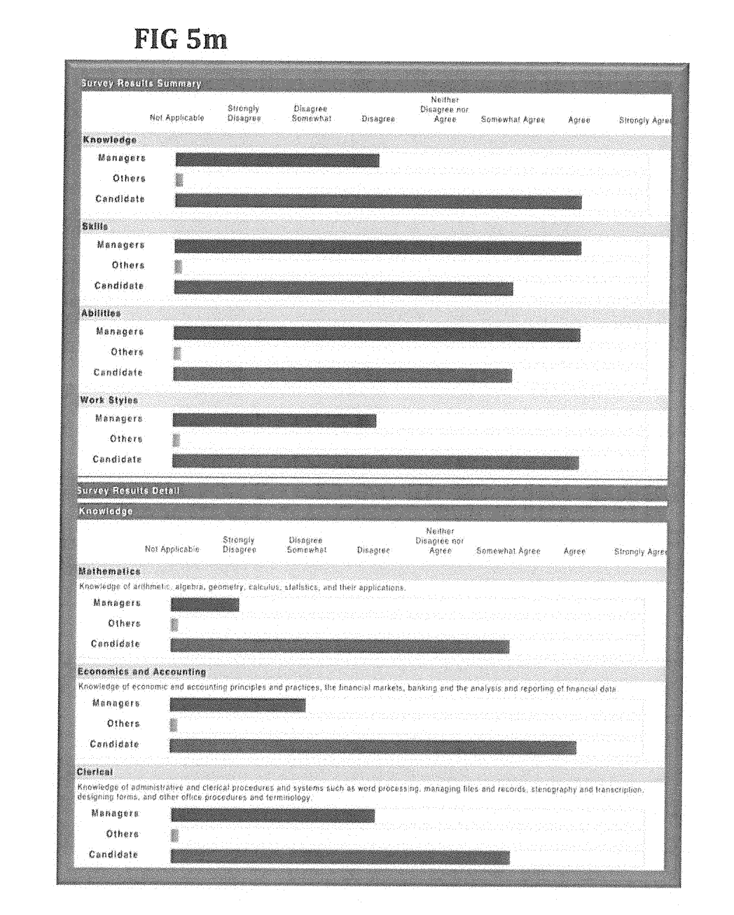

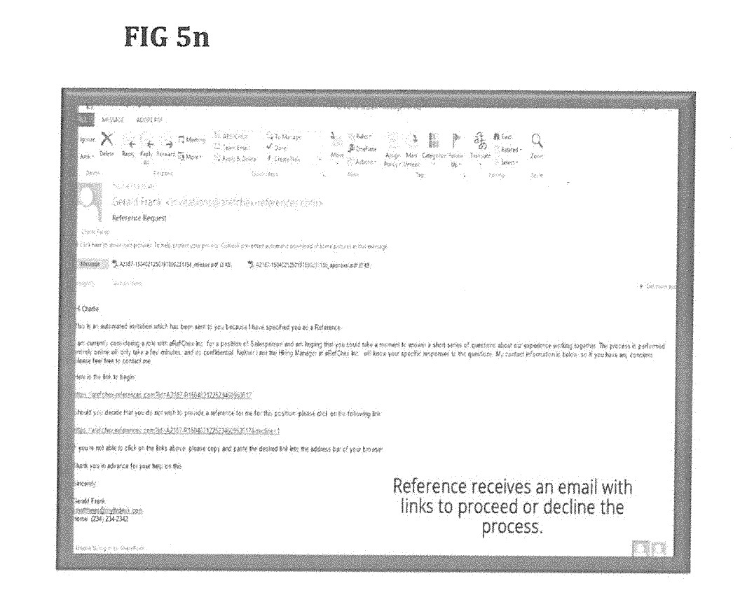

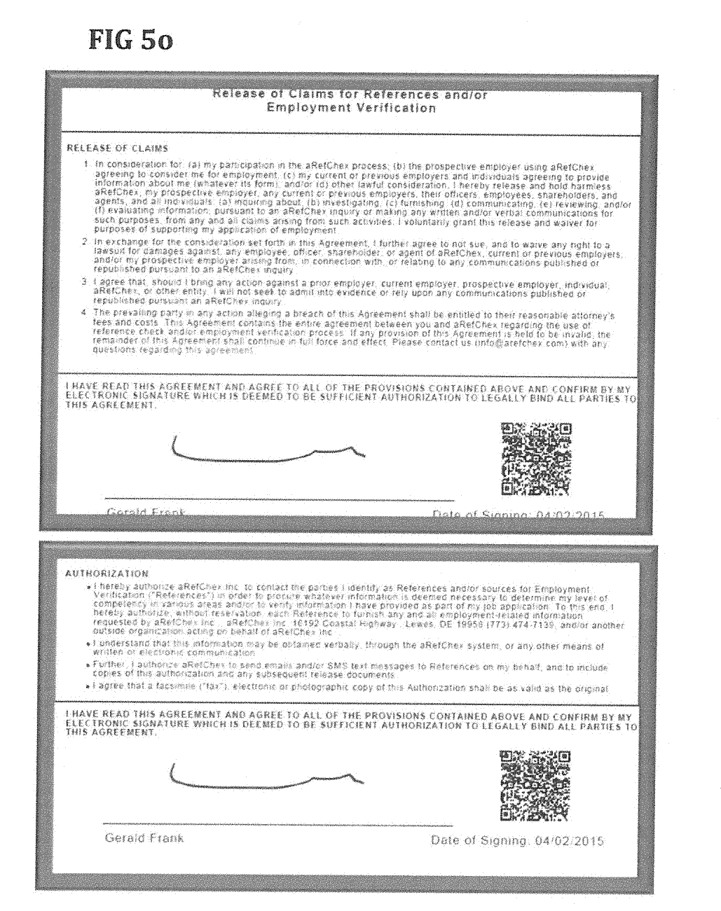

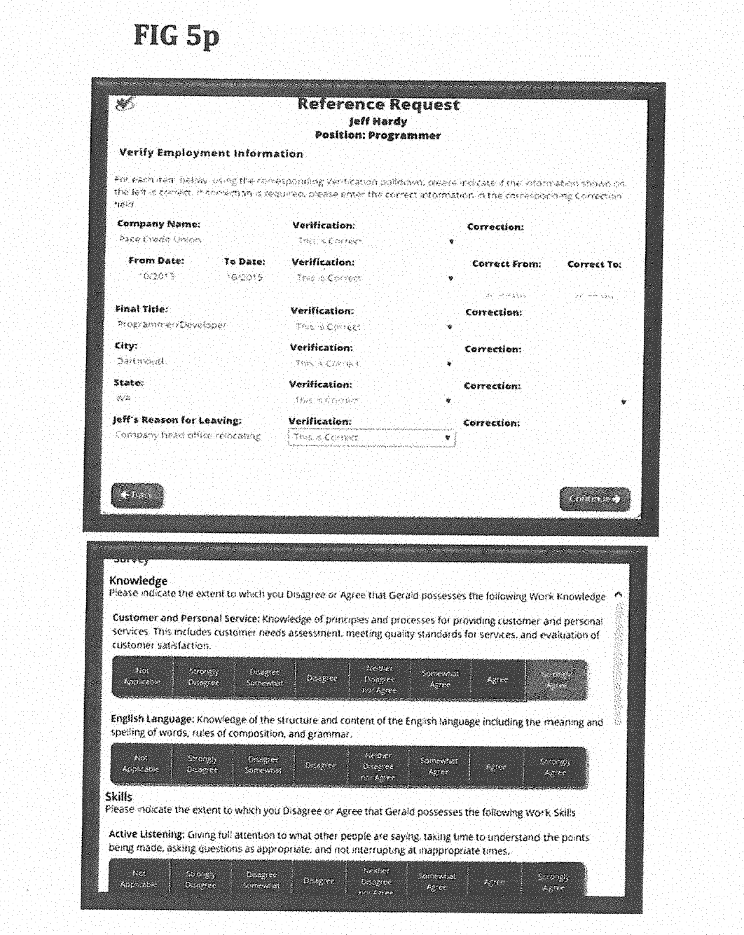

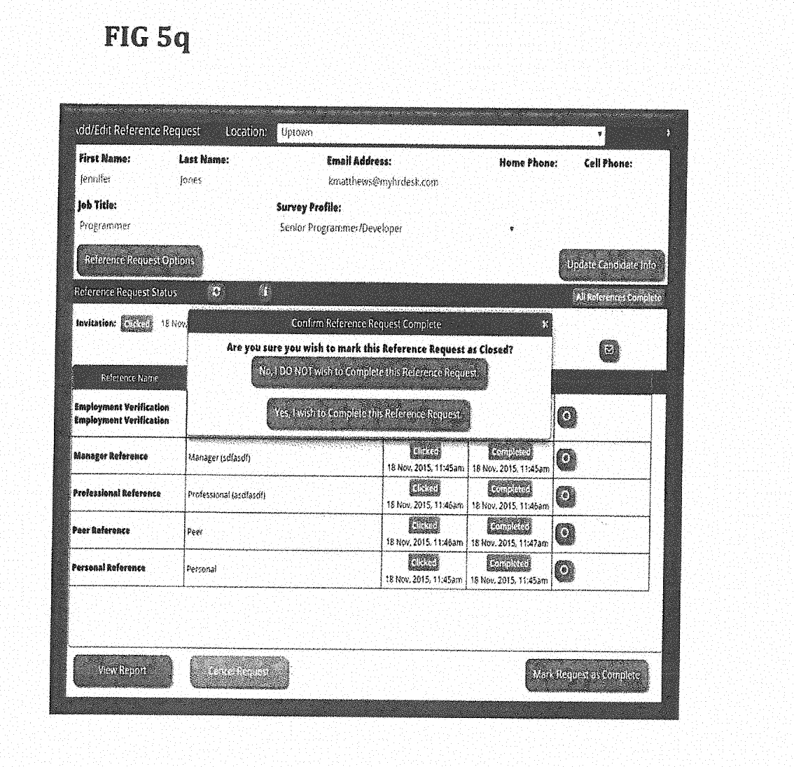

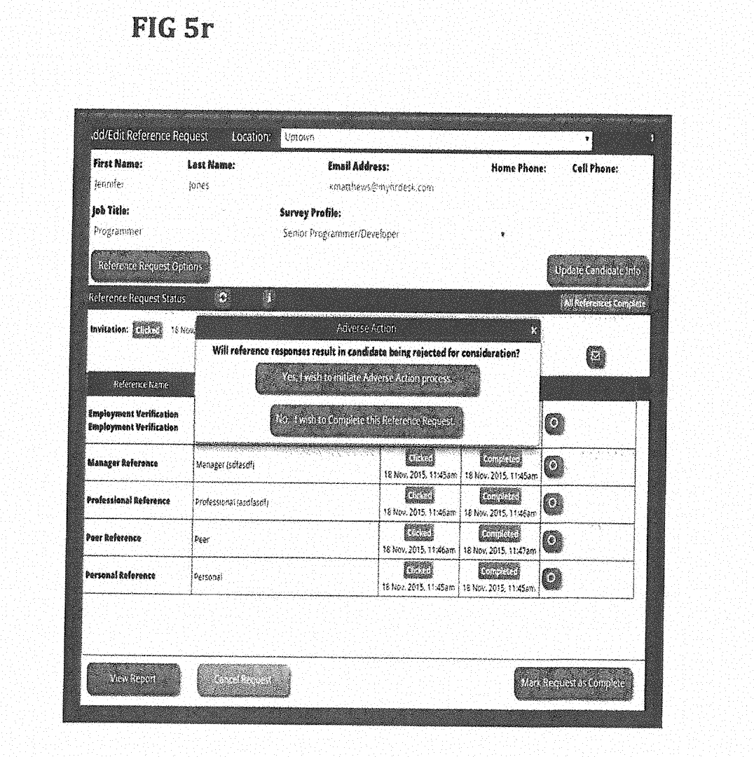

In step 103 the reference checking system 1 generates and transmits via email, SMS text message, letter, or other form of communication an invitation for the candidate to participate in the reference checking process 100 using a survey distribution device that includes a plurality of device specific processing modules. An example of one embodiment of the invitation that is transmitted by the survey distribution device to the candidate is illustrated in FIG. 5a. As illustrated in the example invitation of FIG. 5a, in the invitation the candidate is provided with information about and instructions for the subsequent steps of the reference checking process 100. Also, as illustrated in FIG. 5b, as part of the invitation, the candidate is requested to provide the names and contact information for references.

As illustrated in FIG. 5b, in addition to requesting the names of references, the candidate invitation may optionally also request the candidate to provide additional information such as job title, reference type (e.g. manager, co-worker, peer, subordinate, professional acquaintance, friend, etc.), responsibilities, salary, dates worked, etc. Other items that may also additionally or optionally be included in the invitation sent to a candidate in step 103 include, but are not limited to: a disclosure of the candidate's rights under Fair Credit Reporting Act (FCRA); an authorization requesting permissions from the applicant for the user to contact the references (e.g. such as the example authorization request illustrated in FIG. 5c); a limit-of-liability release form; a candidate self evaluation survey having elements that mirror or are identical to those elements on the survey sent to references; a free-form box in which the candidate can write a personalized message that will be sent to the referenced) along with the invitation sent to references in step 105; additional instructions or criteria the user wishes the candidate to follow; etc.

In step 104 of the reference checking process 100, the candidate responds to the invitation transmitted in step 103 by, among other things: providing the names and contact information of references; reading and acknowledging any disclosures provided in the invitation; signing any required authorizations; submitting any self-evaluation surveys or additional information requested by the user; etc. The contact information for the references may be stored for future use. For instance, this information can later be sold or shared with third party entities who are also looking for new employees.

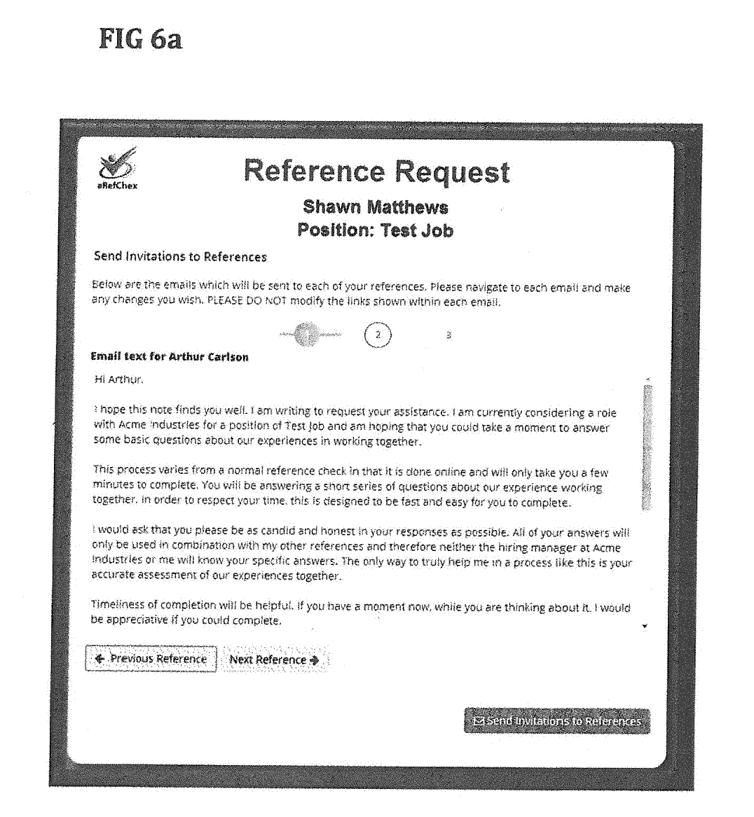

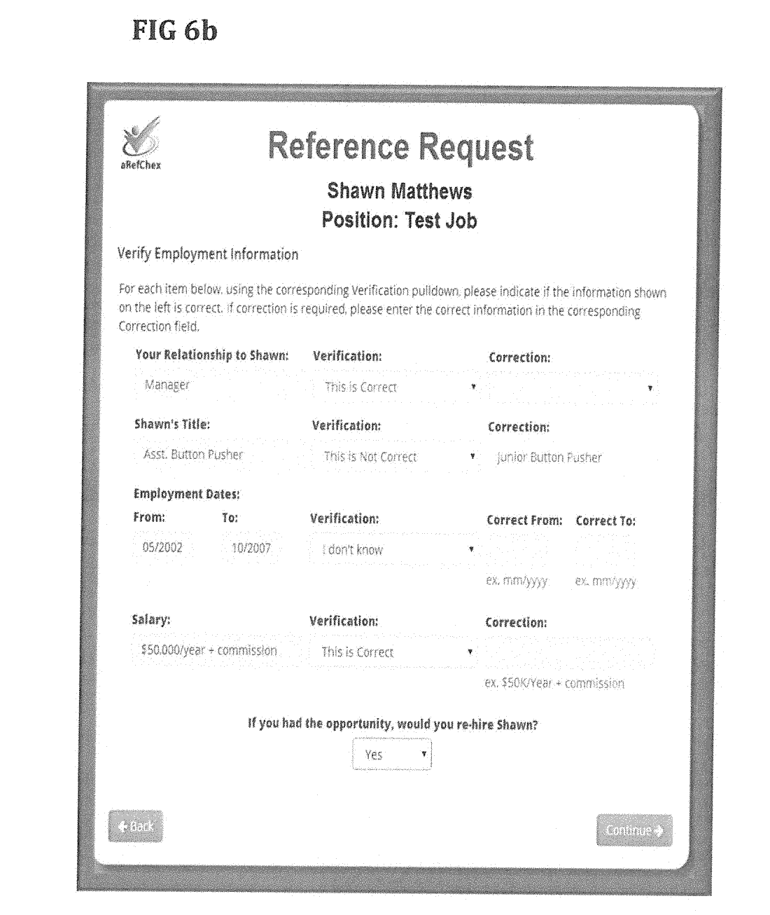

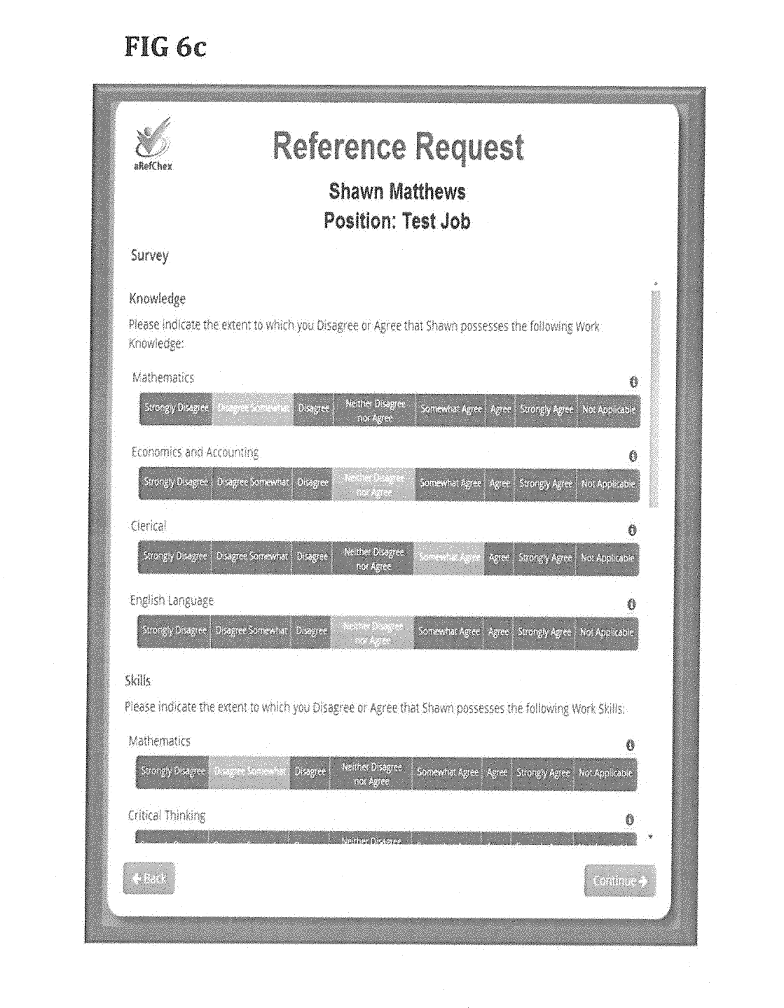

Once the candidate has completed step 103, in step 105 a reference invitation in the form of an email, SMS text message, letter, or other form of communication (such as the embodiment illustrated in FIG. 6a) containing information, instructions, and a copy of or a link to survey generated in step 102 is transmitted to the references designated by the candidate. Prior to sending invitations to the references, the computer 3 generates unique identifiers to each reference. FIG. 6a illustrates an example of one embodiment of how such a reference invitation may be formatted and presented to a reference.

As illustrated in FIG. 6b, in embodiments where the candidate was asked to provide additional information (such as job title, reference type (e.g. manager, co-worker, peer, subordinate, professional reference), responsibilities, salary, dates worked, etc.), the references in step 105 may optionally be additionally requested to verify and/or correct/amend and/or indicate that they “don't know” the information provided by the candidate. Illustrated in FIG. 6c is an embodiment of how a survey may be presented to the reference for completion.

Completed and submitted surveys are stored by the computer 3 in the survey database 31. In step 106, after all the references have completed and submitted the survey (or, if the candidate has provided more references than required, after a minimum required number of references have responded), the surveys are compiled in an organization database to generate a reference report 301. Compilation of the surveys and generation of a reference report 301 may occur automatically once the reference checking system 1 receives the minimum required number of completed surveys. Alternatively, a user may request compilation of the surveys at any point and a reference report 301 may be generated at any time that the user determines that a sufficient number of references have responded. Compilation of the surveys and generation of a reference report is performed by the analysis module 30.

FIGS. 2a & 2b illustrate alternative embodiment of a high level process flow of the reference checking process 100a & 100b according to the present invention. The reference checking process 100a & 100b begins when a user generates and/or creates a reference survey at step 101a. Typically, step 101a is initiated when a user using an Internet enabled computer 2 accesses the computer 3 of the reference checking system 1 through the Internet.

In step 101a, the user selects existing or inputs new information that will be used to generate a survey best suited for the reference request. The process of generating a survey is described in more detail in the discussion of FIG. 3 and in process 400 of FIG. 4h. In step 101a, in addition to specifying the job or position that the reference request is being generated for, the user is able to enter other specifications and/or requests to create a survey best tailored for the user's needs. Examples of customizations that a user can make during step 101a to best tailor the survey to the user's needs are: setting the number of references that a candidate must provide; defining the type of individuals (e.g. managers, co-workers, subordinates, peers, friends, customers, professional references, etc.) that are or are not eligible to serve as references; predefining desired references to a specific profession or industry; pre-defining desired references from specific companies and/or specific positions; allowing the user to create free-form questions or fields; allowing a user to add or remove survey elements to the survey automatically generated by the process described in FIG. 3 and in process 400 of FIG. 4h; allowing the user to replace the survey automatically generated by the process described in FIG. 3 and in process 400 of FIG. 4h with a user-provided survey; allowing the user to determine the type of scale (e.g. 1-10, 1-4, poor-average-high, etc.) used to answer survey elements; etc. The information entered by the user in step 101a is stored by the computer 3 in the candidate database 34 of the data storage 22. When the survey of step 101a has been finalized (or in the event that a user is selecting a previously crested reference request the user does not wish to modify), the reference checking process 100a continues to step 102a in which the reference request is created.

The reference request created at step 102a may be a reference request for a single candidate, or a request for multiple candidates. A unique identifier is assigned to each candidate for whom a reference request is created, which is stored in the candidate database 34. In the event that the user has not previously submitted a reference request, or if the user wishes to modify a previously created reference request, the process continues to step 103a.

In step 103a, a user is given the option to decide if the references will be entered manual by the candidate or if they are imported from a third party system such as an applicant tracking system and/or a consumer reporting agency (CRA) system and/or a job board system, HRIS, RPO, temporary staffing firms, permanent placement firm, executive recruitment firm, payroll company or any other number of third party systems. If the references are imported from a third party system in step 104a, the present invention in step 114a allows the candidate to verify and/or edit the information pre-populated by the 3^{rd} party system.

In step 105a, the Candidate is invited by the reference checking system 1 by generating and transmitting via email, letter, SMS text message, or other form of communication an invitation for the candidate to participate in the reference checking process 100a. An example of one embodiment of the invitation that is transmitted to the candidate is illustrated in FIG. 5a. As illustrated in the example invitation of FIG. 5a, in the invitation the candidate is provided with information about and instructions for the subsequent steps of the reference checking process 100a.

In step 106a the Candidate responds to the invitation generated in 105a by clicking on either of two links in the invitation to indicate that the Candidate either declines or accepts the invitation to proceed with the reference checking process.

Step 107a represents the process flow when the candidate clicks on the link to decline participating in the reference checking process.

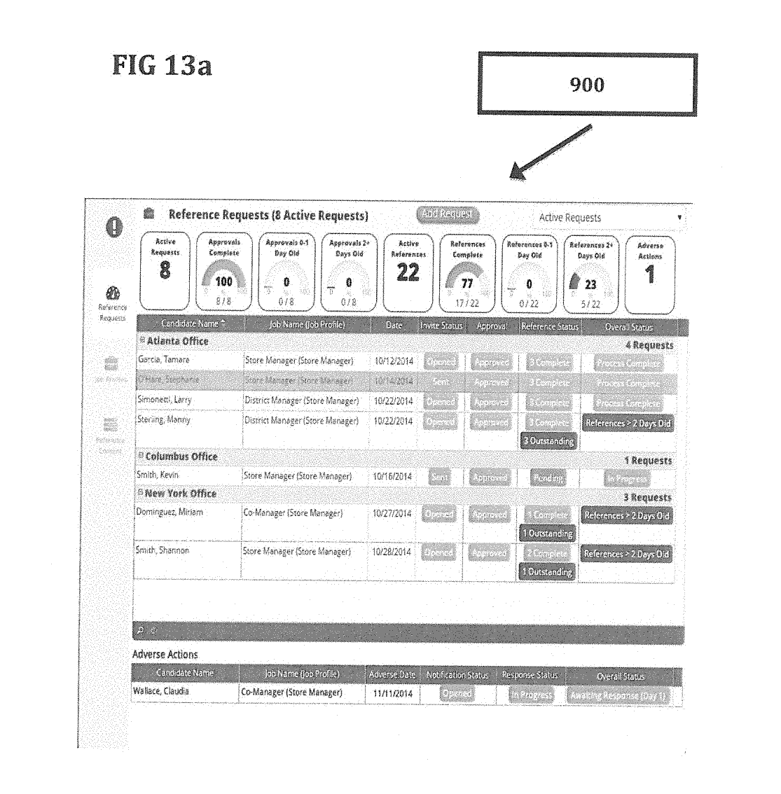

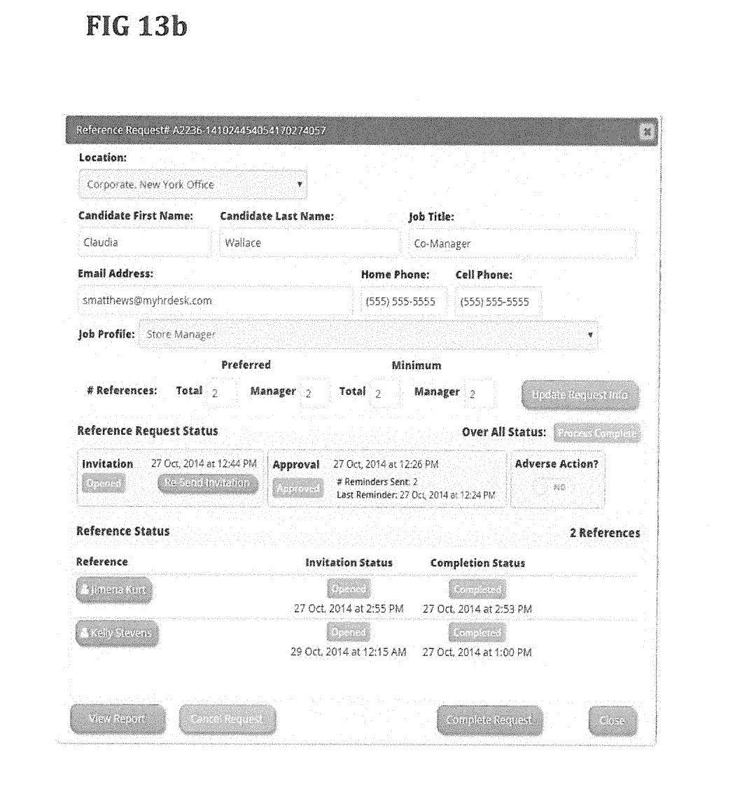

In step 108a the reference checking system 1 records and time-stamps that the candidate has declined and posts the candidates response on the dashboard as illustrated in FIG. 13a.

Step 109a represents the process flow when the candidate accepts to proceed with the reference check process.

In step 110a the candidate is presented a Disclosure form authorizing the user to obtain information about the candidate for employment purposes either directly, through social media, or from a consumer reporting agency (CRA). FIG. 5d is an example of the reference checking system Disclosure form. The candidate is requested to acknowledge the Disclosure form by clicking in the box next to the words “I have read and understand the Disclosure” and as illustrated in FIG. 5d.

In step 111a, the candidate is presented the FCRA legally mandated document entitled: “A Summary of Your Rights Under the Fair Credit Reporting Act” as well as relevant State Rights. Additionally, the candidate is requested to acknowledge the FCRA rights by clicking in the box next to the words: “I have read and understand the Summary of Rights finder the Fair Credit Repotting Act” and as illustrated in FIG. 5e.

Also in step 111a, the candidate is asked to indicate whether he/she lives or intends to apply for work in a specific State. The States listed in FIG. 5f are those that have specific rights and notices that are required by law to be presented to the candidate. The list of States may be updated as needed. For all States that the candidate has selected, the reference checking process 100a & 100b will display the appropriate State rights for the candidate to read and, if desired, send the candidate a copy of the States rights. The candidate is asked to check a box at the end of the listing of States rights and/or at the end of the specific state rights, to indicate that he/she has read and understands the States laws and as illustrated in 5g and 5h.

In step 112a, the candidate is presented an Authorization for References and/or Employment Verification agreement authorizing the employer-user (by name) to contact parties identified as reference and/or for employment verification. Similarly, the references are authorized to furnish employment-related information about the candidate. The candidate is requested to acknowledge the Authorization agreement by electronically signing below the statement: “I have read this agreement and agree to all of the provisions contained above and confirm by my electronic signature which is deemed to be sufficient authorization to legally bind all parties to this agreement.” FIG. 5i illustrates the Authorization for Reference and/or Employment Verification agreement and the electronic signature process.

In step 113a, the candidate is requested to enter the names and contact information for references and/or employment verification. Alternatively, when a 3^{rd} party system has pro-populated the reference companies and/or reference names, the candidate may be prompted to verify and/or edit the pre-populated content supplied by the 3^{rd} party system.

As illustrated in FIG. 5j, in addition to requesting the names of references, the candidate may be asked to provide employment verification information which may include such information as reference type (e.g. manager, co-worker, peer, subordinate, professional acquaintance, friend, etc.), job title, job description, salary history, dates worked, reason for leaving, etc.

In step 114a, the candidate is presented a Release of Claims Agreement that may state that the candidate holds-harmless all prospective employers, any current or previous employers, their officers, employees, shareholders, and agents, and all individuals: (a) inquiring about; (b) investigating; (c) furnishing; (d) communicating; (e) reviewing; and/or (f) evaluating information about the candidate. In addition, the candidate is requested to acknowledge the Release of Claims Agreement by electronically signing below the statement; “I have read this agreement and agree to all of the provisions contained above and confirm by my electronic signature which is deemed to be sufficient authorization to legally bind all parties to this agreement.” FIG. 5k illustrates the Release of Claims Agreement and the electronic signature process.

In step 115a the survey distribution device and plurality of device specific processing modules distribute a reference invitation to the references designated by the candidate in the form of an email, SMS text message, letter, or other form of communication (such as the embodiment illustrated in FIG. 6a) containing information, instructions, and a copy of or a link to the survey generated in step 101a. Prior to sending invitations to the references, the computer 3 generates unique identifiers for each reference. FIG. 6a illustrates an example of one embodiment of how such a reference invitation may be formatted and presented to a reference.

In step 116a the candidate is requested to complete the same reference checking survey about him/herself that was generated in step 101a. FIG. 5l illustrates an example of the survey that the candidate would complete.

The candidate's responses to the survey are graphically presented in the reference checking report as a point of comparison to the reference responses (e.g. manager, co-worker, peer, subordinate, professional acquaintance, friend, etc.) and as illustrated in FIG. 5m.

The reference response process of FIG. 2b 100b begins when a reference responds to the candidate's invitation, step 117a. Typically, step 117a is initiated when a user using an Internet enabled computer 2 accesses the computer 3 of the reference checking system 1 through the Internet.

In step 117a, the Reference responds to the invite that was generating by the survey generation device including a plurality of device specific generating modules. An example of one embodiment of the invitation that is transmitted to the reference is illustrated in FIG. 5n. As illustrated in the example invitation of FIG. 5n, the reference is provided with information about and instructions for the subsequent steps of the reference checking process in the invitation.

FIG. 5o illustrates example documents attached to the invitation email including: the Candidate's electronically signed Authorization to perform a reference and/or employment verification check as well as the candidates electronic Signed Release of Claims (e.g. liability). These documents are designed to assure the reference that the candidate welcomes his/her participation in the reference checking process. By attaching the signed Authorization and the Release of Claims to the invitation, the reference response rate is greatly increased and helps ensure that the user of system 1 will receive timely and candid feedback about the candidate.

In step 117a the reference responds to the invitation generated in 115a by clicking on either of two links in the invitation to indicate that the reference either declines or accepts the invitation to proceed with the reference checking process.

Step 118a represents the process flow when the reference clicks on the link to declines participating in the reference checking process.

In step 119a the reference checking system 1 records and time-stamps that the reference has declined and posts the reference's response on the dashboard. The dashboard is illustrated in FIG. 13a.

Step 120a represents the process flow when the reference accepts to proceed with the reference check process.

In step 121a the reference is requested to complete the reference checking survey that was generated in step 101a using the survey distribution device and plurality of device specific processing modules. FIG. 5p illustrates one embodiment of the reference survey that is transmitted to reference.

Upon completion of some or all of the reference responses to the surveys ((e.g. manager, co-worker, peer, subordinate, professional acquaintance, friend, etc.), the reference check report is generated in step 122a.

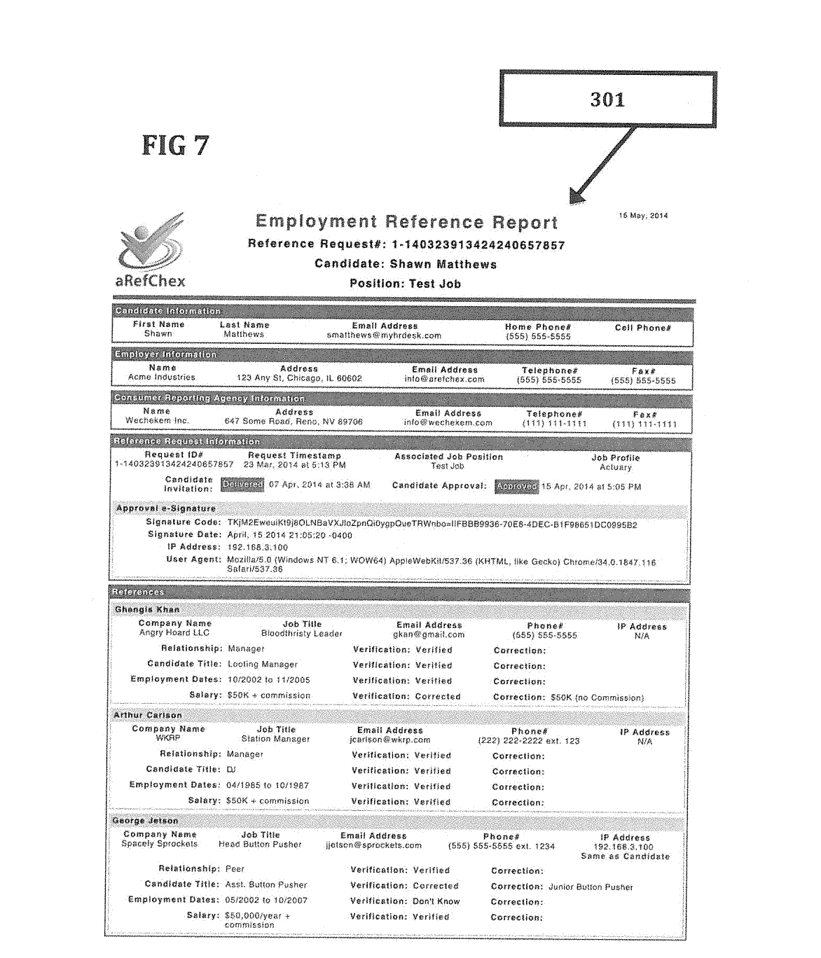

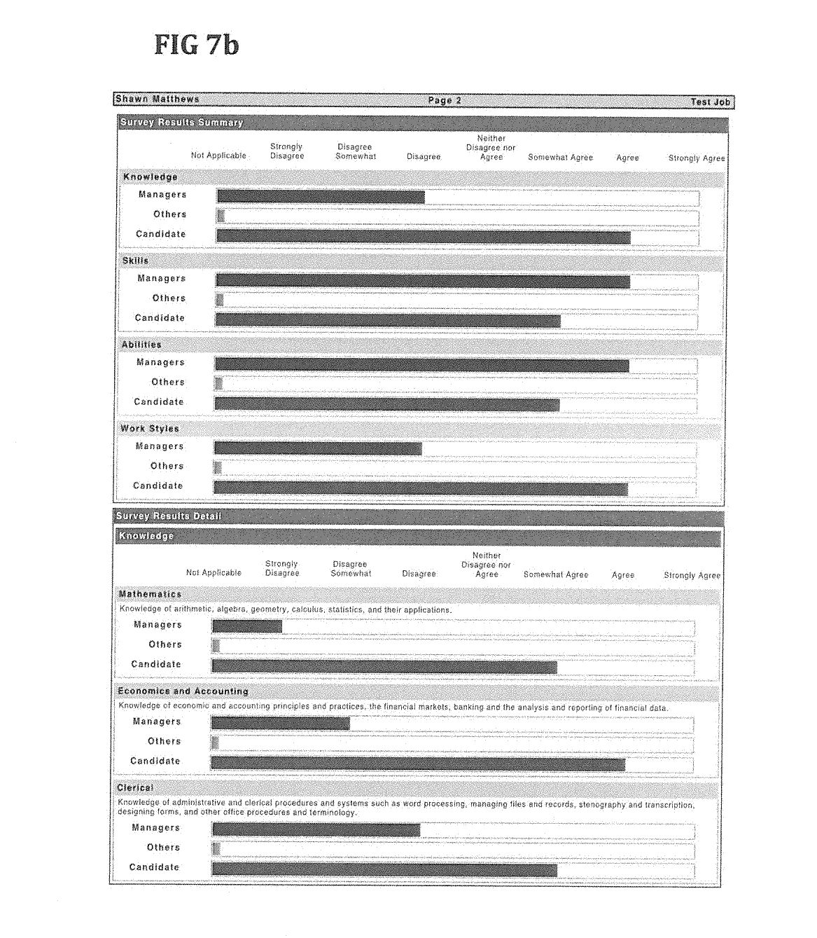

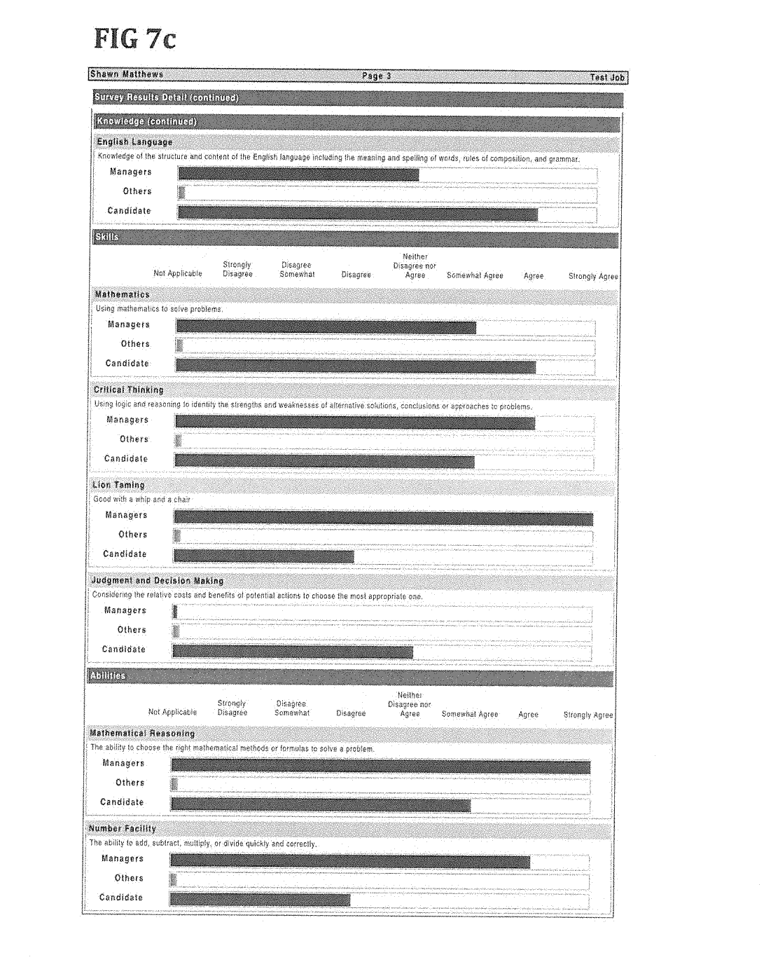

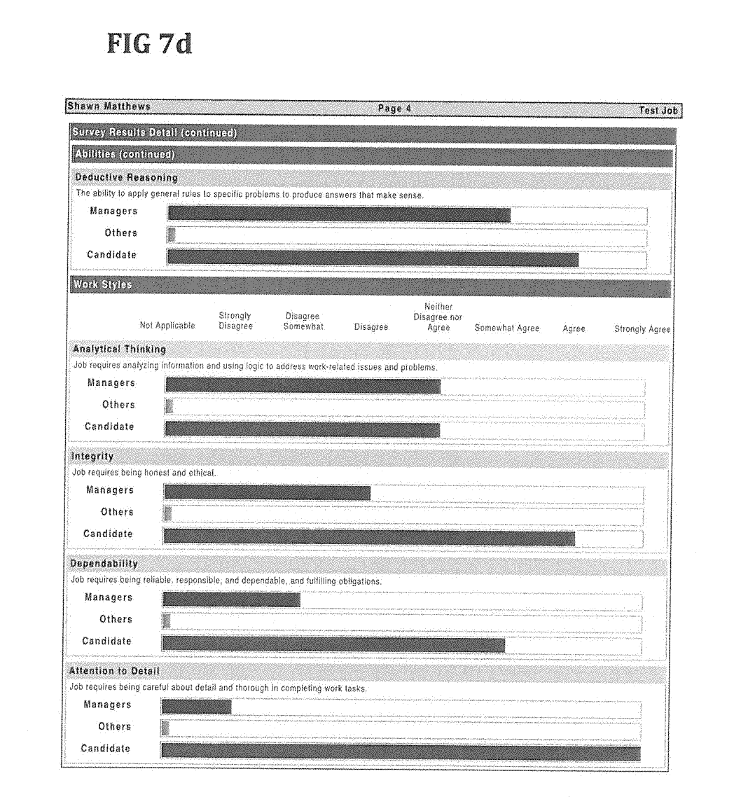

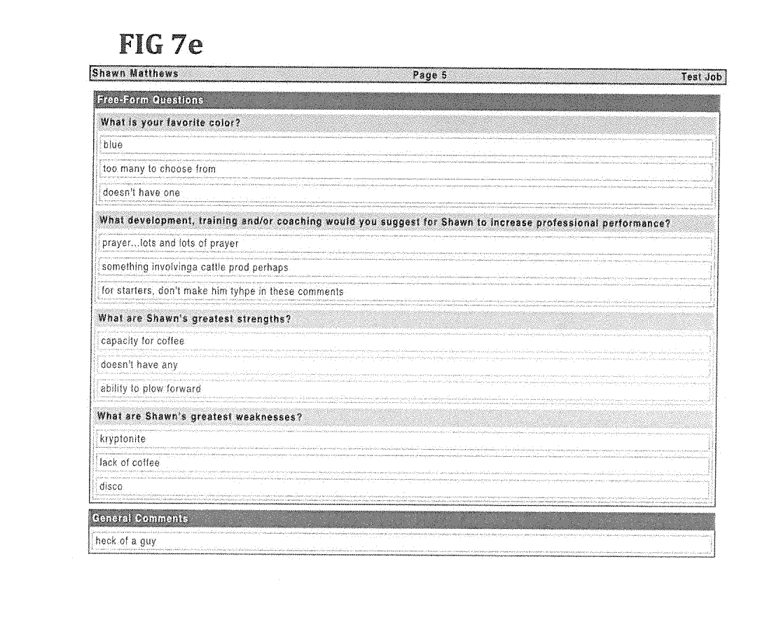

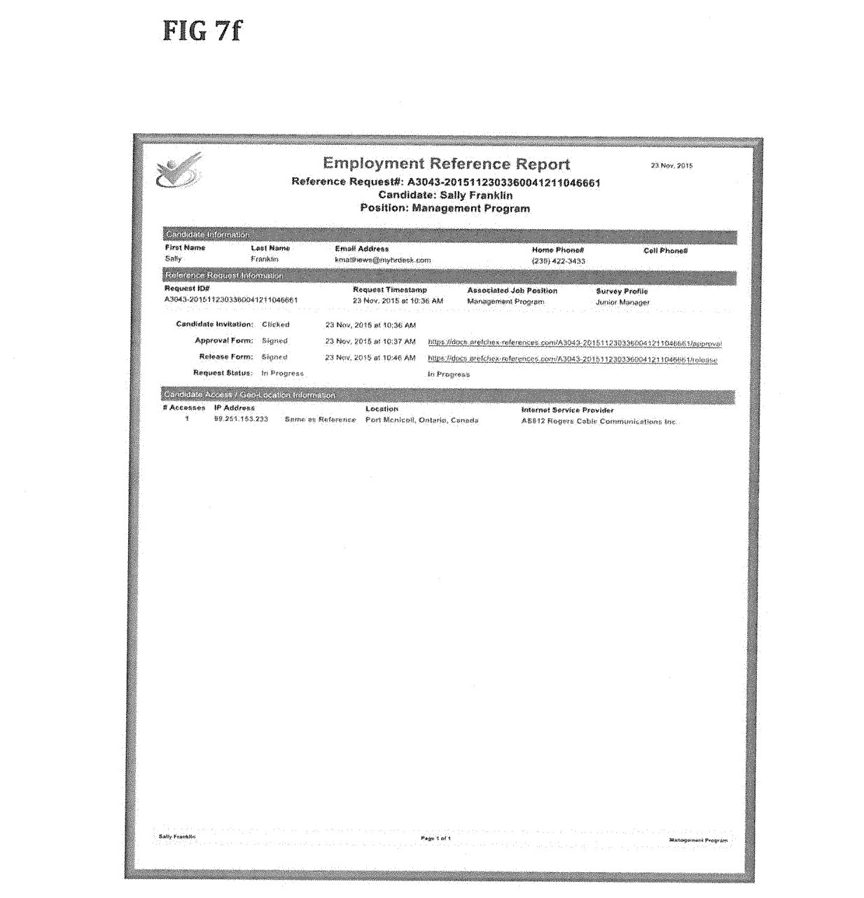

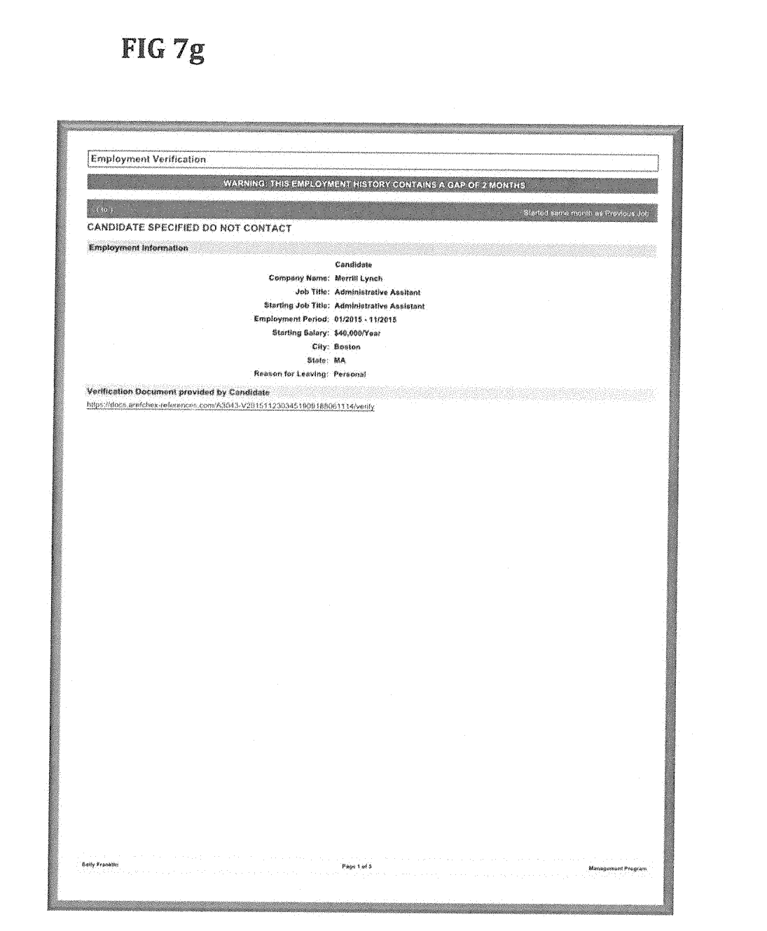

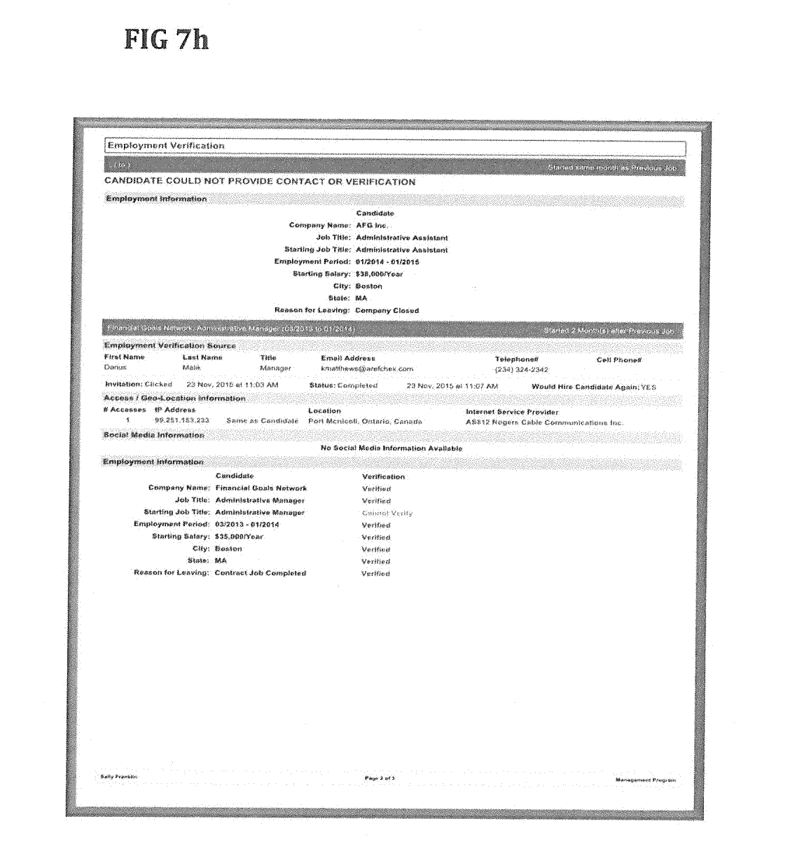

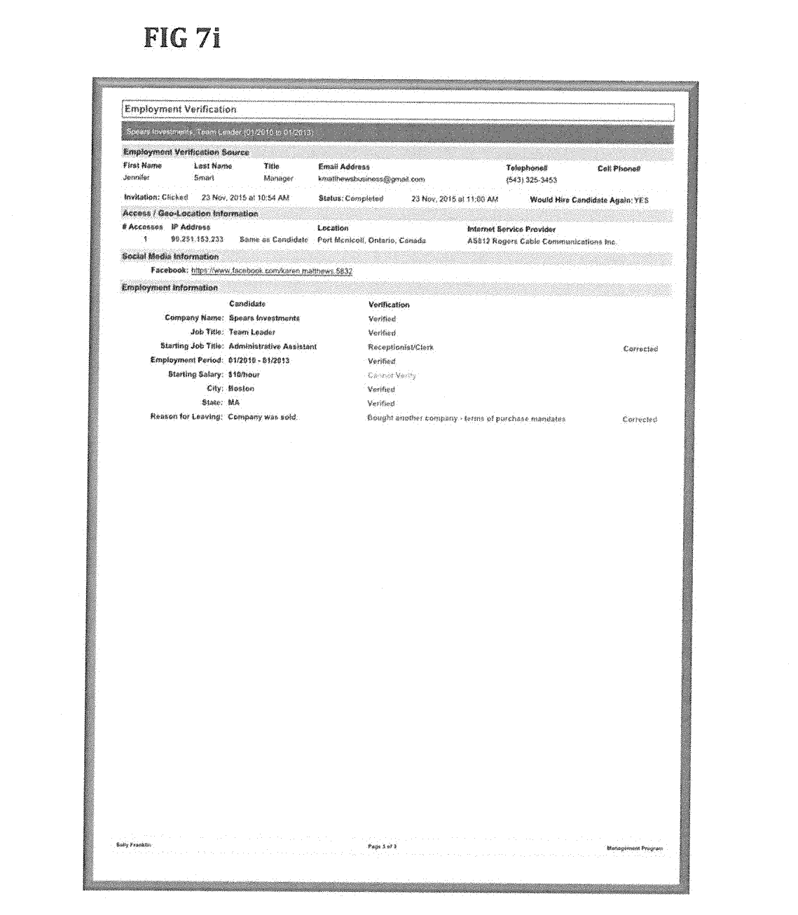

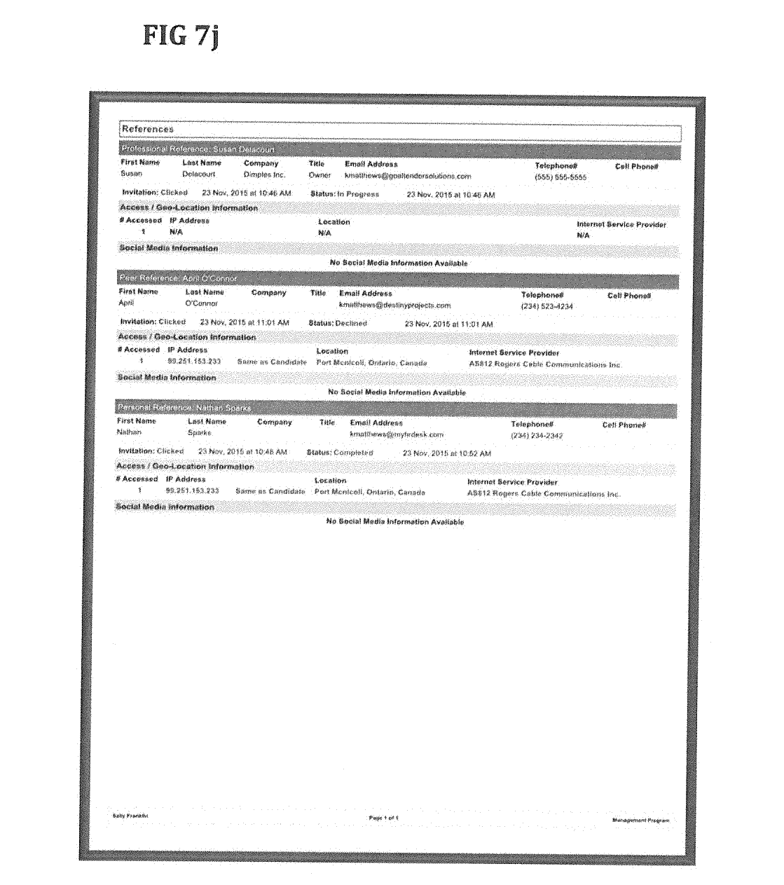

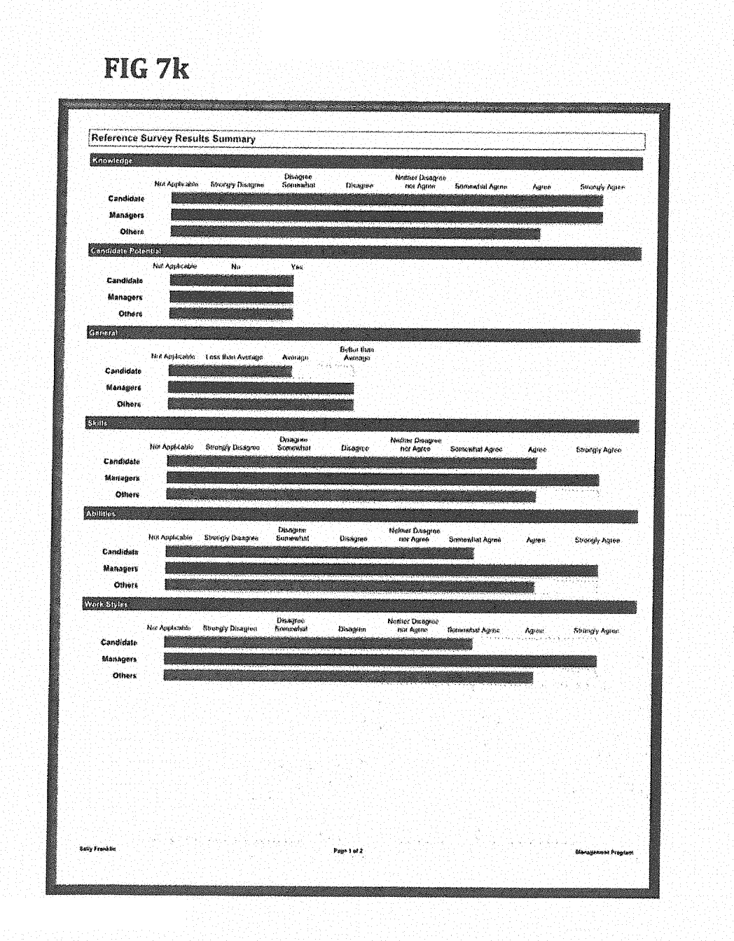

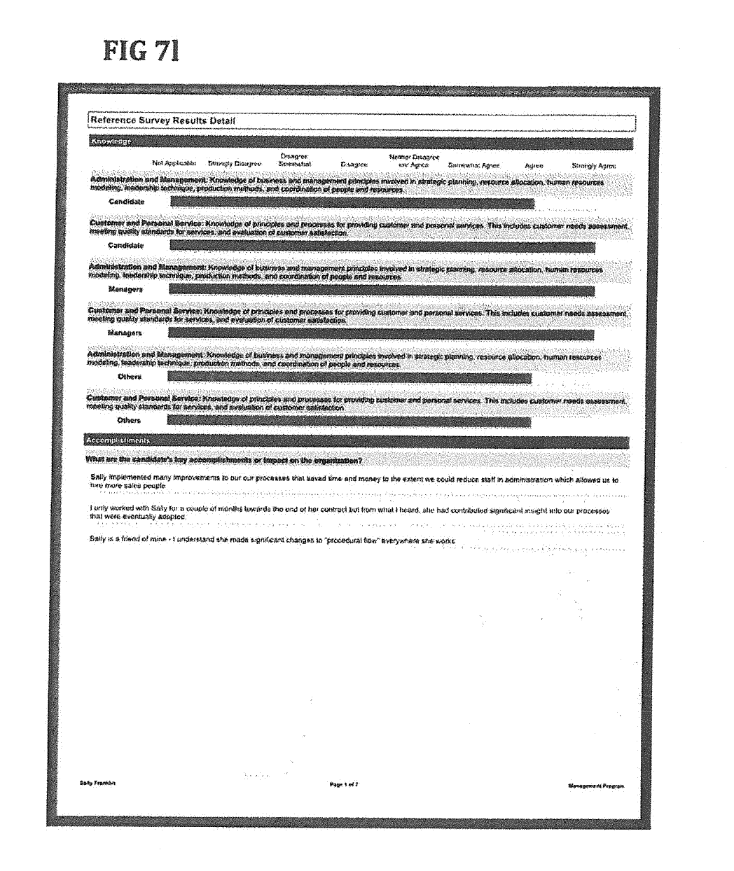

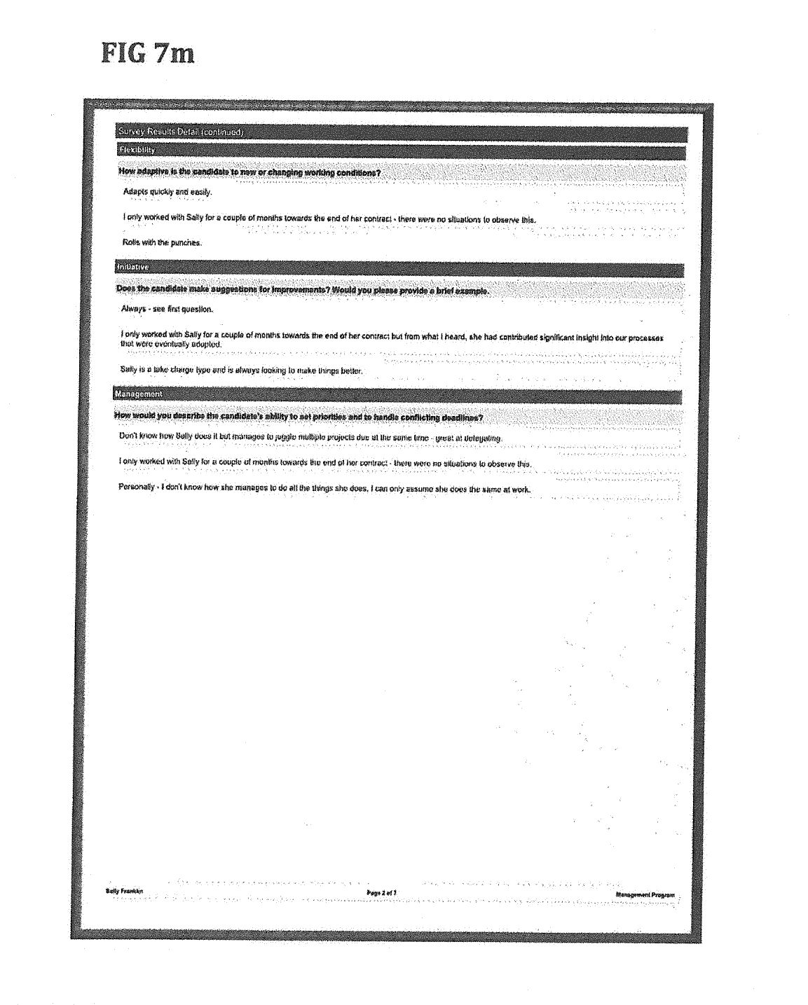

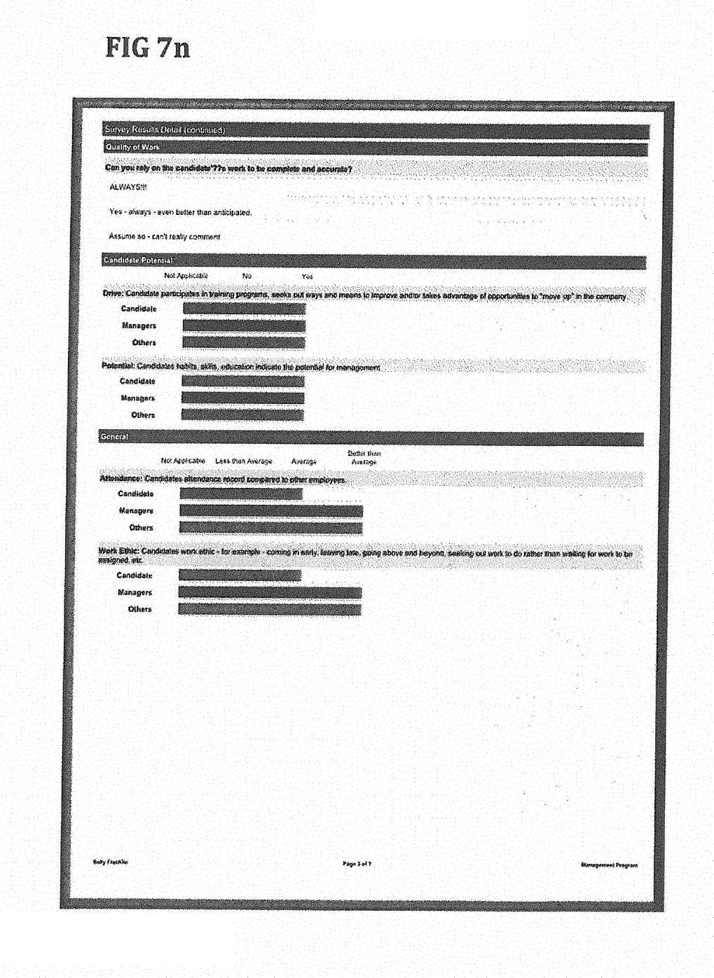

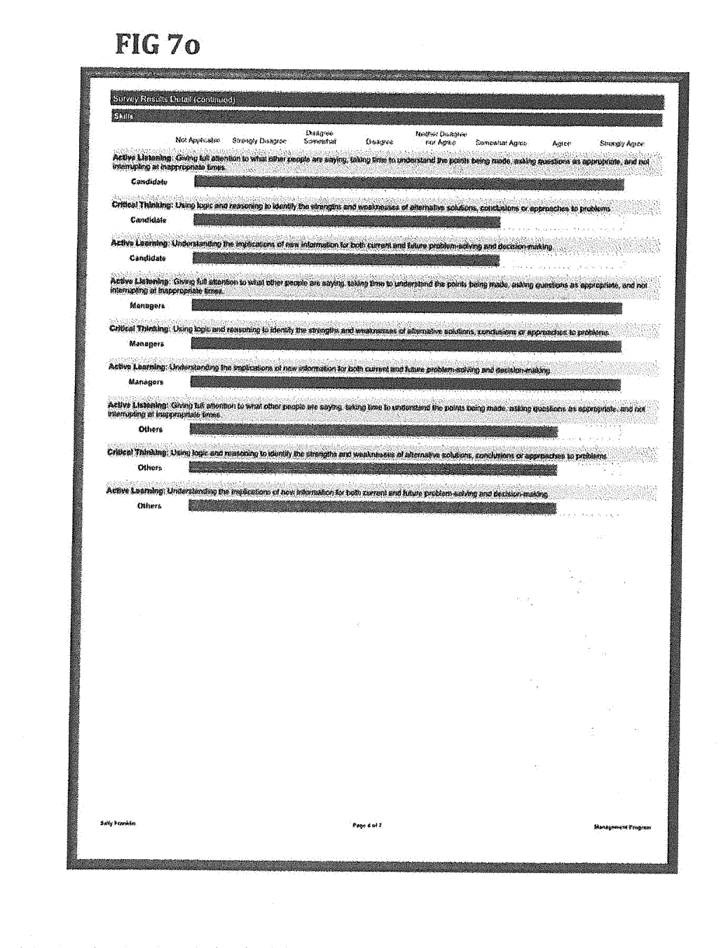

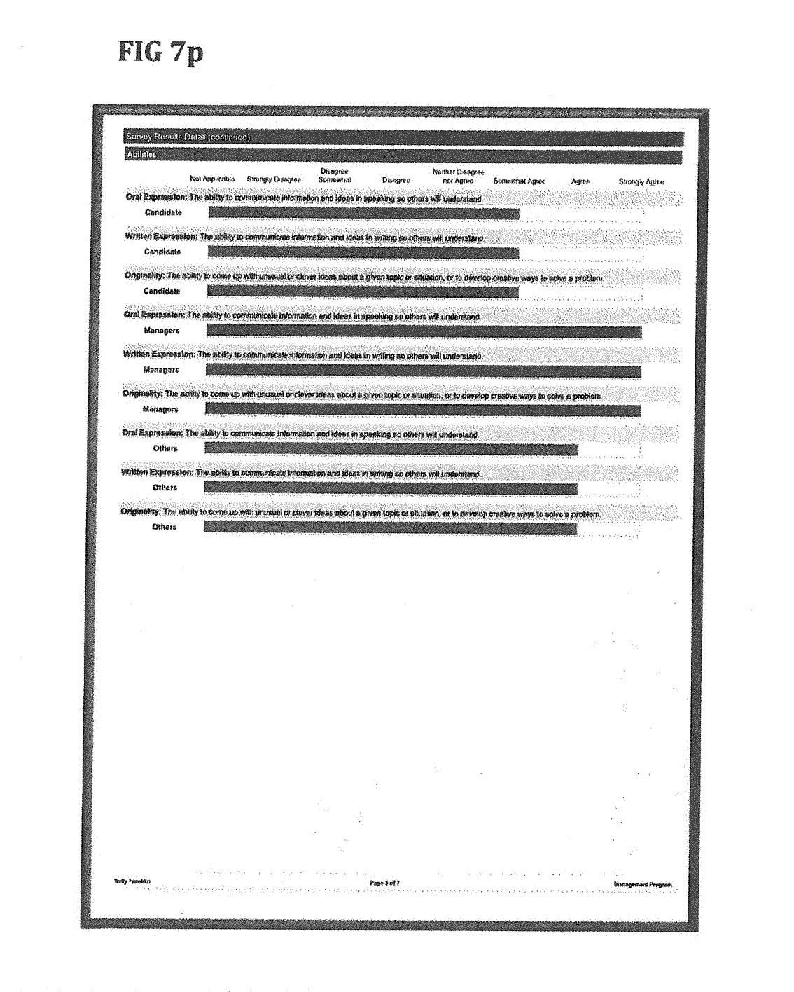

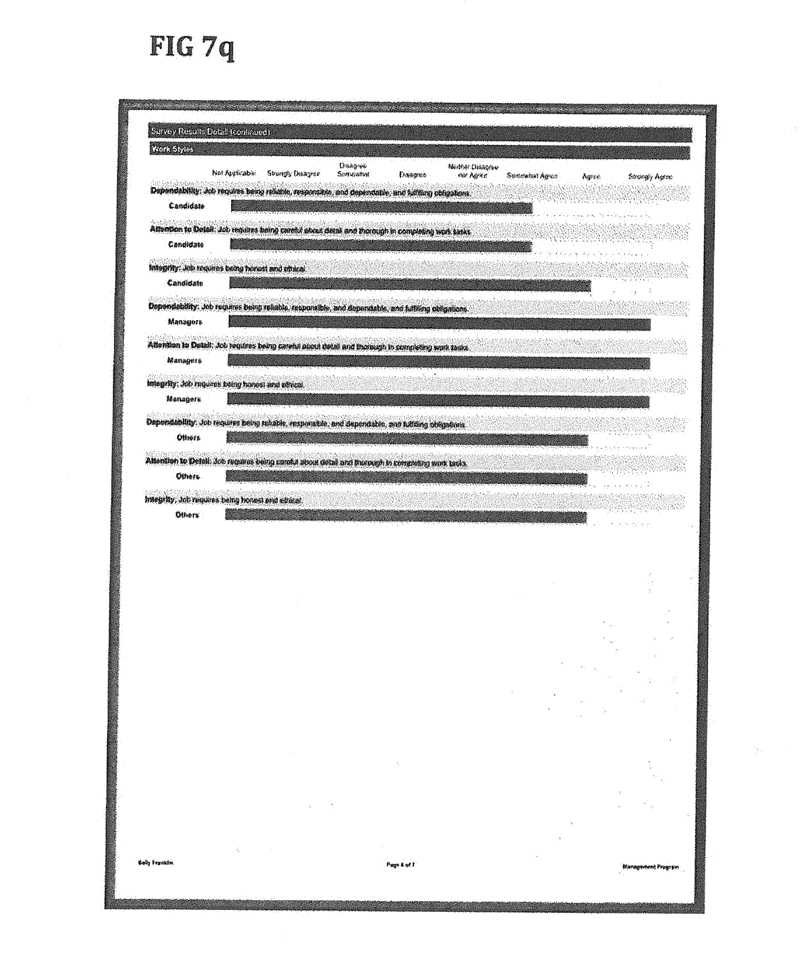

Completed and submitted surveys are stored by the computer 3 in the survey database 31. In step 121a, after all the references have completed and submitted the survey (or, if the candidate has provided more references than required, after a minimum required number of references have responded), the surveys are compiled in a collection database to generate a reference report as one embodiment is illustrated in FIGS. 7f-7q. Compilation of the surveys and generation of a reference report in FIGS. 7f-7q may occur automatically once the reference checking system 1 receives the minimum required number of completed surveys. Alternatively, a user may request compilation of the surveys at any point and a reference report FIGS. 7f-7q may be generated at any time that the user determines that a sufficient number of references have responded. Compilation of the surveys and generation of a reference report is performed by the analysis module 30.

As seen in the embodiment of a reference report shown in FIGS. 7f-7q, the reference report may present to the user information pertaining to: the number of references that responded to the reference request; when the references responded; the references' job titles; whether or not the references verified the additional information provided by the candidate; any corrections to the candidate provided information the references made; etc. Additionally, the reference report may optionally include information regarding the IP address and any other information which may be automatically captured, such as ISP, from which the candidate accessed the invitation in step 103 and/or the IP address and/or ISP information from which the candidate sent invitation requests to references in step 115a as well as the IP addresses and/or ISP information from which the references received and/or complemented the reference survey in step 121a. By monitoring this IP address and other captured information and presenting it in the reference report as illustrated in FIGS. 7f-7q, the reference checking system 1 may add an additional level of security to the reference checking system 1 and provides users with a way to monitor whether reference responses may have possibly been fraudulently generated.

Once a reference report has been generated, for instance as shown in FIGS. 7f-7q, the report is made available in step 122a. Depending on who the user is, or depending on how the user plans on using the reference report FIGS. 7f-7q, the user may or may not be the reviewer that will be reviewing the reference report to assess and help aid in the process of determining whether to hire and/or advance a candidate to the next level of the hiring and/or recruitment process. Instead, the user may designate a third party reviewer to review the reference report to assess and determine whether to hire and/or advance the candidate. For example, where the user is an employer, the reviewer of the reference report may be an ATS, job board, HRIS, CRA, RPO, temporary staffing firms, permanent placement firm, executive recruitment firm, payroll company or any other number of third party reviewers. Alternatively, where the user is an ATS, job board, HRIS, CRA, RPO, temporary staffing firms, permanent placement firm, executive recruitment firm, payroll company, etc., the reviewer of the reference report FIGS. 7f-7q may be an employer, or another ATS, job board, HRIS, CRA, RPO, temporary staffing firms, permanent placement firm, executive recruitment firm, payroll company or other third party. Finally, in some embodiments it is possible that the user may work jointly with a third party as a co-reviewer that uses the reference report FIGS. 7f-7q in deciding whether to hire and/or advance a candidate.

In step 123a, the user has reviewed the reference report illustrated in FIGS. 7f-7q and marks the reference check as complete. FIG. 5q illustrates one embodiment of this process on the dashboard.

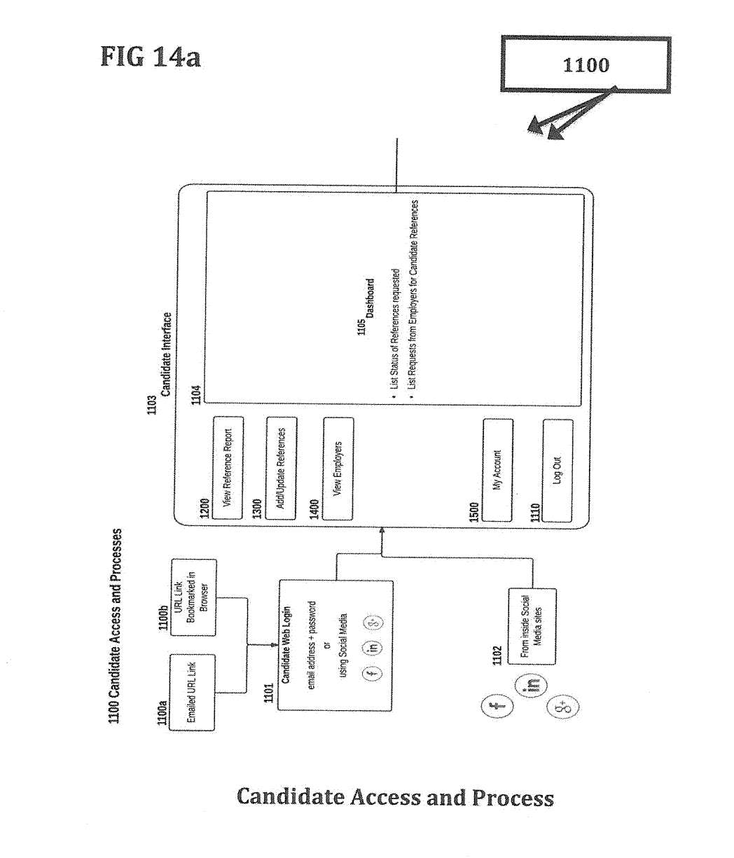

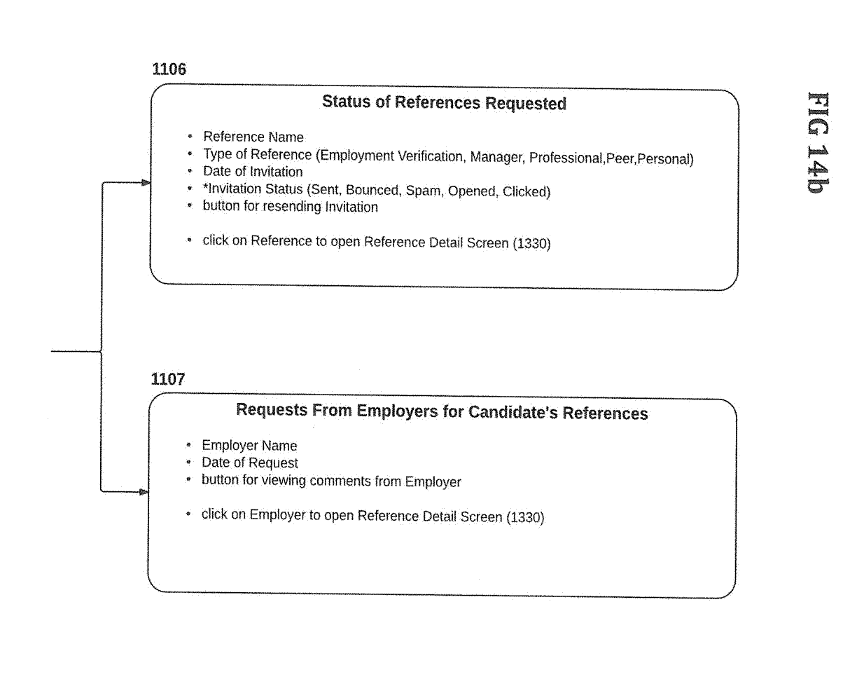

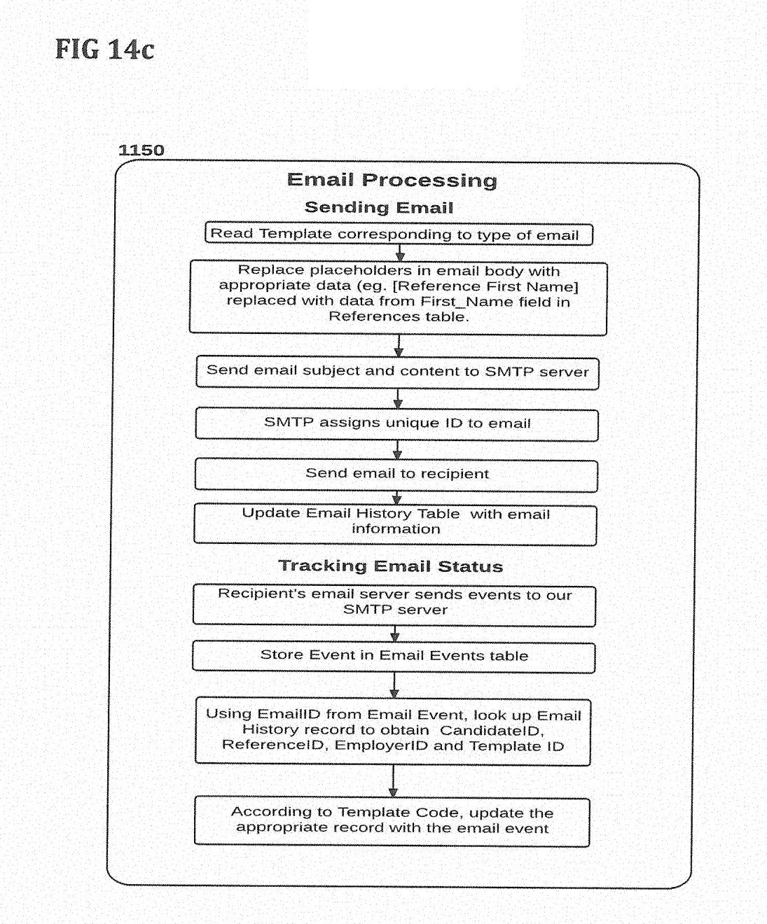

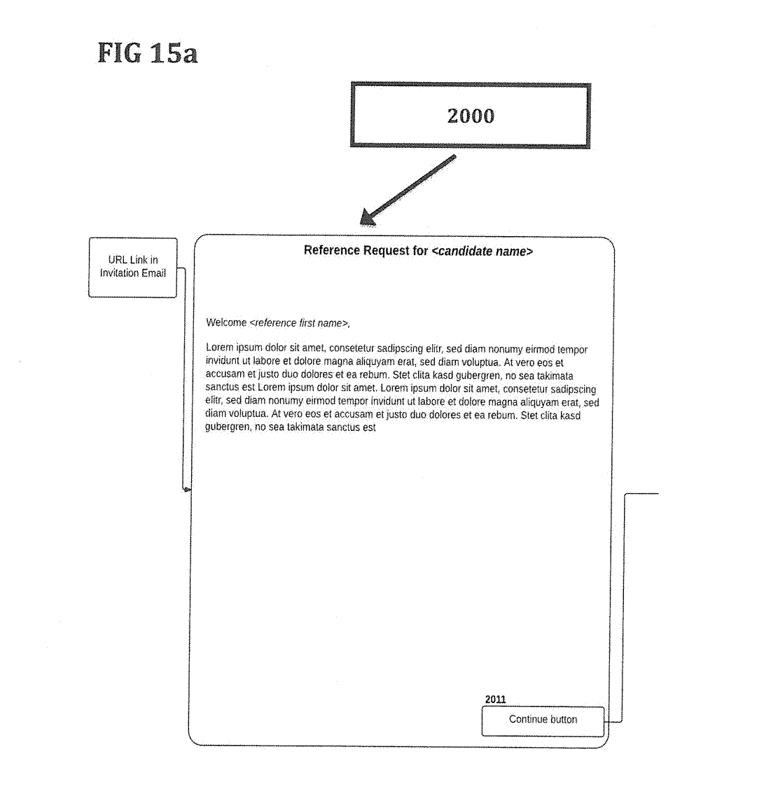

After the user has marked the reference report as complete in step 123a, in step 124a, the reference checking system 1 may make a copy of the reference report illustrated in FIGS. 7f-7q available to the candidate. The candidate is asked, in step 125a, if his/her reference report should be saved into a personal Candidate Reference Application account. If the candidate responses in the negative, the report illustrated in FIGS. 7f-7q is only emailed to the candidate, as indicated in step 126a. If the candidate responses in the affirmative, then a secure account is established in the Candidate Reference Application site where the Candidate is provided fools and processes to maintain and access to the reference report for additional employment efforts, etc. The Candidate Reference Portal is more fully described in FIG. 14a-14g.

In step 128a and as illustrated in 5r, the user-reviewer is prompted to respond Yes or No to the question: “Did the reference responses result in the candidate being rejected from consideration” and as illustrated in 5r. The user of the reference checking system 1 may be either prompted immediately or after a set period of time, to input information as to whether or not the candidate was rejected in the hiring process. In the event that the user answers that the candidate was rejected, the reference checking system 1 may then prompt the user to input additional information regarding that decision. For example, the user may be asked to provide a brief reason as to factors involved in deciding not to pursue the candidate. This can be accomplished by providing a free-form input box. Additionally, or alternatively, this may be accomplished by providing the user with a menu of reasons for not pursuing a candidate. Non-limning examples of reasons that may be presented to the user for not pursuing a candidate include, but are not limited to: the position is no longer available; the candidate is no longer interested in the position; the candidate's salary range expectations exceed the position salary; poor reference responses; inconsistent reference responses; the candidate self-evaluation is not consistent with reference responses; poor/low survey responses from references; the candidate has demonstrated undesirable characteristics; etc.

A user response is mandatory to the question: “Did the reference responses result in the candidate being rejected from consideration” from the reviewer if the reference checking system 1 account is configured for Fair Credit Reporting Act (FCRA) compliance.

In step 130a, the user-reviewer decides not to hire and/or advance a candidate to the next level of a hiring and/or recruitment process—based in whole or in part on the results of the reference report under the FCRA, the reviewer is required to begin a adverse action process 200a by notifying the candidate, with an FCRA specified notice, that their application has been adversely impacted by the information provided by the references. In addition to notifying the candidate of this adverse action, as part of the pre-adverse action process the candidate must also be provided a copy of the reference report as well as a copy the FCRA “A Summary of Your Rights Under the Fair Credit Reporting Act” and the opportunity to respond to the reference report that generated the adverse action, by allowing the candidate to respond to the reference report and/or provide additional information that may mitigate and/or explain the responses provided in the reference report. In addition, the candidate must be given a minimum of five (5) working days to respond to the pre-adverse action. After the candidate has had a minimum of five (5) days to respond, any information provided by the candidate must be assessed to determine if the reference cheek report warrants revision in light of the additional information. Once this process is complete, the reference check report (including any amendments/comments/revisions/etc.) is then returned to the reviewer, at which point the reviewer can reverse their earlier decision and decide to hire/advance the candidate based on the revised reference report. Alternatively, after reviewing updated reference report, the reviewer can decide to continue with the adverse action by maintaining their initial decision to not hire/advance the candidate. In the event the reviewer continues with the adverse action, a final adverse action notice is communicated to the candidate. The reference checking system 1 may include a docketing database that tracks each of these deadlines as outlined by the FCRA Periodic reminders may be sent to the candidate to ensure the candidate is educated as to his or her rights under the FCRA and takes appropriate action if desired.

When the user-review is prompted in step 128a to respond Yes or No to the question: “Did the reference responses result in the candidate being rejected from consideration” and if the responses is no, step 129a, then the reference checking process is marked completed and the report is stored in the database 22.

An example of one embodiment of a reference report 301 that can be generated by the reference checking system 1 is illustrated in FIGS. 7a-q. As seen in the sample reference report 301 of FIG. 7a, among other things, the reference report 301 may present to the user information pertaining to: the number of references that responded to the reference request; when the references responded; the references' job titles; whether or not the references verified the additional information provided by the candidate; any corrections to the candidate provided information the references made; etc. Additionally, the reference report 301 may optionally include information regarding the IP address and any other information which may be automatically captured, such as ISP, from which the candidate accessed the invitation in step 103 and/or the IP address and/or ISP information from which the candidate sent invitation requests to references in step 104, as well as the IP addresses and/or ISP information from which the references received and/or complemented the reference survey in step 105. By monitoring this IP address and other captured information and presenting it in the reference report 301, the reference checking system 1 may add an additional level of security to the reference checking system 1 and provides users with a way to monitor whether reference responses may have possibly been fraudulently generated.

In a preferred embodiment, the reference report 301 provides an objective compilation of the responses received from the references. In such an embodiment, the responses are not scored, weighted, or otherwise interpreted by the reference checking system 1 in any way. Rather, the reference checking system 1 merely averages the responses to the various survey elements using the same scale as that used by the references to evaluate the candidate. For example, if a survey requested references to evaluate a candidate on different elements on a 1-10 scale, the reference checking system 1 would average the total numerical values received from each of the references divided by the number of reference responses for a particular survey element, and present that calculated average reference response on the reference report 301. By providing only averaged responses, the reference checking system 1 provides an objective reference report 301 based entirely on the evaluations and inputs of the references. After receiving from the reference checking system 1 this unanalyzed, uncalculated, unweighted, unscored, and otherwise unaltered summary of the average responses of the references to each survey element, the user is then subsequently able (if they choose to do so) to process, analyze, compare, or otherwise use as raw survey results as the user see fits.

Although in a preferred embodiment the reference checking system 1 only averages the responses to each survey element from the references, and does not otherwise interpret or use the survey responses to generate the reference report 301, in other alternative embodiments of the reference checking system 1 the references' survey responses may be compiled in any number of ways when generating the reference report 301 in step 106. For example, in alternative embodiments, responses from different types of references may: be weighted differently; a candidate may be ranked based on the candidate's scores relative to other candidates' scores; a candidate's scores may be compared to the scores of employees currently in a job or position similar to the job or position for which the candidate is applying to; the candidate's score may be based on the averaging of scores received from multiple survey elements; etc. Thus, embodiments of the types of reference reports 301 the reference checking system 1 and the reference checking process 100 may be used to generate include: reference reports 301 that are either a purely objective compilation of the reference survey responses received in step 105; a subjective reference report 301 generated by scoring, ranking, interpreting or otherwise assessing the reference responses received in step 105; or alternatively the reference report 301 may be both an objective and subjective compilation of the reference responses received in step 105.

The manner in which the survey responses are compiled (e.g. objective compilation, subjective compilation, or a mixed, objective/subjective compilation) may be dictated by a default survey compilation method of the reference checking system 1. Alternatively, the reference checking system 1 may be capable of compiling the survey responses based on a compilation method or system selected by the user. To that effect, the reference checking system 1 may grant the user the ability to choose and select the type of compilation and manner of assessment and/or interpretation of the survey results (including the option of not having the survey results assessed or interpreted at all besides the averaging of the reference survey element values) the user would like used in compiling the reference report 301. As yet another option, the reference checking system 1 may provide users with the option of dictating their own customized manner in which they would like the survey responses to be compiled to generate the reference report 301.

With regards to the organization and formatting of the reference report 301, FIGS. 7a-q illustrate one example of the number of ways in which the reference report 301 may be presented to the user. For example, reference responses as presented in the reference report 301 can be organized by: the length of time a reference has known the candidate; the type of category (e.g. manager, co-worker, peer, professional reference, subordinate, friend, etc.) a reference falls into; the reference the candidate has had the most recent involvement with; etc. In some embodiments, the reference report 301 will only provide a single response representing the average response of the references for each survey element. Alternatively, in other embodiments the reference report 301 may include the individual responses to each survey element from each of the references. In yet another embodiment, the reference report 301 may provide both individual responses as well as averaged responses for each of the survey elements. Additionally, or optionally, in embodiments in which the candidate completed a self-evaluation survey, the candidate's responses from the self evaluation survey may be compiled into the reference report 301 and displayed alongside the values received from the references.

Although various methods of compiling as well as various manners of organizing, formatting, and presenting reference responses so as to generate a reference report 301 have been discussed, it is understood that the generation of the reference report 301 may be achieved in any number of ways. Additionally, although the reference checking system 1 may be designed or structured to generate reference reports 301 compiled and organized, formatted, and presented in a default manner, the reference checking system 1 of the present invention may also be customized to compile and organize, format and present the reference report 301 in any manner desired by and requested by a user.

Once a reference report 301 has been generated in step 106, the reference report 301 is made available to the user. Depending on who the user is, or depending on how the user plans on using the reference report 301, the user may or may not be the reviewer that will be reviewing the reference report 301 to assess and help aid in the process of determining whether to hire and/or advance a candidate to the next level of the hiring and/or recruitment process. Instead, the user may designate a third party reviewer to review the reference report 301 to assess and determine whether to hire and/or advance the candidate. For example, where the user is an employer, the reviewer of the reference report may be an ATS, job board, HRIS, CRA, RPO, temporary staffing firms, permanent placement firm, executive recruitment firm, payroll company or any other number of third party reviewers. Alternatively, where the user is an ATS, job board, HRIS, CRA, RPO, temporary staffing firms, permanent placement firm, executive recruitment firm, payroll company, etc., the reviewer of the reference report 301 may be an employer, or another ATS, job board, HRIS, CRA, RPO, temporary staffing firms, permanent placement firm, executive recruitment firm, payroll company or other third party. Finally, in some embodiments it is possible that the user may work jointly with a third party as a co-reviewer that uses the reference report 301 in deciding whether to hire and/or advance a candidate.

If the selection process falls under the guidelines established by the Fair Credit Reporting Act and in the event a reviewer decides not to hire and/or advance a candidate to the next level of a hiring and/or recruitment process—based in whole or in part on the results of the reference report under the FCRA, the reviewer is required to begin a pre-adverse action process by notifying the candidate, with an FCRA specified notice, that their application has been adversely impacted by the information provided by the references. In addition to notifying the candidate of this adverse action, as part of the pre-adverse action process the candidate must also be provided a copy of the reference report as well as a copy the FCRA “A Summary of Your Rights Under the Fair Credit Reporting Act” and the opportunity to respond to the reference report that generated the adverse action, by allowing the candidate to respond to the reference report and/or provide additional information that may mitigate and/or explain the responses provided in the reference report. In addition, the candidate must be given a minimum of five (5) working days to respond to the pre-adverse action. After the candidate has had a minimum of five (5) days to respond, any information provided by the candidate must be assessed to determine if the reference check report warrants revision in light of the additional information. Once this process is complete, the reference check report (including any amendments/comments/revisions//etc.) is then returned to the reviewer, at which point the reviewer can reverse their earlier decision and decide to hire/advance the candidate based on the revised reference report. Alternatively, after reviewing updated reference report, the reviewer can decide to continue with the adverse action by maintaining their initial decision to not hire-advance the candidate. In the event the reviewer continues with the adverse action, a final adverse action notice is communicated to the candidate.

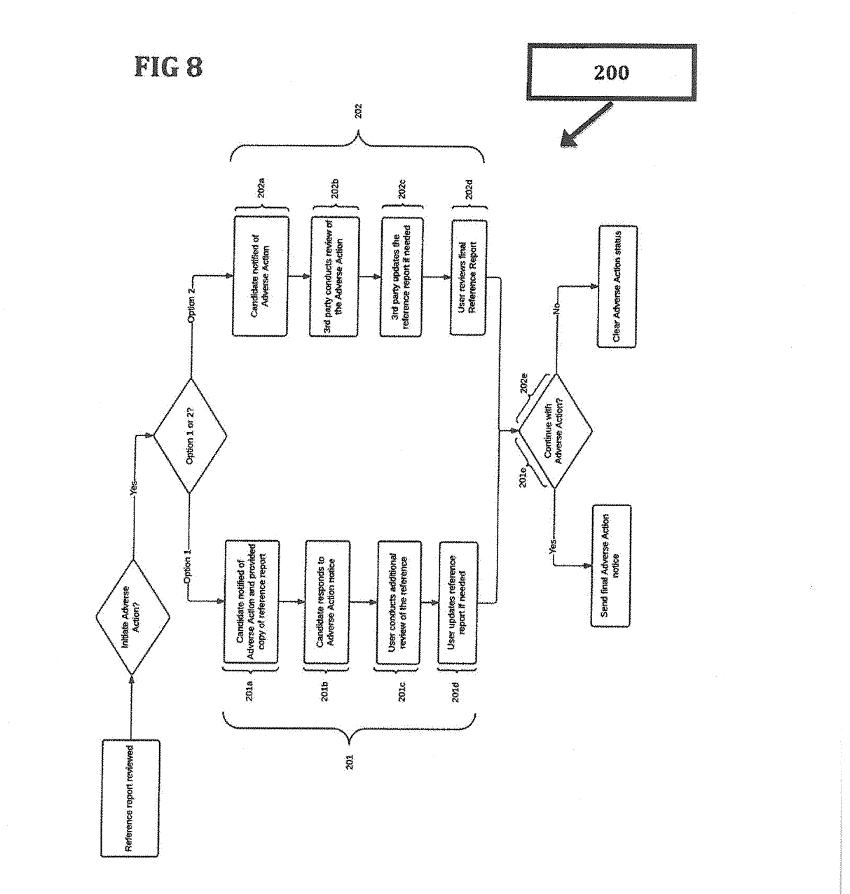

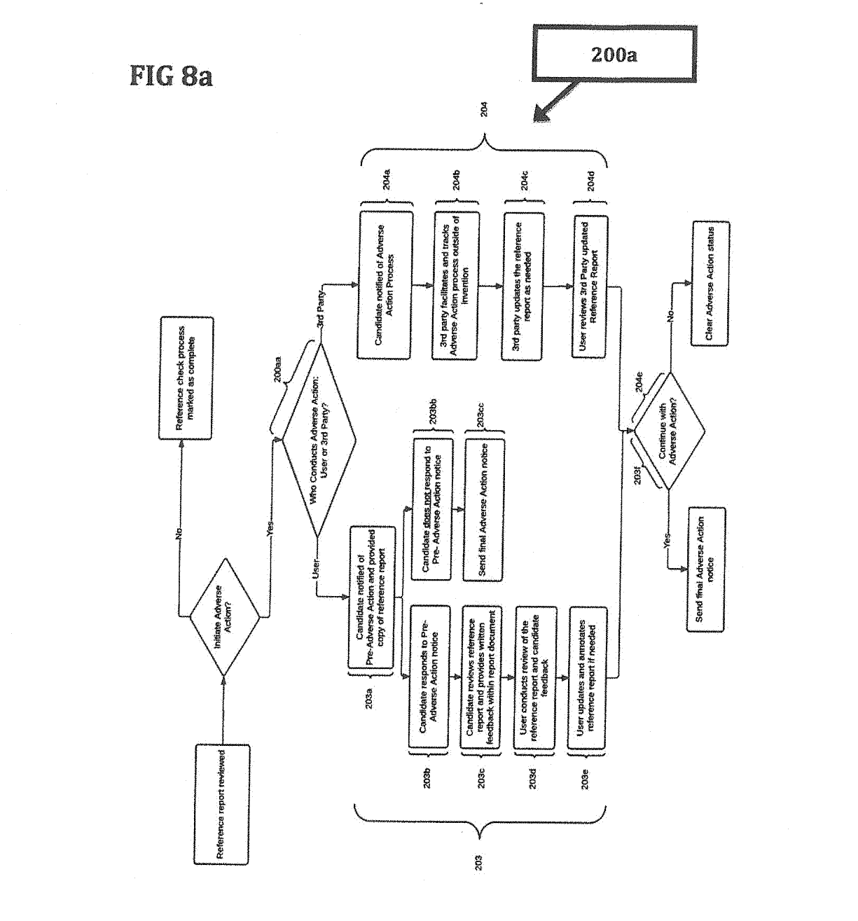

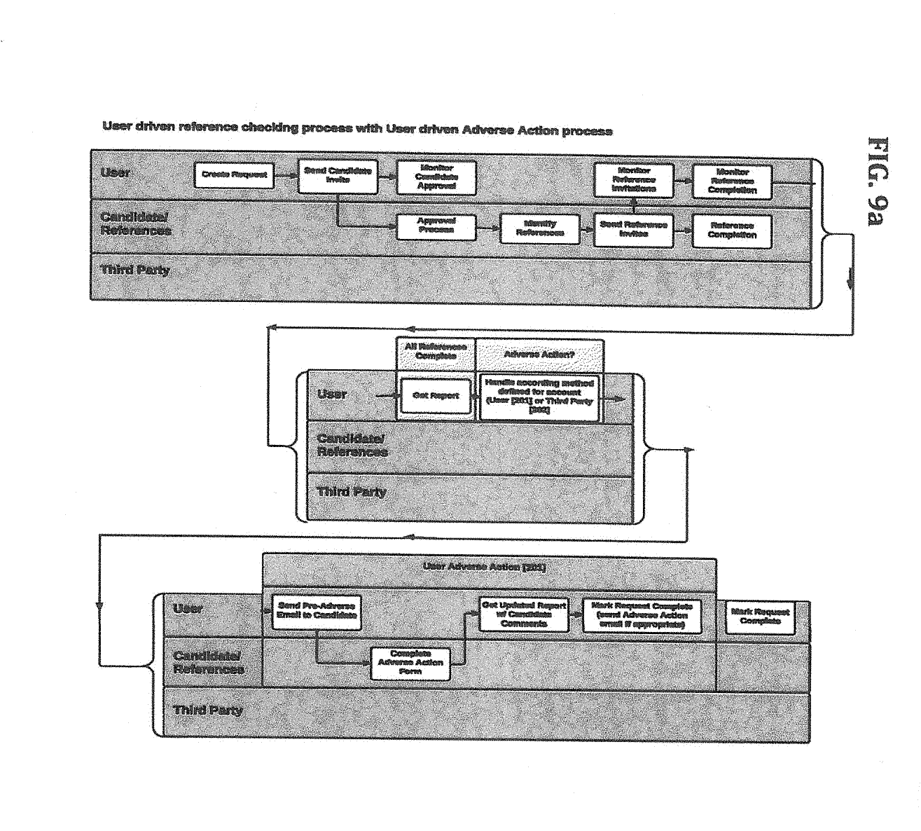

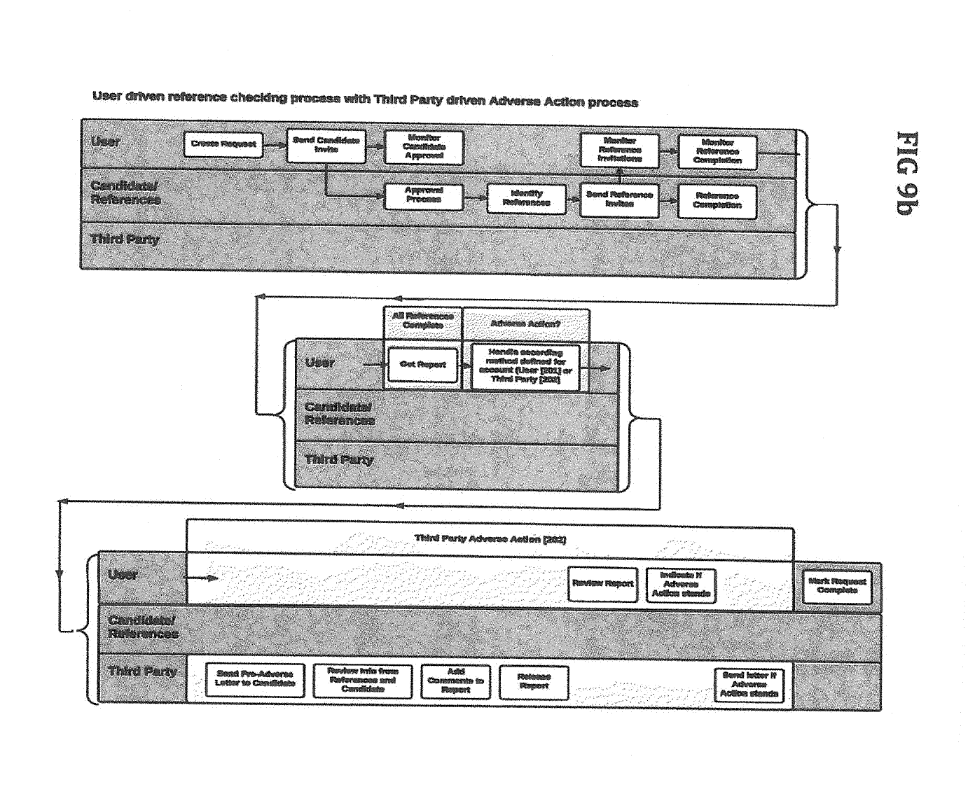

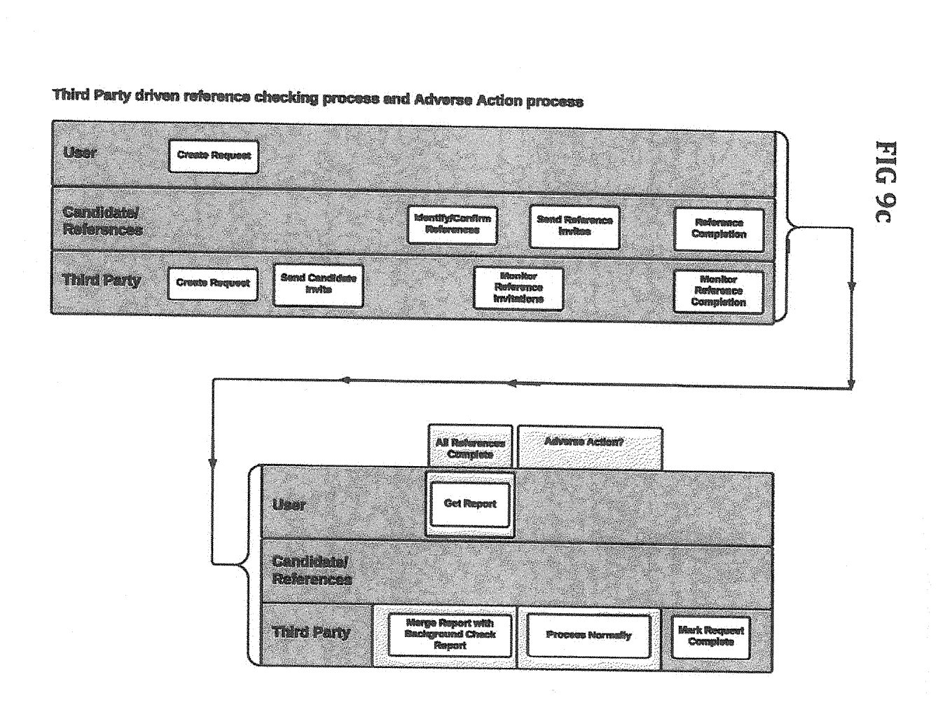

As illustrated in FIG. 8, the reference checking system 1 and the reference checking process 100 include an adverse action reporting process 200 that helps ensure that the review of the candidate's reference report 301 is compliant with FCRA requirements. In the event that an adverse action occurs, a message distribution device will notify the applicant of the adverse action. In addition to notifying the applicant of the adverse action, the message distribution device may also provide the applicant with information regarding the applicant's reference report and the applicant's rights under the FCRA. The reference checking system 1 may further include a collection database for receiving additional information related to the applicant's reference report in response to the notification of the adverse action. This adverse action process 200 is available to the user anytime after the reference report 301 has been generated, and the user has the ability to initiate the adverse action process 200 at any time they choose to do so. Although the user may organically arrive at a decision to initiate the adverse action process 200, the reference checking system 1 and reference checking process 100. in step 107, are also designed to help assist the user in determining whether and when to initiate the adverse action process 200.

In step 107, after the reference report 301 has been provided to the user, the reference checking system 1 may either immediately or after a set period of time prompt the user to input information as to whether or not the candidate was hired and/or advanced in the hiring process using the docketing database. In the event that the user answers in the negative, the reference checking system 1 may then prompt the user to input additional information regarding that decision. For example, the user may be asked to provide a brief reason as to factors involved in deciding not to pursue the candidate. This can be accomplished by providing a free-form input box. Additionally, or alternatively, this may be accomplished by providing the user with a menu of reasons for not pursuing a candidate. Non-limiting examples of reasons that may be presented to the user for not pursuing a candidate include, but are not limited to: the position is no longer available; the candidate is no longer interested in the position; the candidate's salary range expectations exceed the position salary; poor reference responses; inconsistent reference responses; the candidate self-evaluation is not consistent with reference responses; poor/low survey responses from references; the candidate has demonstrated undesirable characteristics; etc.

Once the user has responded and provided reasons for no longer pursuing the candidate, the reference checking system 1 reviews the responses and determines if any of the reasons the user has listed or indicated for not pursuing the candidate may in whole or in part be attributed to information about the candidate that was obtained from the reference report 301. In the event that the user's responses indicate that the reference report 301 may have been a factor in the user's decision, the reference checking system 1 flags the candidate's reference request, notifies the user of this fact and prompts the user to begin the adverse action process 200.

In the event that in step 107 a user does not respond to prompts from the reference checking system 1 to: input whether the candidate has been hired/advanced in the hiring process; provide reasons for no longer pursuing a candidate; and/or initiate an adverse action process 200 based on a notification from the reference checking system 1 that the user-provided reasons for not pursuing a candidate indicate that the adverse action process is warranted, the reference checking system 1 may periodically: contact the user that action is required; mark/flag/highlight the recommended action the user should take; and/or otherwise alert the user to the fact that the user is recommend to provide additional information/action so as to better assure compliance with FCRA requirements.

Although in the described embodiments of the reference checking system 1 and reference checking process 100 the user has often been described as being the employer who is looking to hire/advance a candidate and it being the employer who is performing the steps of the reference checking process 100, as illustrated in FIG. 9, in other embodiments, the party performing the steps of the reference checking process 100 may be a third party. As seen in FIG. 9, in embodiments in winch a third party is involved in the reference checking process 100, the third party may become involved in the reference checking process 100 at any step in the process: from the initial step 101 of creating a reference request, to the adverse action process in step 107 or at any other point.

Thus, although the above-described step 107 has made reference to the user being the same individual/party that acts as the reference report 301 reviewer it is to be understood that the reference checking system 1 and reference chocking process 100 may be used in embodiments where the user is not the same individual/party acting as the reviewer of the reference report 301. In such embodiments in which the reviewer is a third-party (or embodiments in which the user is assisted by a third-party co-reviewer) the reference checking system 1 may be modified to allow the user to customize the reference checking system 1 to allow for such third-party or assisted review. For example, the user may grant access for the reference checking system 1 to communicate and interact directly with the third-party reviewer (so as to entirely replace of minimize the user's involvement) during steps 106 and 107 of the reference checking process 100 as well as during any adverse action processes 200 that may be initiated. Alternatively, the user may decide to limit the third-party to only being able to receive communication from the reference checking system 1, and to allow only the user to follow up on any protocols that the reference checking system 1 might suggest in step 107 and/or during the adverse action process 200. As will be appreciated by those with skill in the art, the reference checking system 1 may be modified to allow for as much or as little interaction, control, and/or input from a third-party reviewer as the user desires and that these levels may be changed at any time the user chooses to do so.

As illustrated in FIG. 8, once the user has decided to initiate the adverse action process 200, the user may choose different options of how to proceed. In some embodiments, such as the embodiment illustrated by 201, the adverse action process is user-driven. In other embodiments, such as the embodiment illustrated by 202, the adverse action process may be delegated to a third party, such as, but not limited to, e.g. a CRA.

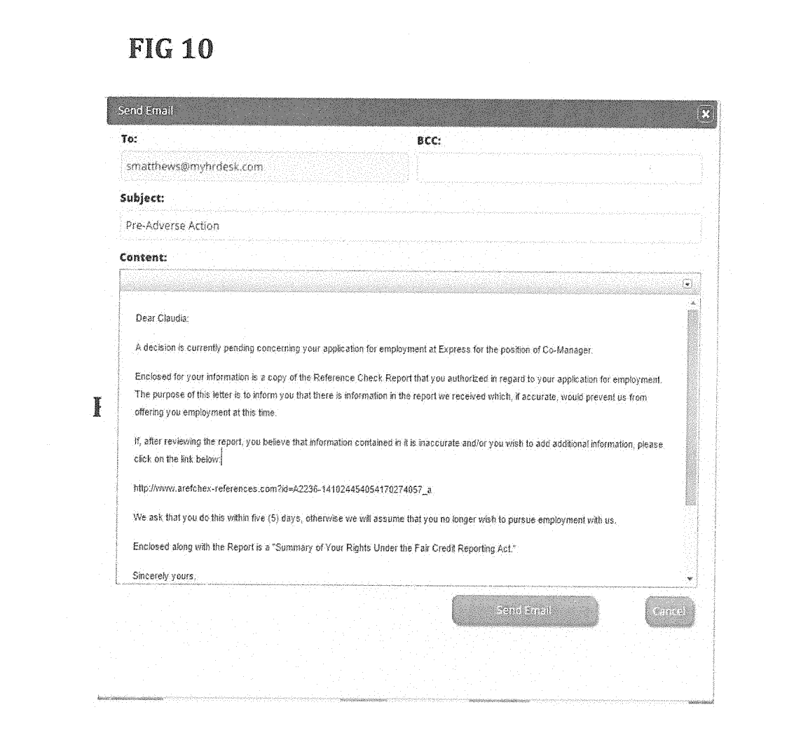

In the embodiment depicted in step 201, the adverse action process 200 begins with the reference checking system 1 notifying the candidate of the adverse action, and providing the candidate with a copy of the reference report 301, a copy of the federal government notice: “A Summary of Your Rights Under the Fair Credit Reporting Act” and/or any other legally required notice to the candidate of the candidate's rights under the FCRA, as well as a invitation to submit any information that may explain, mitigate and/or may otherwise be relevant to reference report 301. FIG. 10 illustrates one example of how a candidate may be notified of the adverse action process 200. In the event that the reference report 301 generated for the user may have presented both a single averaged survey response of all the references' responses to the various survey elements as well as the individual responses of each of the references, the reference checking system 301 may generate a redacted reference report 301 that presents only the averaged survey responses and does not present the individual responses made by each individual reference prior to providing the reference report 301 to the candidate. Preferably, the reference checking system 1 tracks the receipt and opening by the candidate of the notification of the adverse action process 200.

In step 201a of the pro-adverse action process 200, the candidate is given a set time period, e.g. 5 days or at least a time period equaling any minimum time period required under the FCRA, during which the candidate must respond to the initial notification in order for the adverse action process 200 to proceed. During this set time period, the reference checking system 1 may periodically send the candidate reminders or notifications prompting the candidate to submit a response if the candidate desires to submit feedback to the reference report 301 and proceed with the adverse action process 200. These reminders may be generated using the docking database. If the candidate decides not to proceed with the adverse action process 200 or fails to respond to the invitation during the set time period, the pre-adverse action process 200 will terminate, and the reference checking system 1 will close the status of the candidate's reference request profile and send a final adverse action notice to the candidate notifying the candidate of this final adverse action status.

In the event that a candidate chooses to proceed with the adverse action process 200, after the candidate has accepted the invitation and submitted any relevant feedback and/or information which is stored in the collection database, the reference checking system 1 in step 201b notifies and invites the user to review the submitted information. Once the user has reviewed the information from the candidate, the user in step 201c may decide to gather and review additional information from any or all of the candidate, the references, other individuals, etc. During step 201c of the adverse action process 200, if the user has decided to proceed with the collection and review of additional information, the reference checking system 1 allows the user to, among other actions: receive and transmit communications from the parties involved in the adverse action review process (e.g. the candidate, references, other individuals, etc.); store communications and other information related to the adverse action review process; create and input reports, findings, or other comments into the candidate's reference request profile; amend or revise the reference report 301; etc. Additionally, similar to the reminders that are sent to candidates during step 201a, the user in step 201c may utilize the reference check system to periodically remind other individuals involved in the adverse action process 200 to respond to communications/requests that have been sent by the user to those individuals. In step 201d, once the user has obtained and analyzed information from both the candidate and any other individuals involved in the adverse action process 200, the user updates and/or otherwise amends the reference report 301 to reflect the results of the user's reference report 301.

Once the user has finished gathering and reviewing information in the collection database and has updated the reference report 301 in steps 201c and 201d, the user in step 201e makes a decision whether or not to continue with the adverse action. If the user decides to reverse the initial decision to not pursue the candidate and instead the user decides to hire and/or advance the candidate in the hiring process, the adverse action status is cleared from the candidate's reference request. Alternatively, in the event that even after reviewing the additional information the user chooses not to proceed with hiring and/or advancing the candidate in the hiring process, the adverse action status remains set in the candidate's reference request profile, and a final notice is sent to the candidate informing them this status.

As an alternative to a user-driven adverse action process, in certain embodiments, such as that depicted by 202, the user may wish to delegate the adverse action process 200 to a third party. In such third-party embodiments, the reference checking system 1 may provide users the option to directly grant access to these third-parties to the adverse action process 200 such that the third party may have direct access to the reference checking system 1 during the adverse action process 202.

As in the user-driven embodiment 201, the adverse action process of embodiment 202 begins with step 202a in which the candidate is notified of the adverse action and provided with a copy of the reference report 301 and a copy of the candidate's rights under the FCRA. Unlike in step 201a, in step 202a the candidate is not invited to submit any information by the reference checking system 1. Instead, at step 202b, the third party takes over the process of requesting, transmitting, collecting, and otherwise conducting the review of the reference report 301. Although the third party may utilize the reference checking system 1 to aid in conducting their review, the third party is in control of how the adverse action process proceeds. Once the third party has finishing their investigation, the third party in step 202c updates any changes (if there are any) to the reference report 301 and the reference report 301 becomes available to the user through the reference checking system 1. In step 202d the updated reference report 301 is reviewed by the user. In step 202e, utilizing the updated reference report 301, the user then makes a decision whether or not to continue with the adverse action. Similar to the process of embodiment 201, if alter reviewing the additional information in step 202d the user in step 202e decides to reverse the initial decision to not pursue the candidate and instead the user decides to hire and/or advance the candidate in the hiring process, the adverse action status is cleared from the candidate's reference request. Alternatively, in the event that even after reviewing the additional information the user chooses not to proceed with hiring and/or advancing the candidate in the hiring process, the adverse action status remains set in the candidate's reference request profile, and a final notice is sent to the candidate informing them this status.

In another embodiment and as illustrated in FIG. 8a, the reference checking system 1 and the reference checking process 100a and 100b include an adverse action reporting process 200a that assists to ensure the candidate's rights under the Fair Credit Reporting Act (FCRA) are systematically implemented and tracked using a docketing database that tracks important deadlines. After the user has marked the reference request as complete in step 123a and the reference report has been made available to the candidate in steps 124a, 125a and 126a; the user is promoted by reference checking system 1 in step 128a if the reference responses will result in the candidate being rejected from consideration. If the user responses in the affirmative in step 129a, then the adverse action process in 200a is initiated. Although the user may organically arrive at a decision to initiate the adverse action process 200a, the reference checking system 1 and reference checking process 100a, in step 128a, are also designed to help assist the user in determining whether and when to initiate the adverse action process 200a.

Although in the described embodiments of the reference checking system 1 and reference checking process 100a and 100b the user has often been described as being the employer who is looking to hire/advance a candidate and it being the employer who is performing the steps of the reference checking process 100a and 100b, as illustrated in FIG. 9, in other embodiments, the party performing the steps of the reference checking process 100a and 100b may be a third party. As seen in FIG. 9, in embodiments in which a third party is involved in the reference checking process 100a and 100b, the third party may become involved in the reference checking process 100a and 100b at any step in the process: beginning at step 101a of generating a reference survey, and progress to step 102a of creating a reference request, all the way to the adverse action process in step 130a or at any other point.

Therefore, although the above-described steps has made reference to the user being the same individual/party that acts as the reference report 301 reviewer, it is to be understood that the reference checking system 1 and reference checking process 100a and 100b may be used in embodiments where the user is not the same individual/party acting as the reviewer of the reference report 301. In such embodiments in which the reviewer is a third-party (or embodiments in which the user is assisted by a third-party co-reviewer), the reference checking system 1 may be modified to allow the user to customize the reference checking system 1 to allow for such third-party or assisted review. For example, the user may grant access for the reference checking system 1 to communicate and interact directly with the third-party reviewer (so as to entirely replace of minimize the user's involvement) during steps 122a, 123a, 128a, 129a and/or 130a of the reference checking process 100a and 100b as well as during any adverse action processes 200a that may be initiated. Alternatively, the user may decide to limit the third-party to only being able to receive communication from the reference checking system 1, and to allow only the user to follow up on any protocols that the reference checking system 1 might suggest in steps 128a, 129a and 130a and/or during the adverse action process 200a. As will be appreciated by those with skill in the art, the reference checking system 1 may be modified to allow for as much or as little interaction, control, and/or input from a third-party reviewer as the user desires and that these levels may be changed at any time the user chooses to do so.

As illustrated in FIG. 8a, once the user has decided to initiate the adverse action process 200a, the user may choose different options of how to proceed. In some embodiments, such as the embodiment illustrated by 203, the adverse action process is user-driven. In other embodiments, such as the embodiment illustrated by 204, the adverse action process may be delegated to a third party, such as, but not limited to, e.g. a Consumer Reporting Agency.

In the embodiment depicted in step 203, the FCRA required adverse action process 200a begins with the reference checking system 1 in step 201a by notifying the candidate of the pre-adverse action and providing the candidate with an additional copy of the reference report 301, a copy of the federal government notice: “A Summary of Your Rights Under the Fair Credit Reporting Act” and/or any other legally required notice to the candidate of the candidate's rights under the FCRA.

In step 203bb, the candidate has not acknowledged receipt of the Pre-Adverse action notice. In this scenario, the user is notified on the dashboard that, within a set period of time and after repeated attempts, she candidate has not responded. In step 203cc, the user is prompted to send the final Adverse Action notice as also provide for in step 203f.

In step 203b, the candidate has acknowledged receipt of the Pre-Adverse action notice. In step 203c, the candidate reviews the reference report 301, as being prompted to enter into the report 301, any information that may explain, mitigate and/or may otherwise be relevant to reference report 301. FIG. 10 illustrates one example of how a candidate may be notified of the adverse action process 200a. In the event that the reference report 301 generated for the user may have presented both a single averaged survey response of all the references' responses to the various survey elements as well as the individual responses of each of the references, the reference checking system 1 may generate a redacted reference report 301 that presents only the averaged survey responses and does not present the individual responses made by each individual reference prior to providing the reference report 301 to the candidate. Preferably, the reference checking system 1 tracks the receipt and opening by the candidate of the notification of the adverse action process 200a.

In step 203 of the pre-adverse action process 200a, the candidate is given a set time period, e.g. 5 days or at least a time period equaling any minimum time period required under the FCRA, during which the candidate must respond to the initial notification in order for the adverse action process 200a to proceed. These deadlines may tracked using the docketing database. During this set time period, the reference checking system 1 may periodically send the candidate reminders or notifications from the docketing database prompting the candidate to submit a response if the candidate desires to submit feedback to the reference report 301 and proceed with the adverse action process 200a. If the candidate decides not to proceed with the adverse action process 200a or fails to respond to the invitation during the set time period, the pre-adverse action process 200a will terminate, and the reference checking system 1 will close the status of the candidate's reference request profile and send a final adverse action notice, as in step 203f, to the candidate notifying the candidate of this final adverse action status.

In the event that a candidate chooses to proceed with the adverse action process 200a, after the candidate has accepted the invitation and submitted any relevant feedback and/or information with notations on the reference report 301, the reference checking system 1 in step 203d notifies and invites the user to review the feedback submitted by the candidate and notated on reference report 301. Once the user has reviewed the information from the candidate, the user in step 203d may decide to gather and review additional information from any or all of: the candidate, the references, other individuals, etc. During step 203d of the adverse action process 200a, if the user has decided to proceed with the collection and review of additional information, the reference checking system 1 allows the user to, among other actions: receive and transmit communications from the parties involved in the adverse action review process (e.g. the candidate, references, other individuals, etc.); store communications and other information related to the adverse action review process; create and input reports, findings, or other comments into the candidates reference request profile; amend or revise the reference report 301; etc. Additionally, similar to the reminders that are sent to candidates during step 203a, the user in step 203d may utilize the reference check system to periodically remind other individuals involved in the adverse action process 200a to respond to communications/requests that have been sent by the user to those individuals. In step 203e, once the user has obtained and analyzed information from both the candidate and any other individuals involved in the adverse action process 200a, the user updates and/or otherwise amends the reference report 301 to reflect the results of the user's reference report 301.

Once the user has finished gathering and reviewing information and has updated the reference report 301 in steps 203d and 203e, the user in step 201f makes a decision whether or not to continue with the adverse action. If the user decides to reverse the initial decision to not pursue the candidate and instead the user decides to hire and/or advance the candidate in the hiring process, the adverse action status is cleared from the candidate's reference request. Alternatively, in the event that even after reviewing the additional information the user chooses not to proceed with hiring and/or advancing the candidate in the hiring process, the adverse action status remains set in the candidate's reference request profile, and a final notice is sent to the candidate informing them this status.

As an alternative to a user-driven adverse action process, in certain embodiments, such as that depicted by 204, the user may wish to delegate the adverse action process 200a to a third party. In such third-party embodiments, the reference checking system 1 may provide users the option to directly grant access to these third-parties to the adverse action process 200a such that the third party may have direct access to the reference checking system 1 during the adverse action process 204.

As in the user-driven embodiment 203, the adverse action process of embodiment 204 begins with step 204a in which the candidate is notified of the pre-adverse action and the candidate is provided with an additional copy of the reference report 301, a copy of the federal government notice: “A Summary of Your Rights Under the Fair Credit Reporting Act” and/or any other legally required notice to the candidate of the candidate's rights under the FCRA.

Unlike in step 203a, in step 204a the candidate is not invited to submit any information by the reference checking system 1. Instead, at step 204b, the third party takes over the process of requesting, transmitting, collecting, and otherwise conducting the review of the reference report 301. Although the third party may utilize the reference checking system 1 to aid in conducting their review, the third party is in control of how the adverse action process proceeds. Once the third party has finishing their investigation, the third party in step 204c updates any changes (if there are any) to the reference report 301 and the reference report 301 becomes available to the user through the reference checking system 1. In step 204d the updated reference report 301 is reviewed by the user. In step 204e, utilizing the updated reference report 301, the user then makes a decision whether or not to continue with the adverse action. Similar to the process of embodiment 203, if after reviewing the additional information in step 204d the user in step 204e decides to reverse the initial decision to not pursue the candidate and instead the user decides to hire and/or advance the candidate in the hiring process, the adverse action status is cleared from the candidate's reference request. Alternatively, in the event that even after reviewing the additional information the user chooses not to proceed with hiring and/or advancing the candidate in the hiring process, the adverse action status remains set in the candidate's reference request profile, and a final notice is sent to the candidate informing them of this status.

Although in each of the embodiments previously described the reference checking system 1 and reference checking process 100 has been described as being a process initiated by and controlled by a user, such as an employer or other party involved in the process of screening and/or hiring potential candidates, in an alternate embodiment of the invention, the reference checking system 1 of the present invention may also be utilized to create and manage a self-verification process 700 that is initiated by and controlled by an individual.

Reference checks are a standard procedure for hiring, advancing, and/or otherwise determining an individual's suitability for a position and/or to verify information about an individual (e.g. employment history, compensation, education, skills, abilities, personality traits, character, etc.). Furthermore, the traditional reference check and verification process can be long and tedious. Thus, in an alternate embodiment of the present invention, the reference checking system 1 may be designed to allow an individual to in advance of applying for a job, promotion, or other position prepare a reference report 301 such that that a potential employer or other reviewer may have access to the individual's reference report 301 at substantially the same time the potential employer or other reviewer receives individual's application.

Although the description of the self-verification process 700 below describes an embodiment in which the individual employs the self-verification process 700 to generate a reference report 301 in anticipation of applying for a job or a promotion, if is to be understood the self-verification process 700 may be used to generate reference reports 301 in anticipation of and/or for any number of reasons in which it would be desirable for an individual to verity information (either objectively or subjectively) about themselves. Non-limiting examples of alternate markets and/or uses for the self-verification process 700 and a reference report 301 generated based on the verification process 700 include, but are not limited to: volunteer organizations; political organizations; trade associations; professional associations; academia; referral groups; day-care centers; sports organizations; coaches; personal introductory and/or membership organizations; etc.

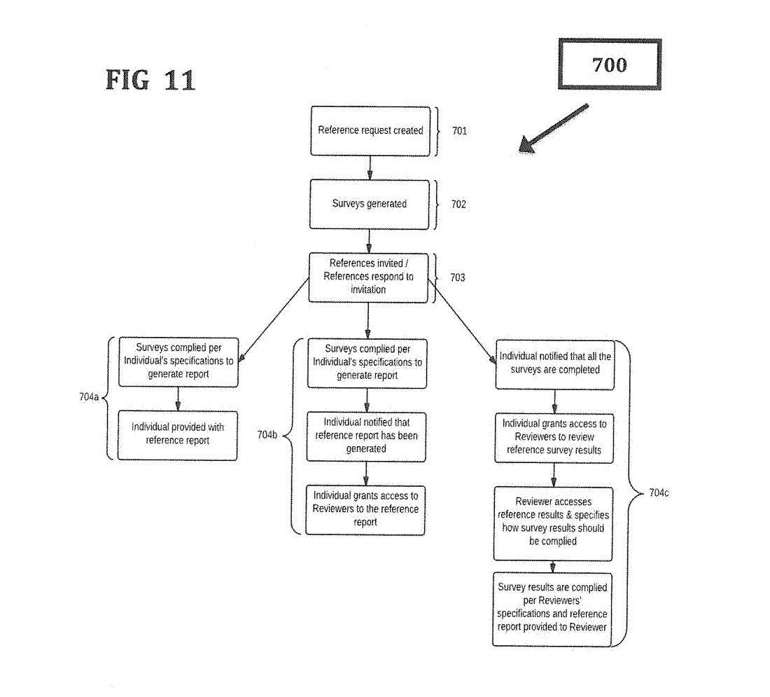

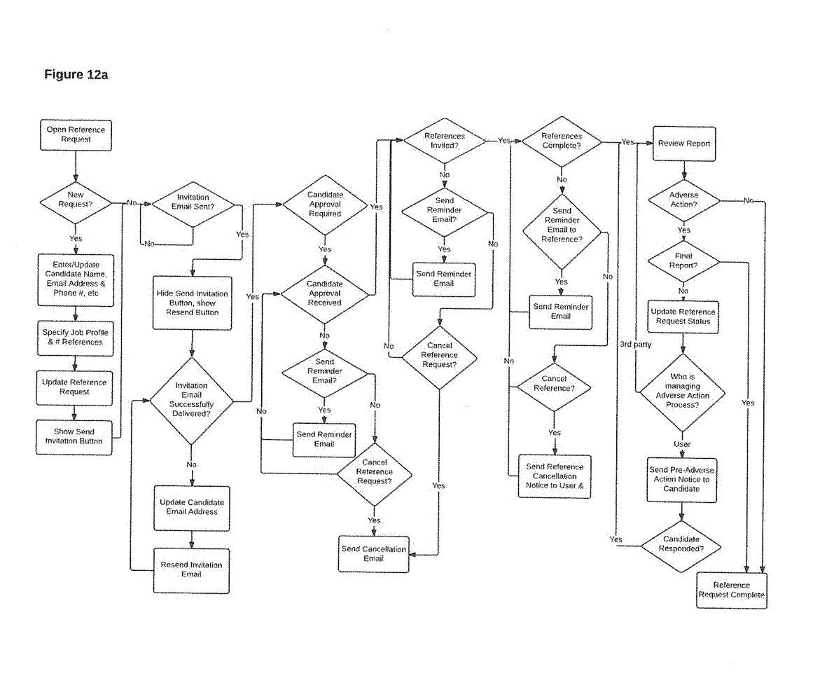

As illustrated in FIG. 11, the self-verification process 700 begins at step 701 during which the individual generates a new reference request using a computer 2. At step 701, the individual may, among other things be asked to provide; the names and contact information of references; information to be verified by the references, such as, e.g., but not limited to: job title, reference type (e.g. manager, co-worker, subordinate, friend, professional acquaintance, etc.), responsibilities, salary, work history, education, skills, character, personality, a free form box including a customized note or instructions to the reference; etc.

In step 702, the individual utilizes the survey generation device including the plurality of device specific generating modules of the reference checking system 1 to generate a survey for the references. In a preferred embodiment, step 702 of generating a survey will mirror the generation of a survey as described in FIG. 3 with reference to the user initiated reference checking process 100 previously described. Thus, step 702 will generally begin with the individual selecting from the survey database 31 job profiles that best and most closely represent the types of jobs that the individual expects to be applying to. The individual may choose one or more job profiles that best represent the range of jobs or positions that the individual expects they might be applying for. Alternatively, if the individual does not know or does not wish to narrow the job profiles they might be applying for, the individual may have the option to select all or a subset of job profiles from the survey database 31.

Also similar to the process of survey generation in the user initiated reference checking process 100 described in FIG. 3, in step 702 once the individual has selected the desired job profiles, the reference check system 1 presents a list of categories and category elements relevant to the selected job profile. The individual then has the option to choose which categories, and which category elements to use in generating the survey. The individual can choose any or all of the categories and category elements and/or alter categories and category elements to generate the survey. The individual may also optionally add in other self-generated categories and/or category elements to include with the categorized and category elements presented by the reference chock system 1. After the individual has finalized the categories and category elements to be included in the survey, the reference checking system 1 generates a survey.

Although the individual may utilize the reference checking system 1 to generate a survey in step 702, the survey may be a survey generated in any number of ways and originating from any number of sources (including surveys generated by the individuals themselves). For example, in embodiments where the individual knows in advance that the employer/position/organization/utility/etc. that the individual will be using the reference report 301 for relies on its own, pre-established reference survey, the individual may utilize that pre-established reference survey as the survey that will be used for the self-verification process 700.

In step 703 the survey distribution device including the plurality of device specific processing modules may be used to invited references to complete the survey. The process of inviting references in step 703 is similar to step 105 of the user-driven reference checking process 100.

FIG. 11 illustrates three non-limiting embodiments (704a, 704b, and 704c) of how the self-verification process 700 may progress once the surveys have been completed by the references. In any of these or other embodiments, the actual process of compiling the reference report 301 in the self-verification process 700 is similar to step 106 of the user-driven reference checking process 100 in which the collection database collects the responses.

In embodiment 704a, once the surveys have been completed, the reference checking system 1 compiles the surveys to generate a reference report 301. The reference report 301 is compiled (e.g. using objective or subjective compilation of results), organized, and presented in any manner that the individual chooses. The generated reference report may then made available to the individual in the reference checking system 1. Although the reference report 301 is made available to the individual, preferably, the reference report 301 is provided to the individual in a read-only view such that the individual is not able to (without, e.g. going through an adverse action process) amend or otherwise alter the contents of the reference report 301. Furthermore, the individual is provided an opportunity to add his/her personal notations and/or comments to specific content categories in the reference report to provide feedback and/or correct inaccurate information gathered from references.

Once the individual has access to the reference report 301, the individual use the reference report 301 in any manner he or she sees fit. For example, the individual may include a copy of or a link to the reference report 301 in applications that the individual submits. Alternatively, the individual may provide a potential employer or other reviewer with the reference report 301 at a later time during the application process. Preferably, any links to the reference report 301 that the individual provides are secured links that require the potential employer or any other reviewer of the reference report 301 to enter a password to view the contents of the reference report 301.

In embodiment 704b, once the surveys have been completed, the reference checking system 1 also compiles the surveys to generate a reference report 301, and notifies the individual of this fact. In embodiment 704b, similar to the process in 704a, the reference report 301 is compiled (e.g. using objective or subjective compilation of results), organized, and presented in any manner that the individual chooses. However, in step 704b, after the reference report 301 is generated, unlike in embodiment 704a the individual is not able to review the reference report 301. Instead, the individual is only provided the option of granting a potential employer or other party involved in the review process access to the reference report 301. For example, when filling out an application or at any other time during an application process, the individual may provide the potential employer and/or other reviewer with a secure link; password protected login, quick response code (QR), etc and access instructions that allow the potential employer and/or other reviewer to access the reference report 301. Additionally, the link and access instructions may be structured such that in order to access the reference report 301, the potential employer and/or other reviewer must go through some verification process to ensure that the individual viewing the reference report 301 is in fact doing so as part of an existing application or review process.

Embodiment 704c is similar to embodiment 704b in that the embodiment of 704c also only notifies the individual that the references have responded, but does not otherwise grant access to the individual to review the survey results. However, in embodiment 704c, unlike in embodiments 704a and 704b, the reference report is not compiled, organized, and presented based on the individual's inputs.

In embodiment 704c, like in embodiment 704b, the individual at the time of applying for a position or at any time during an application process may provide the potential employer and/or other reviewer with a secure link, password protected login, quick response code (QR), etc to access the reference report 301. As in embodiment 704b, the potential employer and/or other reviewer may use this secure link, password protected login, quick response code (QR), etc to view the reference report. Optionally, as in embodiment 704b, the potential employer and/or other reviewer may first be required to authenticate that they in fact are doing so as part of an actual hiring or other application or review process. However, once the potential employer and/or other reviewer follows the link provided by the individual, the potential employer and/or other reviewer will have the added step of inputting into the reference checking system 1 those parameters that the employer and/or other reviewer wishes to use in generating the references report 301. For example, the employer and/or other reviewer may decide whether they want the results objectively or subjectively compiled; in the event that the individual's self-evaluation survey was generated with categories and category elements from multiple job profiles, the employer and/or other reviewer may choose to limit the reference report 301 to display only those elements relevant to the position that is actually being applied for; etc. Once the employer and/or other reviewer has specified how they wish the results to be compiled, presented, mid organized, the reference checking system 1 generates a reference report 301 which is then sent to the employer and/or other reviewer. Additionally, the reference checking system 1 may include a searching module such that potential employers or other third parties such as recruiters can search survey results to find candidates that meet desired parameters.

By only allowing access to potential employers and/or other reviewers involved in the application process, the embodiments of 704b and 704c may enhance the quality of the responses provided by the references, or increase the number of references willing to complete the survey, as the references will not have to be concerned about the individual seeing how the reference has evaluated the individual. Similarly, by not allowing the individual to review the contents of the reference report 301, potential employers and/or other reviewers may be more apt to lend credibility to the reference report 301, knowing that an individual has not had a chance to edit out, amend, or otherwise alter the reference report 301 any potentially unfavorable reference responses.

In generating a reference report 301 in the self-verification process 700, there may also be any number of optional features added to the process. For example, in any of the embodiments 704a-c, if the individual has completed a self-evaluation survey, the results of the individual's self-evaluation survey may be compiled into the final reference report 301. As another example, in embodiments 704a and 704b, using the same survey results, the individual may have the option of generating multiple different reference reports 301 that are each compiled and/or organized and presented in any number of ways depending on the individual's needs. Similarly, in 704c, the reference report 301 may be compiled and/or organized and presented in any number of ways such that the individual may allow more than once potential employer and/or other reviewer to request and generate a customized reference report 301.

Although the choice between embodiments 704a and 704b/704c has been described as being chosen by the individual, it is also envisioned that the responses of references may possibly dictate whether the reference report 301 will or will not be reviewable by the individual. For example, in one embodiment, included in the invitation to the reference may be an option for the reference to choose whether or not they authorize the individual to review the completed survey. If a reference authorizes this option, the individual may then be able to choose any embodiment 704a, 703b, or 704c. If however, the reference indicate that they do not authorize the individual to review the survey response, the reference checking system 1 will subsequently only allow the individual to choose between options 704b and 704c.

With respect to embodiments 704b and 704c where the individual has not had a chance to review the reference report 301 prior to providing a potential employer or other reviewer with a link to the reference report 301, in the event of an adverse action in which the employer and/or other reviewer decides not to advance the individual in the application process in any way based in whole or in part on the results of the reference report 301, the self-verification process 700 may then proceed with an adverse action process similar to the adverse action process 200 described with reference to the reference checking process 100 described above and in FIG. 8.

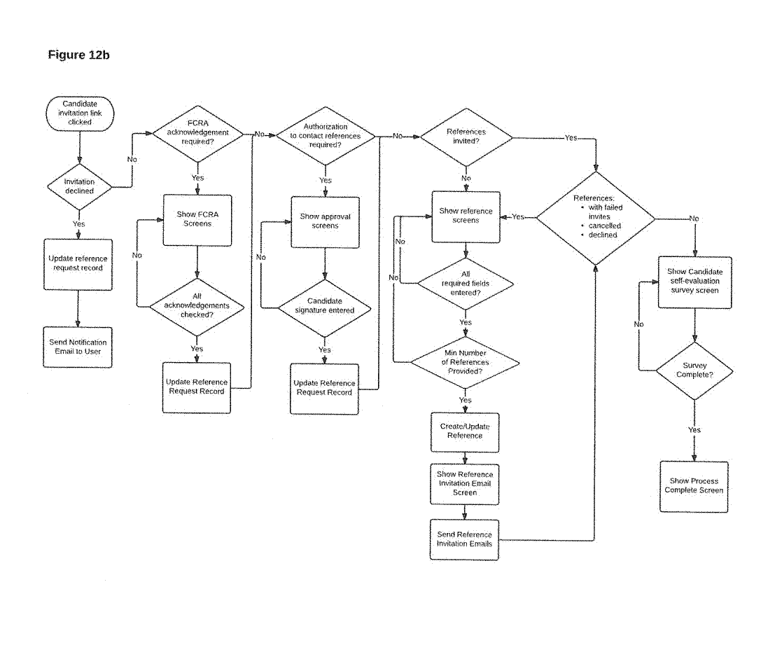

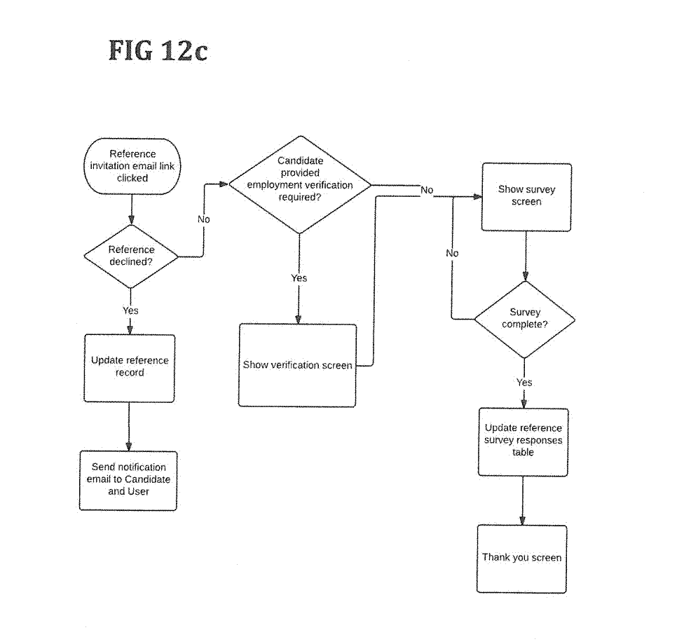

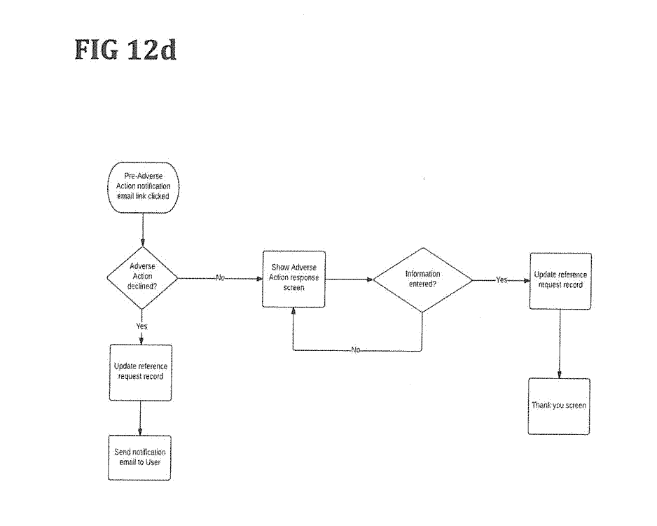

In order to ensure that the reference checking process 100 runs correctly and efficiently, the reference checking system 1 is designed with internal flow processes that help guide the reference checking process 100. These internal flow processes are designed to ensure that as the reference checking process 100 moves through the steps of the reference checking process 100 certain required actions are completed and/or accounted for prior to advancing from one step to the next. Illustrated in FIG. 12a, for example, is an embodiment of an internal flow process for guiding the overall process of creating and managing a reference request using the reference checking process 100. As seen in FIG. 12a. the internal process for guiding the overall process of creating and managing a reference request contains a number of checkpoints that help guide the reference checking process 100 through potential roadblocks in the process, such as, e.g.: situations where: the candidate invitation has not been delivered; the candidate has not yet invited any references; a reference has not replied to an invitation; there is an adverse action; etc.

Illustrated in FIGS. 12b-d are other examples of internal flow processes that help guide other steps of the reference checking process 100. FIG. 12b, for example is one embodiment of an internal flow process used to ensure that the candidate invitation process runs correctly and efficiently. Similarly, FIG. 12c illustrates an internal flow process for ensuring that the reference invitation process runs correctly and efficiently; and FIG. 12d illustrates an internal flow process used with the adverse action process.

In order to facilitate the user's experience in using the reference checking system 1, the reference checking system 1 is preferably designed to include a user interface system 900 that, among other things: allows the user to set and modify user preferences; allows the user to monitor the progress of the reference checking process 100 or 700; provides the user with the option of bypassing certain steps; allows the user to grant access to third parties; stores user preferences; store the user's past reference requests; alerts the user to any problems in the reference checking process 100; alerts the user to any potential adverse action issues; guides the user through the adverse action process; etc.

Also, in embodiments where the reference checking system 1 is also used with the individual self-verification process 700, the user interface system 900 allows the user to generate profiles (e.g. minimum response values; types of survey dements that were reported on; industry the survey was generated for etc.) that can be used to search through completed reference reports 301 generated through self-verification processes 700. Based on these saved user profiles, the reference checking system 1 can search through the database using the search module of the stored individual-initiated pre-verified reference reports 301 and from these reference reports 301 the reference checking system 1 can generate lists of potential individuals matching the user's profile requirements. Additionally, the user interface system 900 may allow the user to select the option to notify the user of new individuals matching the user's profile request as new pre-verified reference reports 301 are added to and updated in the reference checking system 1 database.

One of the functions of the user interface system 900 may be to monitor, track and respond to various stages within the adverse action process 200. As illustrated in FIGS. 13a and 13b, among the information the user interface system 900 may provide regarding the status of the adverse action process 200 include: when the adverse action process 200 began; whether or not the candidate has been notified on the adverse action; tracking of the receipt and opening of the adverse action notification by the candidate; whether or not the candidate has responded to the notification; and the overall progress of the adverse action process 200. Optionally, with regards to the monitoring of the adverse action process 200 the user interface system 900 may also display information regarding: whether or not documents from the candidate have been received; whether or not other individuals (e.g. the references) have been invited to participate in the adverse action process 200, when those other individuals were invited and whether or not those individuals have responded; the number of days the adverse action process 200 has been pending; etc.

It is to be understood that the user interface system 900 may be designed to allow a user to monitor any of steps in the reference checking process 100 or 700, such as dashboards for monitoring the candidate invitation process, the reference invitation process, the adverse action process; etc. and that the monitoring status of each or any of the steps of the reference checking process 100 or 700 may be displayed simultaneously on a single dashboard; each different monitored step may be displayed on a dashboard displaying only the progress of that step; or the dashboard may display the status of some, but not all of the steps in the reference checking process 100 or 700.

FIGS. 14a-14c illustrate the general process 1100 of an embodiment of a candidate reference application. Typically, process 1100 is initiated when a user using an Internet enabled computer 2 accesses the computer 3 of the reference checking system 1 through the Internet. The candidate reference application is a secure, personal site for an individual to: initiate reference checking process; maintain/update previously generated reference reports; provide perspective employers/reviewers access to the reference report; track viewers of the candidates reference report; and to interact with social media sites such as LinkedIn, Google+, Facebook, etc.

The candidate reference application process 1100, illustrated in FIG. 14a, starts when a candidate clicks on a URL that has been emailed as indicated in step 1100a or saved as a bookmark in the browser as in step 1100b. This link takes the candidate to the Candidate Web Login in step 1101 where they can login using their email address and password or via a social media account.

Alternatively, the application can be embedded within a social media platform in step 1102 and accessed through the social media platform with credentials being automatically used for login.

Once login is complete, in FIG. 14a, the Candidate Interface, step 1103 is presented. The interface consists of a content section in step 1104 and a series of navigation buttons in the following steps: View Reference Report 1200, Add/Update Reference 1300, View Employers 1400, My Account 1500, and Log Out 1110, all of which will be described in further depth below.

Initially, the content section displays the dashboard in step 1104 that shows the status of requests to References for information as illustrated in FIG. 14b, section 1106 and new requests from Employers for the candidate's reference information section 1107.

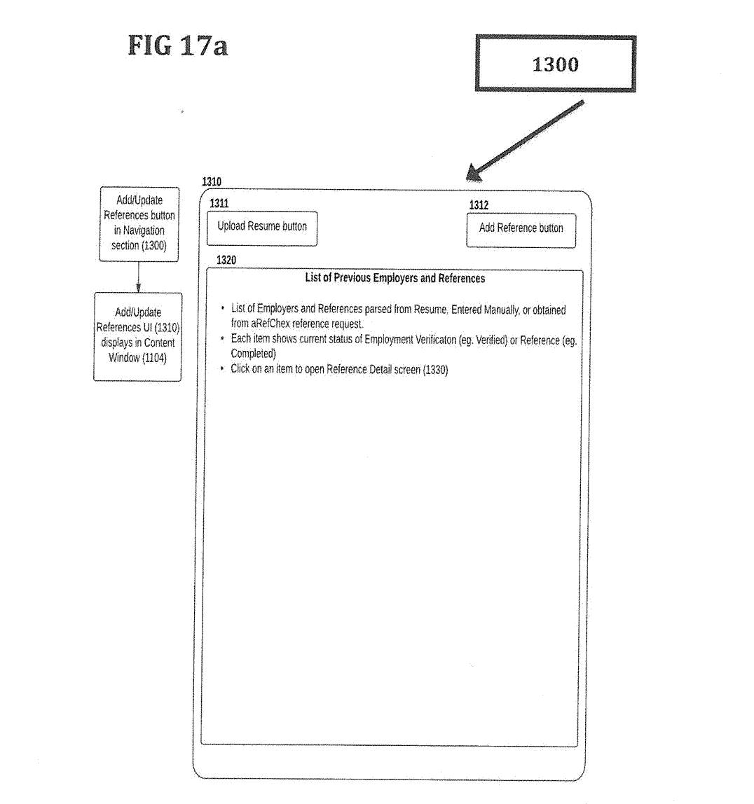

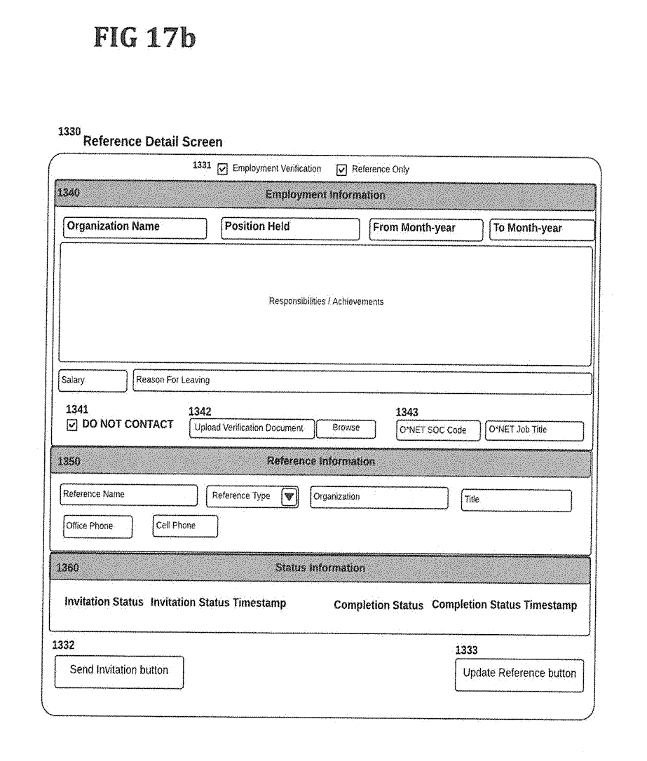

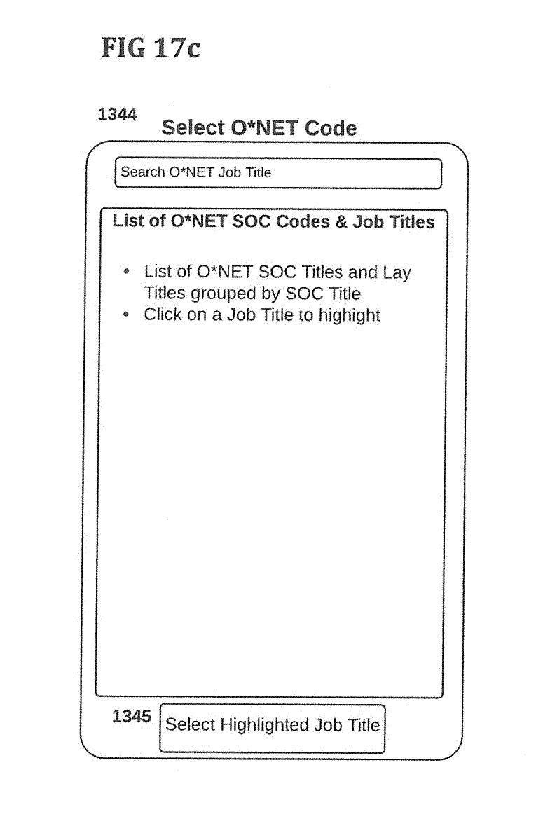

Clicking on items listed in the Reference Request section 1106 opens the Reference Detail Screen in FIG. 17b, step 1330 to manage a particular Reference Request. FIGS. 17a-17c illustrate the “Add/Update References” process. Additional features may be used with Reference Request section 1106 as will be described below.

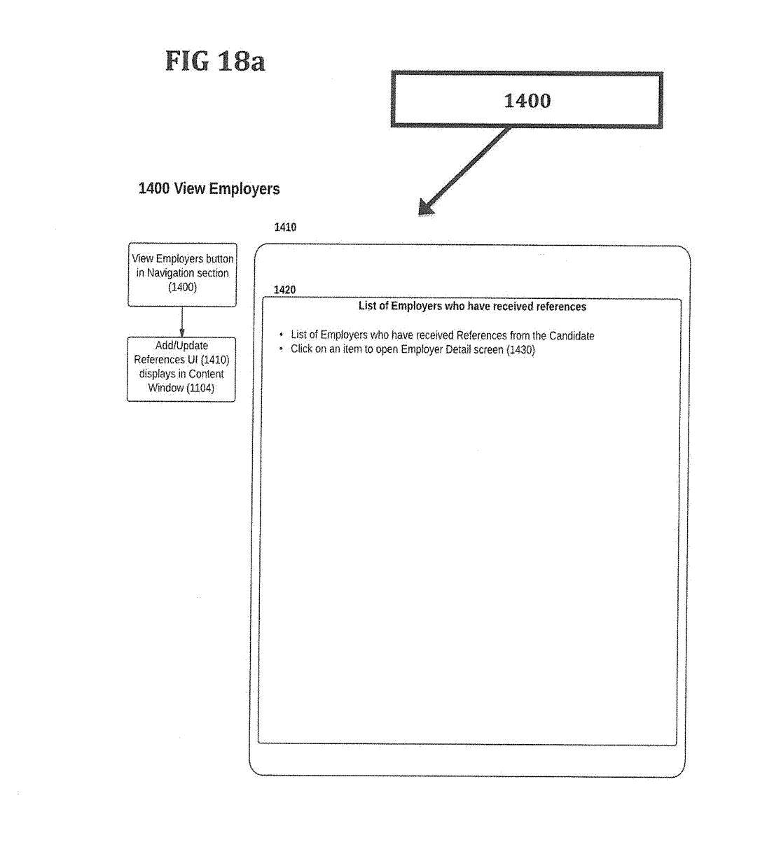

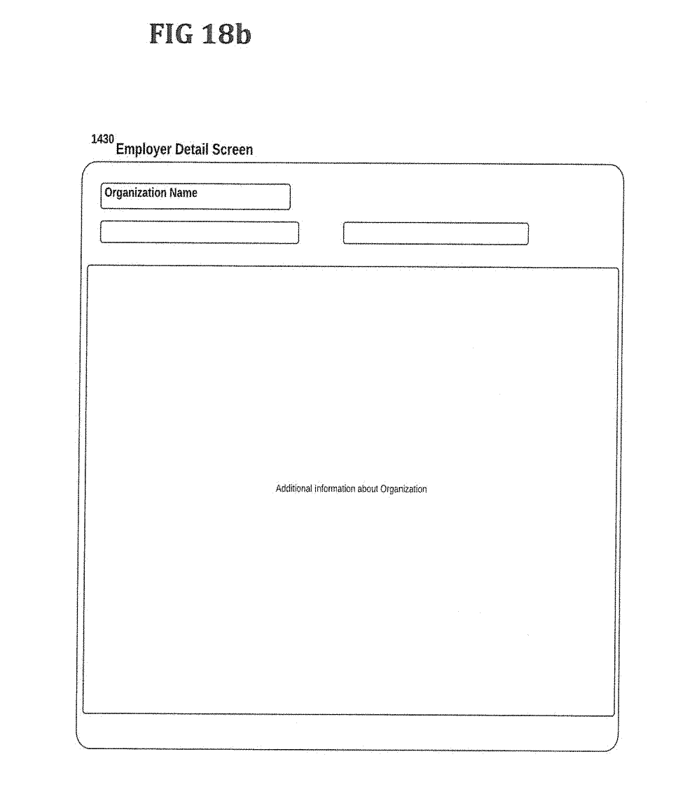

Clicking on items listed in the Requests from Employers section 1107 opens the Employer Detail functionality in FIG. 18b, step 1430 to manage a particular employer request and to view information about the employer. Please refer to FIGS. 18a-18b for the “View Employers” process. Additional features may be used with the the Requests from Employers section 1107 as will be described below. All emails sent from the system are handled using a central Email Processing module 1150 as illustrated in FIG. 14c, that allows for the user of email templates and tracking of email delivery to references.

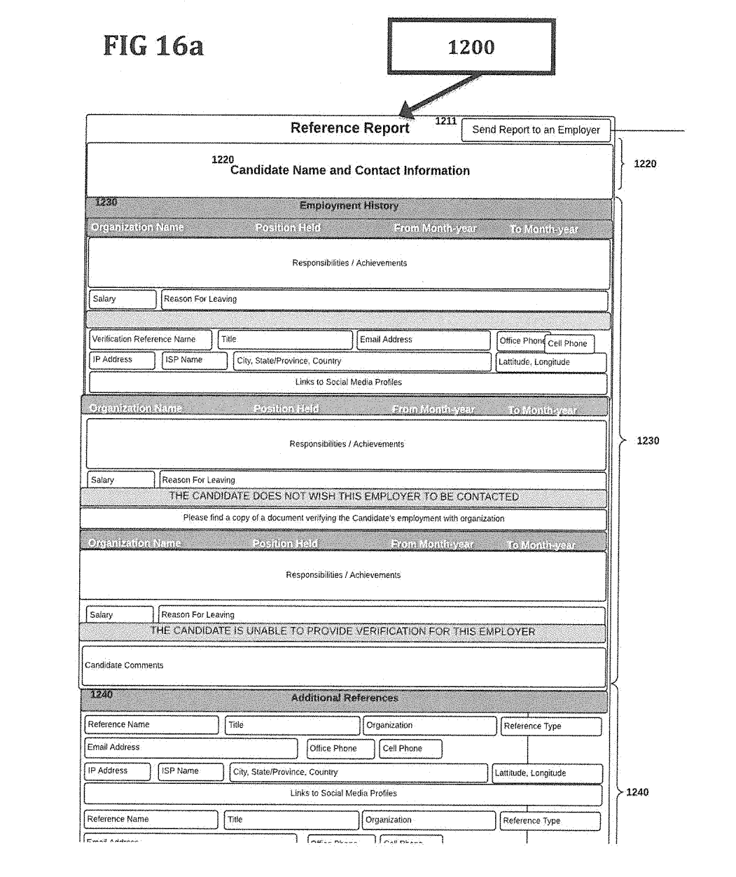

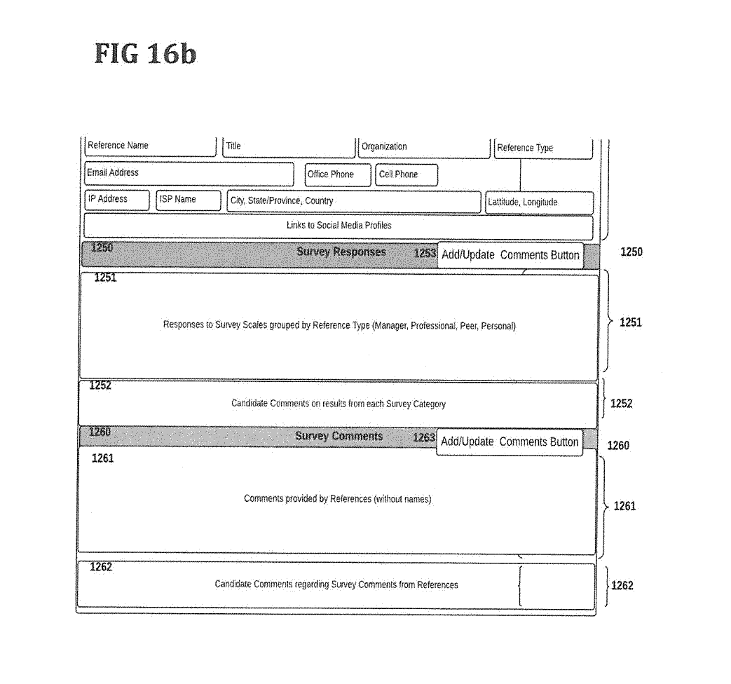

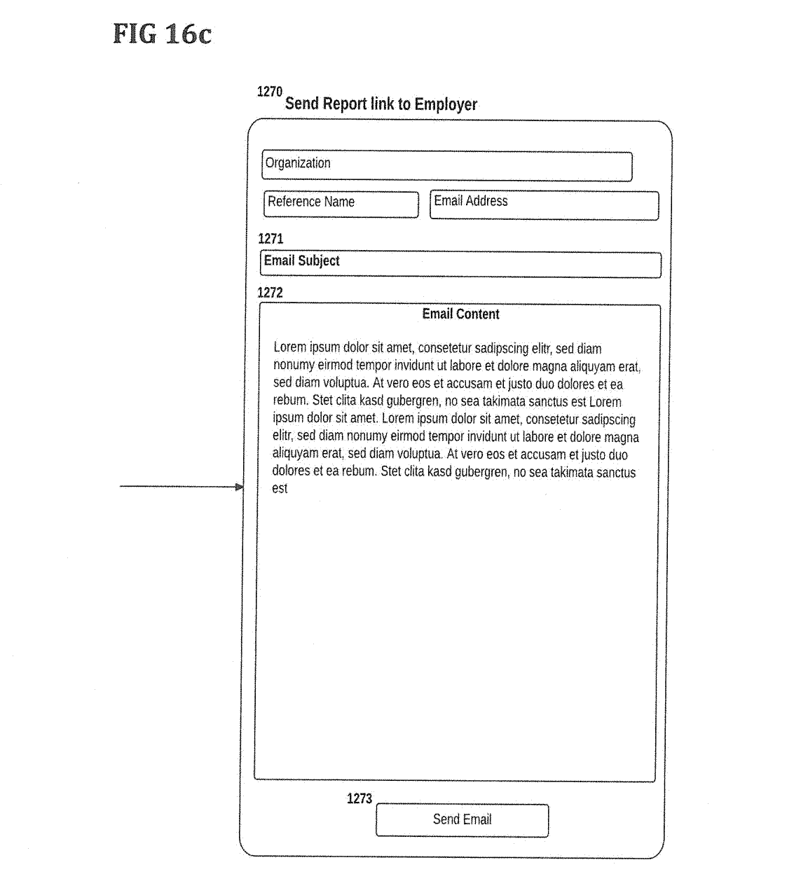

FIGS. 16a-16c are illustrations of the Candidate Reference Application's View Reference Report process 1200.

Process 1200 begins when the candidate clicks on the View Reference Report Button illustrated in FIG. 16a, step 1200 in the navigation section of the screen. When this button is clicked, the Candidate Interface will display the Reference Report in FIG. 16a, step 1210 as the reference report would be seen by a perspective employer/reviewer and within the content section illustrated in FIG. 14a, step 1104.

The Reference Report illustrated in FIG. 16a is comprised of 5 major sections: step 1220 is the Candidate Name and Contact Information, step 1230 is the Employment History, step 1240 is Additional References, step 1250 are the Reference Survey Responses, and step 1260 are the reference survey open-ended comments. The Candidate Name and Contact Information in step 1220 include the following information: Candidate's Name, Email Address, Home Telephone and Cell Phone numbers.

The Employment History information in step 1230 contains the following information: the candidate's previous employers in descending order by From Date (most recent), each previous employer will fall within one of the following three (3) Verification scenarios listed below.

1. Verified by Manager/Supervisor. In this scenario the information includes: the Name and Contact information for Verification Reference including follow-up information, if desired; IP & Geo-location information provided of each reference to assist in verification of the references identity; and any Social Media profile links (if any) are included.

This category is the only scenario where the Responsibilities/Achievements are verified by when the reference completes a survey and provides additional comments. An important feature of process 1200 in that if the reference has changed any of the information provided by the candidate (e.g. Achievements or Salary), then the reference-provider's version replaces the original information provided by the candidate.

2. Do Not Contact. In this scenario the candidate does not wish the specific Employer to be contacted and therefore, the Candidate must upload documentation to verify the Employment Portion such as a W2 form or a paystub with dates and compensation information. This documentation is included at the end of the report when sent to a prospective employer-reviewer along with the reference report.

3. Cannot Verify. In this scenario the candidate is unable to obtain verification from former managers or upload documentation proving previous employment (e.g. W2 form or paystub). However, the candidate is provided a free-form field to add comments and/or to explain his/her lack of employment verification information.

FIG. 16a, process 1200, step 1240 illustrates the information received from references that are not related to Employment History/Verification step 1230 above. Information from references such as: Professional references, Managers who were not direct supervisors of the candidate, or peer references. The type of Reference (e.g. Professional, Manager, Peer, etc.) are included in this step for each reference as well as the name and contact information for each reference are included for follow-up activities including: IP & Geo-location information that assists in verification of the reference's identity as well as social media profile links (if any) are also included.

FIG. 16b, process 1200, illustrate the responses gathered as feedback from the references to the O*NET-based survey items 1251 and/or freeform questions responds 1261. The candidate has the opportunity to provide responses and comments 1252 to the feedback from the references to the O*NET-based survey items 1251 and responses and comments 1262 to the freeform questions responds 1261. Additional survey responses 1250 and survey comments 1260 can be added or updated. For greater clarity, step 1251 includes responses from the references, and the candidate, to O*NET-Generated Survey Items.

The survey-items presented are job relevant elements from the O*NET's database for the categories of: Knowledge, Skills, Abilities and Work Styles which are required to meet performance expectations for the candidate's specific work history.

Using O*NET SOC code the candidate assigns to each Previous Employer (see FIGS. 17a-b, process 1300, the system retrieves the top three (3) elements for each category based on the data value assigned (high value equal important to success on the job) to the element by O*NET for the specified SOC Code.

For each scale-type survey element, the reference is asked to specify his/her level of agreement that the Candidate has demonstrated a knowledge of or ability to perform the element (e.g. Sales and Marketing and/or Critical Thinking). The options provided, of which the Reference must choose one, are: Not Applicable, Strongly Disagree, Disagree, Neither Agree nor Disagree, Agree or Strongly Agree. In order to provide a degree of anonymity for the references, all responses for each item are consolidated (averaged).

Additionally, all references are presented with a list of questions that require a free-form, textual response. An example of such a question would be “What are the candidate's key accomplishments?” The responses are presented in the report are grouped by question and do not include the name of the reference who provided each response. In step 1250, for each O*NET category and each free-form question response from references, the candidate may add comments by clicking on the Add/Update Comments button as illustrated in step 1253.

Step 1253 allows the candidate to add information and/or dispute and/or provide mitigating information, etc. regarding the responses from references.

In step 1261, all references are presented with an opportunity to provide additional comments which are general in nature.

Similarly, in step 1262, the candidate may provide general comments by clicking on the Add/Update Comments button as in step 1263.

In step 1211, the candidate can send an email containing a link to the Reference Report to a prospective employer or any reviewer, by clicking on the ‘Send Report to an Employer’ button and completing the Send Report Link to Employer form 1270 Illustrated in FIG. 16c, including providing an email subject 1271, writing Email Content 1272, and sending the email 1273.

Process 1300 begins when the candidate clicks on the Add/Update Reference button illustrated in FIG. 17a in the navigation section of the Candidate Reference Application Interface which will display Maintain References screen in step 1310 within the content section FIG. 14a, step 1104.

In steps 1310, 1311, 1312 and 1320, the Candidate may add Previous Employers and References by uploading a resume or manually entering the reference data as described below.

Step 1311 illustrates where the candidate may click on the Upload Resume button which allows the Candidate to upload a Microsoft Word document containing a resume from his/her computer. The resume is sent through a resume parser that extracts all Previous Employers and Additional References contained in the document.

The extracted information from the resume appears in the list illustrated in step 1320. The candidate is able to open each item to update the information and/or to add missing information via the Reference Detail Screen in step 1330.

In step 1312, the candidate may click on the Add Reference button which allows the Candidate to manually add a new Reference by entering the Reference information into the Reference Detail Screen illustrated in 1330.

In step 1320, the screen displays lists of all the Previous Employers and References that the candidate has provided. Each item includes a status message to indicate whether it has been verified (for Employment Verifications) or is complete (Additional References). The candidate can view/modify the details for each item by clicking on it to open the Reference Detail Screen as illustrated in 1330.

In FIG. 17b, Step 1330 illustrates the Reference Detail Screen where the Candidate may add/modify information regarding a Previous Employer or Additional Reference. The type of Reference is indicated with the checkboxes at the top 1331. In the case of a Previous Employer the candidate may indicate that this Organization should not be contacted by potential Employers, as indicated in step 1341. If this box is checked, then the candidate is required to upload a verification document (e.g. W2 form and/or paystub as in step 1342) that will verify that the candidate was employed by the specified organization, in the specified position, during the specified data range. The Candidate may upload a verification document even if the Do Not Contact box is not checked.

The Candidate is also required to specify an O*NET SOC code and Job Title for each Previous Employer. This is done by opening the Select O*NET Code window in step 1344 and selecting the Job Title which most closely matches the position at the Previous Employer in step 1345.

The candidate, in step 1350, must provide for each reference the: name, email address and at least one phone number. For References not related to Employment Verification, the candidate must also specify the Type of Reference as well as Organization Name and Title if appropriate.

In step 1360, for References who have been invited, the Status Information section shows the status of the invitation email and the overall completion status of the request.

For newly added References, once the candidate has provided all appropriate information, the candidate can send an invitation by clicking on the Send Invitation button in step 1332. Additionally, the candidate may check the status of the Reference by clicking on the Update Reference button 1333.

FIGS. 18a-18b illustrates process 1400 for Add/Update References, Clicking on the View Employers button in the navigation section of the Candidate Interface illustrated FIG. 14a process 1100, will display View Employers screen step 1410, within the content section FIG. 14a, step 1104.

Steps 1420 and 1430 displays a list of all information of all Employers to whom the candidate has interacted.

In step 1420, each employer to whom the candidate has sent a link to the Reference Report appears in this list. The candidate may click on an Employer to open the Employer Detail Screen in step 1430, in order to view additional information.

In FIG. 18b, step 1430, the Employer Detail screen shows the information that the Employer has provided for the candidate's benefit and consideration.

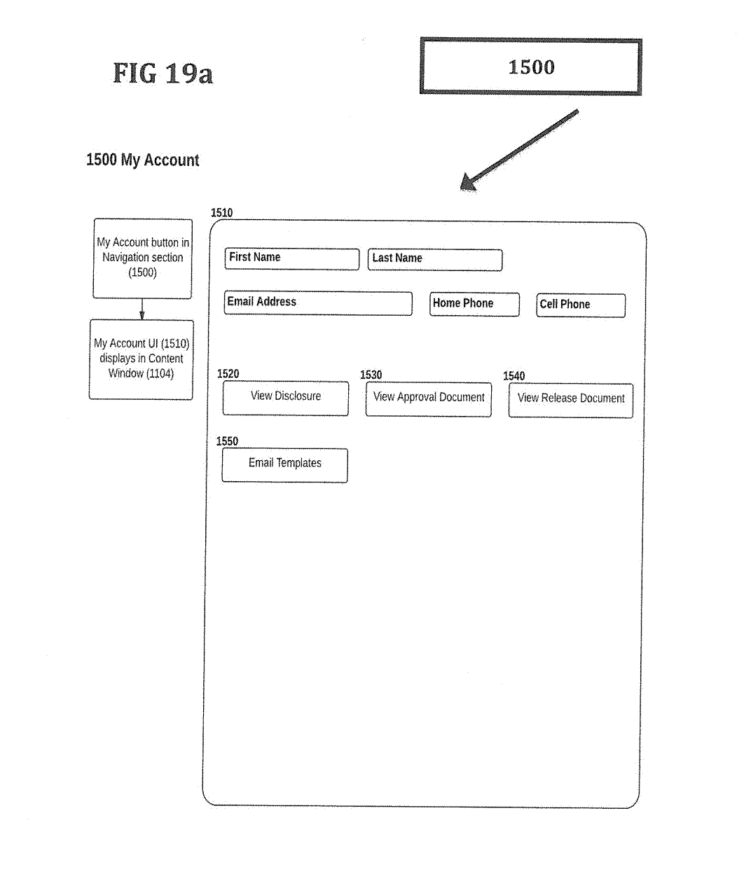

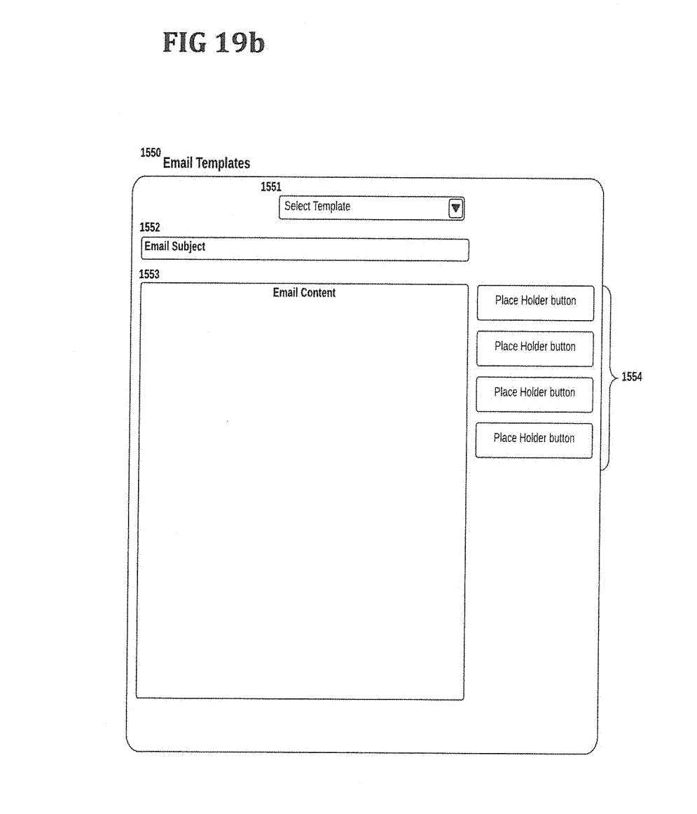

Process 1500 begins when the candidate clicks on the My Account button illustrated in FIG. 19a in the navigation section of the Candidate Interface illustrated FIG. 14a process 1100, will display My Account screen step 1510, within the content section FIG. 14a, step 1104.

Process 1500 provides the candidate with the ability to keep his/her contact information up-to-date. It is also from within this screen that the candidate may view the Disclosure in step 1520, Approval Form in step 1530, and the Release Agreement in step 1540. These are all documents that the Candidate acknowledged or signed in order to make use of process 1100 illustrated in FIGS. 14a-14c.

In step 1550, clicking on the Email Templates button opens the Email Templates window where the candidate can maintain the email templates used for inviting references and sending Reference Report invitation links.

Once the Candidate selects the desired template to modify in step 1551, the corresponding Email Subject in step 1552 and Email Content in step 1553, can all be modified for use with future emails. A number of Place Holder buttons as illustrated in 1554, are available to allow the candidate to specify a place within the Email Content for such data as Reference Name. When an email is sent (using the Email Processing module in FIG. 14c, step 1150), each placeholder is replaced with the corresponding data from the database.

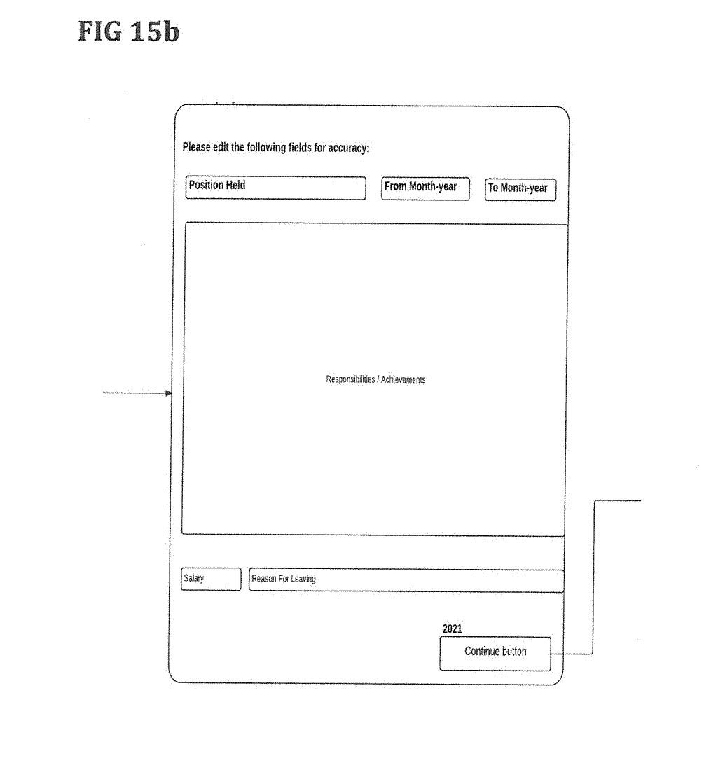

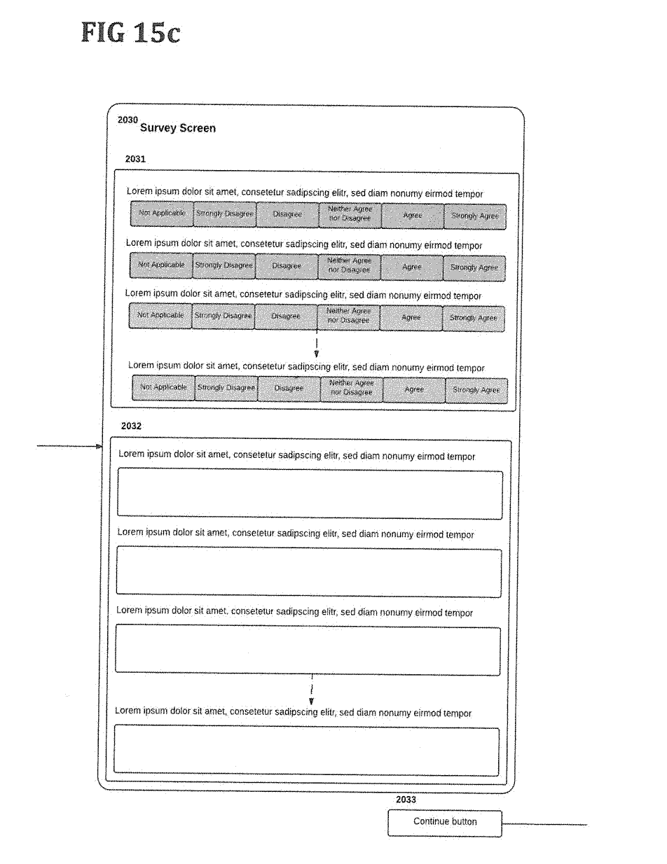

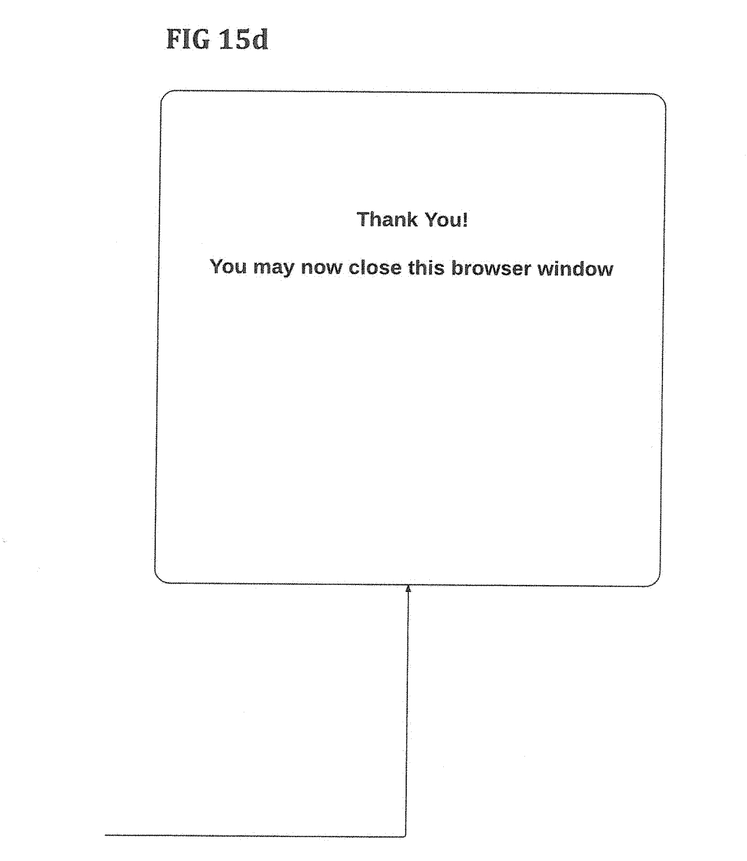

In FIGS. 15a-15d, the employers click on a link provided via email from the system in order to access the Reference Interface. Upon doing so, the reference is presented with up to four (4) pages as part of the Reference process.

FIG. 15a, step 2000 illustrates a welcome message to the Reference and thanks him/her for taking the time to complete the process. In step 2011, the reference clicks on the Continue button to proceed to the next page.

In FIG. 15b, step 2020, this screen is only presented to references who are designated as Previous Employers. The reference is asked to review the information which the candidate has provided, and to make any necessary changes. The candidate's original information is not lost, however it is the information provided by the reference which appears in the Reference Report. Upon completion of this page, the reference clicks on the Continue button in step 2021 to proceed to the next page.

In FIG. 15c, step 2030, all references are presented with the Survey Screen. However only Previous Employers are presented with the scale-type O*NET-related survey items in step 2031. All references are also presented with the Free-Form Questions survey section in step 2032. For details regarding these sections, please see FIG. 16b of process 1200 “View Report”, step 1250 “Survey Responses”.

In step 2033, once the reference has completed the Survey, the Continue button is clicked to show the final Thank You page in step 2040.

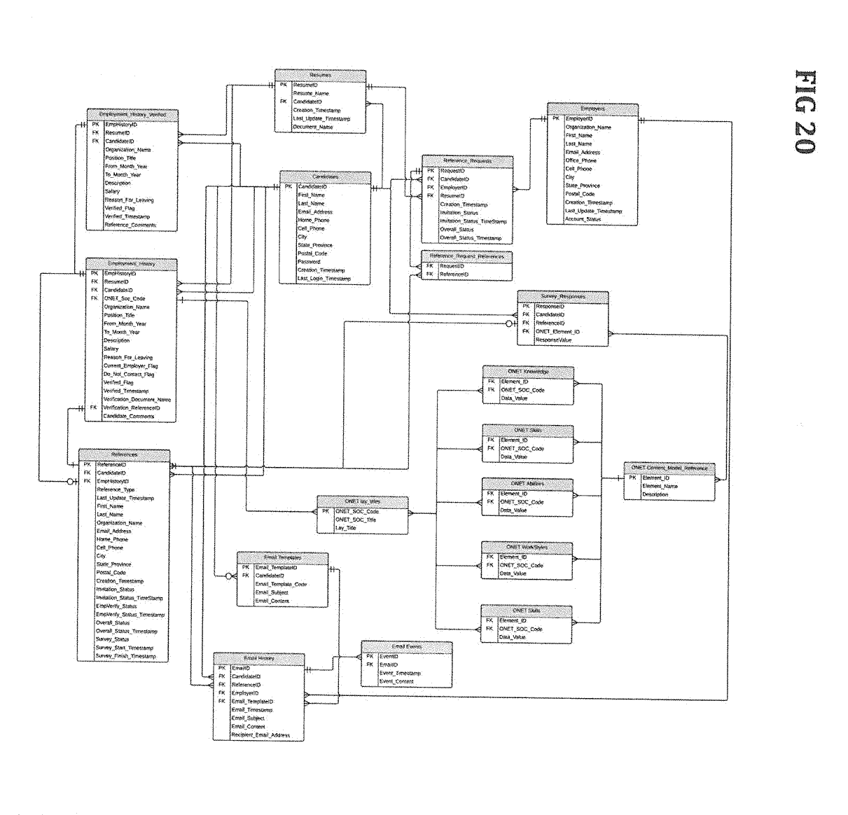

FIG. 20 represents a detail view of the database structure behind the candidate reference application process 1100 and as illustrated in FIG. 14a-14c.

Once the survey report has been generated, the candidate may share the survey report with third parties using a survey report distribution device. The survey report distribution device may allow the candidate to send an invitation to view this information via email, SMS text message, letter, or other form of communication. Additionally, the survey report may periodically be updated using a survey generation device including a plurality of device specific generating modules configured to generate, maintain, and update the survey feedback.

Of course, it is to be understood that the above-described embodiments and arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modification, including, but not limited to, variations in size, materials, shape, form, function and manner of operation, assembly and use may be made without departing from the principles and concepts set forth herein. The illustrated embodiments including any interface designs or language included thereon are exemplary in nature and could vary without departing the spirit and scope of the present invention.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

What is claimed is:

1. A system for checking references by an individual in anticipation of submitting an application comprising;
a plurality of computers in communication with one another, at least one computer configured to receive a self-verification reference request from the individual including a list of references to be contacted;
a first survey generation device including a plurality of device specific generating modules configured to generate a survey based on parameters;
a survey distribution device including a plurality of device specific processing modules, each device specific processing module being configured to distribute the survey to each of the list of references;
a survey database including a plurality of collection modules that collects responses provided by the list of references based on the survey;
an organization database including a plurality of analysis modules that organize the plurality of responses;
a system database configured to generate a survey report based on the plurality of responses;
a second survey generation device including a plurality of device specific generating modules configured to generate and update survey feedback; and
a survey report distribution device that enables the individual to invite at least one third party to review the survey report.

2. The system of claim 1, wherein the survey is generated based on parameters provided by the individual.

3. The system of claim 1, wherein the survey is generated based on information from a third party.

4. The system of claim 3, wherein the information is retrieved from a third-party database that contains job-specific information.

5. The system of claim 1,wherein the individual is provided access to the survey report.

6. The system of claim 1, wherein only a third party is provided access to the survey report.

7. The system of claim 1, further comprising a reference survey database in communication with the plurality of computers for storage of responses and survey reports for future review.

8. A reference checking system comprising:
a plurality of computers in communication with one another, at least one computer configured to receive a reference request from one or more individuals, each individual providing a list of references to be contacted;
a survey generation device including a plurality of device specific generating modules to generate a survey based on parameters identified by information found on a third-party website;
a survey distribution device including a plurality of device specific processing modules to send a copy of the survey and invite the references to complete the survey;
a survey database including a plurality of collection modules that collects responses provided by the list of references based on the survey;
a searching module that allows a user to search the survey responses of the one or more individuals based on parameters provided by the user; and
a system database configured to provide the user results from the search.

9. The reference checking system of claim 8, wherein the third-party website contains job-specific information.

10. The reference checking system of claim 9, wherein the job-specific information correlates to a specific job title.

11. The reference checking system of claim 10, wherein the job-specific information is collected from an O*NET database.

12. The reference checking system of claim 11, wherein at least one of the computers remotely access the O*NET database directly to retrieve the job-specific information.

13. The reference checking system of claim 12, wherein the survey responses are stored for future use.

14. The reference checking system of claim 8, wherein the system database is configured to receive a notice from the user of an adverse action relating to an applicant's reference report.

15. The reference checking system of claim 14, further comprising:
a message distribution device configured to notify the applicant of an adverse action process by a notice and providing the applicant with information regarding the applicant's reference report and information about the applicant's right under the Fair Credit Reporting Act (FCRA); and
a collection database for receiving additional information related to the applicant's reference report in response to the notification of the adverse action process.

16. The reference checking system of claim 15, wherein the notice of an adverse process action is received in response to a decision to not advance the applicant in an application process based on the applicant's reference report.

17. A reference checking system comprising:
a plurality of computers in communication with one another, at least one computer configured to receive a reference request from an individual providing a list of references to be contacted;
a survey generation device including a plurality of device specific generating modules configured to generate a survey relating to employment of the individual;
a survey distribution device including a plurality of device specific processing modules, each device specific processing module being configured to distribute the survey to each of the list of references;
a survey database including a plurality of collection modules that collects responses provided by the list of references based on the survey;
an organization database including a plurality of analysis modules that organize the plurality of responses; and a system database configured to generate a survey report based on the plurality of responses wherein the system database allows an employer who views the survey report to input information relating to initialing an adverse action process relating to the individual's reference report;
a message distribution device configured to notify the individual of the adverse action process and providing the individual with information regarding the individual's reference report and information about the individual's right under the Fair Credit Reporting Act (FCRA); and
a collection database for receiving additional information related to the individual's reference report in response to the notification of the adverse action process.

18. The reference checking system of claim 17, further comprising a docketing database that automatically periodically sends reminders relating to the adverse action process to the individual.

19. The reference checking system of claim 18, wherein the survey is generated based on job-specific information from a third party.

20. The reference checking system of claim 18, wherein the reference request is initiated by the individual.
